(19) United States
(12) Patent Application Publication
(10) Pub. No.: US 2021/0122844 A1
(43) Pub. Date: Apr. 29, 2021

(54) Catalyst Systems Including Phenol-Oxadiazole Catalyst and Non-Coordinating Anion Type Activators Containing Cation Having Alkyl Groups and uses Thereof

(71) Applicant: ExxonMobil Chemical Patents Inc., Baytown, TX (US)

(72) Inventors: Catherine A. Faler, Houston, TX (US); Margaret T. Whalley, Houston, TX (US); Charles J. Harlan, Houston, TX (US)

(21) Appl. No.: 17/081,221

(22) Filed: Oct. 27, 2020

Related U.S. Application Data
(60) Provisional application No. 62/926,947, filed on Oct. 28, 2019.

(51) Int. Cl. C08F 4/76; C08F 210/16

(52) U.S. Cl. CPC C08F 4/76; C08F 210/16

(57) ABSTRACT

The present disclosure provides a catalyst system having a catalyst compound having an oxadiazole group and borate or aluminate activators comprising cations having alkyl groups and methods for polymerizing olefins using such catalyst systems. In still another embodiment, the present disclosure provides a polymerization process comprising a) contacting one or more olefin monomers with a catalyst system comprising: i) an activator as described herein, ii) a catalyst compound as described herein, and iii) optional support.

### CROSS REFERENCE TO RELATED APPLICATIONS

The present application claims the benefit under 35 U.S.C. 119(e) of U.S. Provisional Patent Application 62/926,947, filed Oct. 28, 2019, the entirety of which is hereby incorporated by reference. The present disclosure also relates to: U.S. Ser. No. 16/394,166, filed Apr. 25, 2019 and U.S. Ser. No. 16/394,197, filed Apr. 25, 2019.

### FIELD

The present disclosure provides catalyst systems and methods for polymerizing olefins.

### BACKGROUND

Polyolefins are widely used commercially because of their robust physical properties. Polyolefins are typically prepared with a catalyst that polymerizes olefin monomers. Therefore, there is interest in finding new catalysts and catalyst systems that provide polymers having improved properties.

Catalysts for olefin polymerization are often based on metallocenes as catalyst precursors, which are activated either with an alumoxane or an activator containing a non-coordinating anion. A non-coordinating anion, such as tetrakis(pentafluorophenyl)borate, is capable of stabilizing the resulting metal cation of the catalyst. Because such activators are fully ionized and the corresponding anion is highly non-coordinating, such activators can be effective as olefin polymerization catalyst activators. However, because they are ionic salts, such activators are insoluble in aliphatic hydrocarbons and only sparingly soluble in aromatic hydrocarbons. It is desirable to conduct most polymerizations of α-olefins in aliphatic hydrocarbon solvents due to the compatibility of such solvents with the olefin monomer and in order to reduce the aromatic hydrocarbon content of the resulting polymer product. Typically, ionic salt activators are added to such polymerizations in the form of a solution in an aromatic solvent such as toluene. The use of even a small quantity of such an aromatic solvent for this purpose is undesirable since it needs to be removed in a post-polymerization devolatilization step and separated from other volatile components, which is a process that adds significant cost and complexity to any commercial process. In addition, the activators often exist in the form of an oily, intractable material which is not readily handled and metered or precisely incorporated into the reaction mixture.

U.S. Pat. No. 5,919,983 discloses polymerization of ethylene and octene using a catalyst system comprising [(C₁₈)₂MeN)]⁺[B(PhF₅)₄]⁻ activator having four perfluoro-phenyl groups bound to the boron atom and two linear C₁₈ groups bound to the nitrogen, as well as describing other linear groups at column 3, line 51 et seq.

U.S. Pat. No. 8,642,497 discloses the preparation of N,N-dimethylanilinium tetrakis(heptafluoronaphth-2-yl)borateanion.

US 2003/0013913 (granted as U.S. Pat. No. 7,101,940) discloses various activators such as N,N-dimethylcyclohexylammoniumtetrakis(pentafluorophenyl)borate [0070], and N,N-diethylbenzylammoniumtetrakis(pentafluorophenyl)borate [0124].

US 2002/0062011 discloses phenyl dioctadecylammonium(hydroxyphenyl) tris(pentafluorophenyl) borate at paragraph [0200] and (pentafluorophenyl) dioctadecylammonium tetrakis(pentafluorophenyl) borate at paragraph [0209].

U.S. Pat. Nos. 7,799,879, 7,985,816, 8,580,902, 8,835,587, and WO2010/014344 describe ammonium borate activators that include some that use a tetrakis(heptafluoronaphth-2-yl)borate anion.

Furthermore, it would be expected that altering the activator chemical structure, such as using a different anion, would provide altered polymerization and polymer properties. As an example, using an activator having heptafluoronaphth-2-yl groups instead of perfluoro-phenyl groups as part of the borate anion would reduce activation of the catalyst because of the increased steric bulk of heptafluoronaphth-2-yl groups versus perfluoro-phenyl groups. Accordingly, research into different activator chemical structures has been limited.

Nonetheless, there remains a need for catalyst systems having activators that are soluble in aliphatic hydrocarbons and catalyst systems capable of producing polyolefins having, for example, high comonomer incorporation, low molecular weight, and or a melt temperature of about 120° C. or greater. Likewise, there is a need for catalyst systems having activators that are soluble in aliphatic hydrocarbons and capable of producing polyolefins at the same or improved activity levels, as compared to conventional activators, where the polymers can have high comonomer incorporation, low molecular weight, and or a melt temperature of about 120° C. or greater.

References of interest include: WO 2002/002577; WO 2006/066126; WO 2010/132811; U.S. Pat. Nos. 7,087,602; 8,642,497; 6,121,185; 8,642,497; US 2015/0203602; Chemical Abstract Service (CAS) number 909721-53-5; Chemical Abstract Service (CAS) number 943521-08-2; U.S. Ser. No. 16/394,174, filed Apr. 25, 2019, U.S. Ser. No. 16/394,166, filed Apr. 25, 2019; U.S. Ser. No. 16/394,197, filed Apr. 25, 2019; U.S. Ser. No. 16/394,186, filed Apr. 25, 2019; U.S. Ser. No. 16/394,520, filed Apr. 25, 2019; U.S. Ser. No. 16/394,566, filed Apr. 25, 2019; and U.S. Ser. No. 62/882,088, filed Aug. 2, 2019.

### SUMMARY

The present disclosure relates to catalyst systems comprising:

1) a catalyst compound represented by the formula (CI):

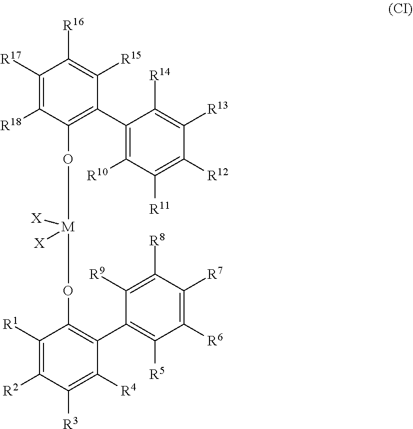

M is selected from the group consisting of Ti, Zr, and Hf;

where each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is independently selected from the group consisting of hydrogen, hydrocarbyl, substituted hydrocarbyl, heterohydrocarbyl, substituted heterohydrocarbyl, alkoxy, substituted alkoxy, aryloxy, substituted aryloxy, hydroxyl, alkylthio, substituted alkylthio, arylthio, substituted arylthio, aryl, substituted aryl, heteroaryl, substituted heteroaryl, halide, silyl, boryl, phosphinyl, and amino; with the proviso that at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is an oxadiazole group having the following structure:

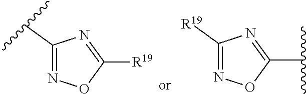

where R¹⁹ is independently selected from the group consisting of hydrogen, hydrocarbyl, substituted hydrocarbyl, heterohydrocarbyl, substituted heterohydrocarbyl, alkoxy, substituted alkoxy, aryloxy, substituted aryloxy, hydroxyl, alkylthio, substituted alkylthio, arylthio, substituted arylthio, aryl, substituted aryl, heteroaryl, substituted heteroaryl, halide, silyl, boryl, phosphinyl, and amino; and

each X is independently a leaving group; and

2) an activator compound represented by Formula (AI):

[R¹R²R³EH]_{d}⁺[M^{k+}Qₙ]^{d-} (AI)

wherein:

E is nitrogen or phosphorous;

d is 1, 2 or 3; k is 1, 2, or 3;

n is 1, 2, 3, 4, 5, or 6; n−k=d;

each of R¹, R², and R³ is independently H, an optionally substituted C₁-C₄₀ alkyl, or an optionally substituted C₅-C₅₀-aryl, wherein R¹, R², and R³ together comprise 15 or more carbon atoms;

M is an element selected from group 13 of the Periodic Table of the Elements; and

each Q is independently a hydrogen, bridged or unbridged dialkylamido, halide, alkoxy, substituted alkoxy, aryloxy, substituted aryloxy, hydrocarbyl, substituted hydrocarbyl, halocarbyl, substituted halocarbyl, or halosubstituted-hydrocarbyl radical.

In yet another embodiment, the present disclosure provides a catalyst system further comprising a support.

In still another embodiment, the present disclosure provides a polymerization process comprising a) contacting one or more olefin monomers with a catalyst system comprising: i) an activator as described herein, ii) a catalyst compound as described herein, and iii) optional support.

In still another embodiment, the present disclosure provides a polyolefin formed by a catalyst system and or method of the present disclosure.

### BRIEF DESCRIPTION OF THE FIGURES

FIG. 1 is a graph illustrating catalyst activity data for ethylene-octene polymerizations, according to an embodiment.

### DETAILED DESCRIPTION

### Definitions

Unless otherwise noted all melt temperatures (Tm) are DSC second melt and are determined using the following DSC procedure according to ASTM D3418-03. Differential scanning calorimetric (DSC) data are obtained using a TA Instruments model Q200 machine. Samples weighing about 5 to about 10 mg are sealed in an aluminum hermetic sample pan. The DSC data are recorded by first gradually heating the sample to about 200° C. at a rate of about 10° C./minute. The sample is kept at about 200° C. for about 2 minutes, then cooled to about −90° C. at a rate of about 10° C./minute, followed by an isothermal for about 2 minutes and heating to about 200° C. at about 10° C./minute. Both the first and second cycle thermal events are recorded. The melting points reported herein are obtained during the second heating/cooling cycle unless otherwise noted.

All molecular weights are weight average (Mw) unless otherwise noted. All molecular weights are reported in g/mol unless otherwise noted. Melt index (MI), also referred to as 12, reported in g/10 min, is determined according to ASTM D-1238, 190° C., 2.16 kg load. High load melt index (HLMI) also referred to as 121, reported in g/10 min, is determined according to ASTM D-1238, 190° C., 21.6 kg load. Melt index ratio (MIR) is MI divided by HLMI as determined by ASTM D1238.

The specification describes catalysts that can be transition metal complexes. The term complex is used to describe molecules in which an ancillary ligand is coordinated to a central transition metal atom. The ligand is bulky and stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization or oligomerization function using an activator which is believed to create a cation as a result of the removal of an anionic group, often referred to as a leaving group, from the transition metal.

For the purposes of the present disclosure, the numbering scheme for the Periodic Table Groups is the “New” notation as described in Chemical and Engineering News, 63(5), pg. 27 (1985). Therefore, a “Group 8 metal” is an element from Group 8 of the Periodic Table, e.g., Fe, and so on.

The following abbreviations are used through this specification: Me is methyl, Ph is phenyl, Et is ethyl, Pr is propyl, iPr is isopropyl, n-Pr is normal propyl, Bu is butyl, iBu is isobutyl, tBu is tertiary butyl, p-tBu is para-tertiary butyl, nBu is normal butyl, sBu is sec-butyl, TNOAL is tri(n-octyl)aluminum, p-Me is para-methyl, Bn is benzyl (i.e., CH₂Ph), RT is room temperature (and is 23° C. unless otherwise indicated), tol is toluene, MeCy is methylcyclohexane, and Cy is cyclohexyl.

Unless otherwise indicated (e.g., the definition of “substituted hydrocarbyl”, etc.), the term “substituted” means that at least one hydrogen atom has been replaced with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a ring structure.

The terms “hydrocarbyl radical,” “hydrocarbyl,” and “hydrocarbyl group,” are used interchangeably throughout this disclosure. Likewise, the terms “group”, “radical”, and “substituent” are also used interchangeably in this disclosure. For purposes of this disclosure, “hydrocarbyl radical” is defined to be C₁-C₁₀₀ radicals of carbon and hydrogen, that may be linear, branched, or cyclic, and when cyclic, aromatic or non-aromatic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like.

Substituted hydrocarbyl radicals are radicals in which at least one hydrogen atom of the hydrocarbyl radical has been replaced with a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring.

Halocarbyl radicals (also referred to as halocarbyls, halocarbyl groups or halocarbyl substituents) are radicals in which one or more hydrocarbyl hydrogen atoms have been substituted with at least one halogen (also referred to as a “halide”) (e.g., F, Cl, Br, I) or halogen-containing group (e.g., CF₃). Substituted halocarbyl radicals are radicals in which at least one halocarbyl hydrogen or halogen atom has been substituted with at least one functional group such as NR*₂, OR*, SeR*, TeR*, PR*₂, AsR*₂, SbR*₂, SR*, BR*₂, SiR*₃, GeR*₃, SnR*₃, PbR*₃, and the like or where at least one non-carbon atom or group has been inserted within the halocarbyl radical such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Si(R*)₂—, —Ge(R*)₂—, —Sn(R*)₂—, —Pb(R*)₂— and the like, where R* is independently a hydrocarbyl or halocarbyl radical provided that at least one halogen atom remains on the original halocarbyl radical. Additionally, two or more R* may join together to form a substituted or unsubstituted saturated, partially unsaturated or aromatic cyclic or polycyclic ring structure.

Hydrocarbylsilyl groups, also referred to as silylcarbyl groups (also referred to as hydrocarbyl silyl groups), are radicals in which one or more hydrocarbyl hydrogen atoms have been substituted with at least one SiR*₃ containing group or where at least one —Si(R*)₂— has been inserted within the hydrocarbyl radical where R* is independently a hydrocarbyl or halocarbyl radical, and two or more R* may join together to form a substituted or unsubstituted saturated, partially unsaturated or aromatic cyclic or polycyclic ring structure. Silylcarbyl radicals can be bonded via a silicon atom or a carbon atom.

Substituted silylcarbyl radicals are silylcarbyl radicals in which at least one hydrogen atom has been substituted with at least one functional group such as NR*₂, OR*, SeR*, TeR*, PR*₂, AsR*₂, SbR*₂, SR*, BR*₂, GeR*₃, SnR*₃, PbR₃ and the like or where at least one non-hydrocarbon atom or group has been inserted within the silylcarbyl radical, such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Ge(R*)₂—, —Sn(R*)₂—, —Pb(R*)₂— and the like, where R* is independently a hydrocarbyl or halocarbyl radical, and two or more R* may join together to form a substituted or unsubstituted saturated, partially unsaturated or aromatic cyclic or polycyclic ring structure.

The terms “alkyl radical,” and “alkyl” are used interchangeably throughout this disclosure. For purposes of this disclosure, “alkyl radicals” are defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like. Substituted alkyl radicals are radicals in which at least one hydrogen atom of the alkyl radical has been substituted with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring.

The term “branched alkyl” means that the alkyl group contains a tertiary or quaternary carbon (a tertiary carbon is a carbon atom bound to three other carbon atoms. A quaternary carbon is a carbon atom bound to four other carbon atoms). For example, 3,5,5 trimethylhexylphenyl is an alkyl group (hexyl) having three methyl branches (hence, one tertiary and one quaternary carbon) and thus is a branched alkyl bound to a phenyl group. Unless otherwise indicated a branched alkyl includes all isomers thereof.

The term “alkenyl” means a straight-chain, branched-chain, or cyclic hydrocarbon radical having one or more carbon-carbon double bonds. These alkenyl radicals may be substituted. Examples of suitable alkenyl radicals can include ethenyl, propenyl, allyl, 1,4-butadienyl cyclopropenyl, cyclobutenyl, cyclopentenyl, cyclohexenyl, cyclooctenyl and the like.

The term “arylalkenyl” means an aryl group where a hydrogen has been replaced with an alkenyl or substituted alkenyl group. For example, styryl indenyl is an indene substituted with an arylalkenyl group (a styrene group).

The term “alkoxy”, “alkoxyl”, or “alkoxide” means an alkyl ether or aryl ether radical wherein the terms “alkyl” and “aryl” are as defined herein. Examples of suitable alkyl ether radicals can include methoxy, ethoxy, n-propoxy, iso-propoxy, n-butoxy, iso-butoxy, sec-butoxy, tert-butoxy, phenoxy, and the like.

The term “aryl” or “aryl group” means a carbon-containing aromatic ring such as phenyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

Heterocyclic means a cyclic group where a ring carbon atom (or two or three ring carbon atoms) has been replaced with a heteroatom, such as N, O, or S. A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

Substituted heterocyclic means a heterocyclic group where at least one hydrogen atom of the heterocyclic radical has been substituted with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical.

A substituted aryl is an aryl group where at least one hydrogen atom of the aryl radical has been substituted with at least a non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring, for example 3,5-dimethylphenyl is a substituted phenyl group.

The term “substituted phenyl,” or “substituted phenyl group” means a phenyl group having one or more hydrogen groups replaced by a hydrocarbyl, substituted hydrocarbyl, heteroatom or heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl, halogen, or halocarbyl radical. Preferably the “substituted phenyl” group is represented by the formula:

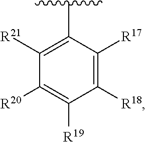

where each of R¹⁷, R¹⁸, R¹⁹, R²⁰, and R²¹ is independently selected from hydrogen, C₁-C₄₀ hydrocarbyl or C₁-C₄₀ substituted hydrocarbyl, a heteroatom, such as halogen, or a heteroatom-containing group (provided that at least one of R¹⁷, R¹⁸, R¹⁹, R²⁰, and R²¹ is not H), or a combination thereof.

A “fluorophenyl” or “fluorophenyl group” is a phenyl group substituted with one, two, three, four or five fluorine atoms.

A “fluoroaryl” or “fluoroaryl group” is an aryl group substituted with at least one fluorine atom, such as the aryl is perfluorinated.

A “chlorophenyl” or “chlorophenyl group” is a phenyl group substituted with one, two, three, four or five chlorine atoms.

A “chloroaryl” or “chloroaryl group” is an aryl group substituted with at least one chlorine atom, such as the aryl is perchlorinated.

The term “arylalkyl” means an aryl group where a hydrogen has been replaced with an alkyl or substituted alkyl group. For example, 3,5′-di-tert-butyl-phenyl indenyl is an indene substituted with an arylalkyl group. When an arylalkyl group is a substituent on another group, it is bound to that group via the aryl. For example in Formula (AI), the aryl portion is bound to E.

The term “alkylaryl” means an alkyl group where a hydrogen has been replaced with an aryl or substituted aryl group. For example, phenethyl indenyl is an indene substituted with an ethyl group bound to a benzene group. When an alkylaryl group is a substituent on another group, it is bound to that group via the alkyl. For example in Formula (AI), the alkyl portion is bound to E.

Reference to an alkyl, alkenyl, alkoxide, or aryl group without specifying a particular isomer (e.g., butyl) expressly discloses all isomers (e.g., n-butyl, iso-butyl, sec-butyl, and tert-butyl), unless otherwise indicated.

The term “ring atom” means an atom that is part of a cyclic ring structure. Accordingly, a benzyl group has six ring atoms and tetrahydrofuran has 5 ring atoms.

For purposes of the present disclosure, a “catalyst system” is a combination of at least one catalyst compound, an activator, and an optional support material. The catalyst systems may further comprise one or more additional catalyst compounds. For the purposes of the present disclosure, when catalyst systems are described as comprising neutral stable forms of the components, it is well understood by one of ordinary skill in the art, that the ionic form of the component is the form that reacts with the monomers to produce polymers. Catalysts of the present disclosure represented by formula (CI), etc. and activators represented by Formula (I) or (AI), etc. are intended to embrace ionic forms in addition to the neutral forms of the compounds.

“Complex” as used herein, is also often referred to as catalyst precursor, precatalyst, catalyst, catalyst compound, transition metal compound, or transition metal complex. These words are used interchangeably.

A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments a co-activator can be pre-mixed with the transition metal compound to form an alkylated transition metal compound.

In the description herein, a catalyst may be described as a catalyst precursor, a pre-catalyst compound, a catalyst compound or a transition metal compound, and these terms are used interchangeably. A polymerization catalyst system is a catalyst system that can polymerize monomers into polymer. An “anionic ligand” is a negatively charged ligand which donates one or more pairs of electrons to a metal ion. A “neutral donor ligand” is a neutrally charged ligand which donates one or more pairs of electrons to a metal ion.

A metallocene catalyst is defined as an organometallic compound with at least one π-bound cyclopentadienyl moiety or substituted cyclopentadienyl moiety (such as substituted or unsubstituted Cp, Ind, or Flu) and more frequently two (or three) T-bound cyclopentadienyl moieties or substituted cyclopentadienyl moieties (such as substituted or unsubstituted Cp, Ind, or Flu). (Cp=cyclopentadienyl, Ind=indenyl, Flu=fluorenyl).

For purposes of the present disclosure, in relation to catalyst compounds, the term “substituted” means that a hydrogen group has been replaced with a hydrocarbyl group, a heteroatom, or a heteroatom containing group. For example, methyl cyclopentadiene (Cp) is a Cp group substituted with a methyl group.

“Catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹ hr⁻¹. “Conversion” is the amount of monomer that is converted to polymer product, and is reported as mol % and is calculated based on the polymer yield and the amount of monomer fed into the reactor. “Catalyst activity” is a measure of the level of activity of the catalyst and is reported as the mass of product polymer (P) produced per mole (or mmol) of catalyst (cat) used (kgP/molCat or gP/mmolCat or kgP/mmolCat), and catalyst activity can also be expressed per unit of time, for example, per hour (hr), e.g., (kg/mmol h).

For purposes herein an “olefin,” alternatively referred to as “alkene,” is a linear, branched, or cyclic compound comprising carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have a “propylene” content of 35 wt % to 55 wt %, it is understood that the mer unit in the copolymer is derived from propylene in the polymerization reaction and the derived units are present at 35 wt % to 55 wt %, based upon the weight of the copolymer.

For purposes herein a “polymer” has two or more of the same or different monomer (“mer”) units. A “homopolymer” is a polymer having mer units that are the same. A “copolymer” is a polymer having two or more mer units that are different from each other. A “terpolymer” is a polymer having three mer units that are different from each other. “Different” in reference to mer units indicates that the mer units differ from each other by at least one atom or are different isomerically. Accordingly, copolymer, as used herein, can include terpolymers and the like. An oligomer is typically a polymer having a low molecular weight, such an Mn of less than 25,000 g/mol, or less than 2,500 g/mol, or a low number of mer units, such as 75 mer units or less or 50 mer units or less. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn.

The term “continuous” means a system that operates without interruption or cessation for a period of time, such as where reactants are continually fed into a reaction zone and products are continually or regularly withdrawn without stopping the reaction in the reaction zone. For example, a continuous process to produce a polymer would be one where the reactants are continually introduced into one or more reactors and polymer product is continually withdrawn.

A “solution polymerization” means a polymerization process in which the polymerization is conducted in a liquid polymerization medium, such as an inert solvent or monomer(s) or their blends. A solution polymerization is typically homogeneous. A homogeneous polymerization is one where the polymer product is dissolved in the polymerization medium. Such systems are typically not turbid as described in Oliveira, J. V. et al. (2000) “High-Pressure Phase Equilibria for Polypropylene-Hydrocarbon Systems,” Ind. Eng. Chem. Res., v. 39, pp. 4627-4633.

A bulk polymerization means a polymerization process in which the monomers and/or comonomers being polymerized are used as a solvent or diluent using little or no inert solvent or diluent. A small fraction of inert solvent might be used as a carrier for catalyst and scavenger. A bulk polymerization system contains less than about 25 wt % of inert solvent or diluent, such as less than about 10 wt %, such as less than about 1 wt %, such as 0 wt %.

Unless otherwise indicated, as used herein, “low comonomer content” is defined as a polyolefin having less than 8 wt % of comonomer based upon the total weight of the polyolefin. As used herein, “high comonomer content” is defined as a polyolefin having greater than or equal to 8 wt % of comonomer based upon the total weight of the polyolefin.

Unless otherwise indicated, as used herein, “high molecular weight” is defined as a number average molecular weight (Mn) value of 100,000 g/mol or more. “Low molecular weight” is defined as an Mn value of less than 100,000 g/mol.

For example, the present disclosure provides activators, catalyst systems comprising catalyst compounds and activators, and methods for polymerizing olefins using said catalyst systems. In the present disclosure, activators are described that feature ammonium or phosphonium groups with long-chain aliphatic hydrocarbyl groups for improved solubility of the activator in aliphatic solvents, as compared to conventional activator compounds.

The present disclosure provides catalyst systems and methods thereof. The catalyst systems include one or more phenol-oxadiazole catalysts and one or more catalyst activators (having a non-coordinating anion) that are soluble in an aliphatic hydrocarbon solvent. It has been discovered that catalyst systems having a phenol-oxadiazole catalyst and a catalyst activator having, for example, a cation having 15 or more carbon atoms carbon atoms can provide catalyst systems having activators that are soluble in aliphatic hydrocarbons, and the catalyst systems are capable of producing polyolefins at the same or improved catalyst activities, as compared to conventional activators. In addition, the polymers produced herein can have the same or improved polymer properties, as compared to polymers produced using conventional catalyst systems. For example, polyolefins of the present disclosure can have high comonomer incorporation, low molecular weight, and or a melt temperature of about 120° C. or greater. Accordingly, catalyst systems of the present disclosure provide soluble activators in addition to improved or maintained catalyst activities and polymer properties. Catalyst systems therefore provide commercially viable catalyst systems without the use of toluene for preparation of the catalyst systems.

The present disclosure relates to catalyst systems having phenol-oxadiazole catalyst compound(s) and activator compound(s) that can be used in olefin polymerization processes. For example, the present disclosure provides catalyst systems including phenol-oxadiazole catalyst compound(s) and ammonium borate activator(s), and methods for polymerizing olefins using such catalyst systems. In the present disclosure, activators are described that feature ammonium groups with long-chain aliphatic hydrocarbyl groups for improved solubility of the activator in aliphatic solvents, as compared to conventional activator compounds. Useful borate groups of the present disclosure include fluoroaryl (such as fluoronaphthyl borates and or fluorophenyl borates). It has been discovered that activators of the present disclosure having borate anions and ammonium cations having, for example, an aliphatic hydrocarbyl moiety can have improved solubility in aliphatic solvents, as compared to conventional activator compounds. Activators having a cation as described herein can provide enhanced activity for polymer production.

In another aspect, the present disclosure relates to polymer compositions obtained from the catalyst systems and processes set forth herein. The components of the catalyst systems according to the present disclosure and used in the polymerization processes of the present disclosure, as well as the resulting polymers, are described in more detail herein below.

The present disclosure relates to catalyst systems including a transition metal compound represented by formula (CI) and an activator compound represented by formula (AI), to the use of an activator compound represented by formula (AI) for activating the transition metal compound represented by formula (CI) in catalyst systems for polymerizing olefins, and to processes for polymerizing olefins, the processes including contacting under polymerization conditions one or more olefins with a catalyst system comprising a transition metal compound represented by formula (CI) and an activator compound represented by formula (AI).

The activator compounds of formula (AI) and the transition metal compounds represented by formula (CI) are further illustrated below. Any combinations of cations and non-coordinating anions disclosed herein are suitable to be used in the processes of the present disclosure and are thus incorporated herein.

### Activators

The terms “cocatalyst” and “activator” are used herein interchangeably and are a compound which can activate any one of the catalyst compounds of the present disclosure by converting the neutral catalyst compound to a catalytically active catalyst compound cation. Activators of the present disclosure have one or more non-coordinating anions (NCAs). Non-coordinating anion (NCA) means an anion either that does not coordinate to the catalyst metal cation or that does coordinate to the metal cation, but only weakly. The term NCA is also defined to include multicomponent NCA-containing activators, such as N,N-dimethylanilinium tetrakis(perfluoronaphthyl)borate, that contain an acidic cationic group and the non-coordinating anion. The term NCA is also defined to include neutral Lewis acids, such as tris(pentafluoronaphthyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the non-coordinating anion. Suitable metals can include aluminum, gold, and platinum. Suitable metalloids can include boron, aluminum, phosphorus, and silicon. The term non-coordinating anion activator includes neutral activators, ionic activators, and Lewis acid activators.

“Compatible” non-coordinating anions can be those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization.

The present disclosure provides activators, such as ammonium or phosphonium metallate or metalloid activator compounds, the activators comprising (1) ammonium or phosphonium groups and long-chain aliphatic hydrocarbyl groups and (2) metallate or metalloid anions, such as borates or aluminates. When an activator of the present disclosure is used with one or more catalyst compounds described herein in an olefin polymerization, a polymer can be formed having high comonomer incorporation, low molecular weight, and or a melt temperature of about 120° C. or greater. In addition, it has been discovered that activators of the present disclosure are soluble in aliphatic solvent.

In one or more embodiments, a 10 wt % mixture (such as 20 wt %) mixture of the activator compound in n-hexane, isohexane, cyclohexane, methylcyclohexane, or a combination thereof, forms a clear homogeneous solution at 25° C., preferably a 30 wt % mixture of the compound in n-hexane, isohexane, cyclohexane, methylcyclohexane, or a combination thereof, forms a clear homogeneous solution at 25° C.

In one or more embodiments, a 10 wt % mixture (such as a 20 wt % mixture) of the catalyst system in n-hexane, isohexane, cyclohexane, methylcyclohexane, or a combination thereof, forms a clear homogeneous solution at 25° C., preferably a 30 wt % mixture of the compound in n-hexane, isohexane, cyclohexane, methylcyclohexane, or a combination thereof, forms a clear homogeneous solution at 25° C.

In some embodiments, the activators described herein have a solubility of more than 10 mM (or more than 20 mM, or more than 50 mM) at 25° C. (stirred 2 hours) in methylcyclohexane (MeCy).

In some embodiments, the activators described herein have a solubility of more than 1 mM (or more than 10 mM, or more than 20 mM) at 25° C. (stirred 2 hours) in isohexane.

In some embodiments, the activators described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In some embodiments, the catalyst systems described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

The present disclosure relates to a catalyst system comprising a transition metal compound and an activator compound as described herein, to the use of such activator compounds for activating a transition metal compound in a catalyst system for polymerizing olefins, and to processes for polymerizing olefins, the process comprising contacting under polymerization conditions one or more olefins with a catalyst system comprising a transition metal compound and such activator compounds, where aromatic solvents, such as toluene, are absent (e.g. present at zero mol %, alternately present at less than 1 mol %, preferably the catalyst system, the polymerization reaction and/or the polymer produced are free of “detectable aromatic hydrocarbon solvent,” such as toluene. For purposes of the present disclosure, “detectable aromatic hydrocarbon solvent” means 0.1 mg/m² or more as determined by gas phase chromatography. For purposes of the present disclosure, “detectable toluene” means 0.1 mg/m² or more as determined by gas phase chromatography.

The polyolefins produced herein preferably contain 0 ppm (alternately less than 1 ppm, alternately less than 1 ppb) of aromatic hydrocarbon. Preferably, the polyolefins produced herein contain 0 ppm (alternately less than 1 ppm, alternately less than 1 ppb) of toluene.

The catalyst systems used herein preferably contain 0 ppm (alternately less than 1 ppm, alternately less than 1 ppb) of aromatic hydrocarbon. Preferably, the catalyst systems used herein contain 0 ppm (alternately less than 1 ppm, alternately less than 1 ppb) of toluene.

The present disclosure provides activator compounds represented by Formula (AI):

[R¹R²R³EH]_{d}⁺[M^{k+}Qₙ]^{d-} (AI)

wherein:

E is nitrogen or phosphorous, preferably nitrogen;

d is 1, 2 or 3 (preferably 3); k is 1, 2, or 3 (preferably 3); n is 1, 2, 3, 4, 5, or 6 (preferably 4, 5, or 6); n−k=d (preferably d is 1, 2 or 3; k is 3; n is 4, 5, or 6, preferably when M is B, n is 4);

each of R¹, R², and R³ is independently H, optionally substituted C₁-C₄₀ alkyl (such as branched or linear alkyl), or optionally substituted C₅-C₅₀-aryl (alternately each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl); wherein R¹, R², and R³ together comprise 15 or more carbon atoms,

M is an element selected from group 13 of the Periodic Table of the Elements, preferably B or Al, preferably B; and

each Q is independently selected from the group consisting of a hydrogen, bridged or unbridged dialkylamido, halide, alkoxy, substituted alkoxy, aryloxy, substituted aryloxy, hydrocarbyl, substituted hydrocarbyl, halocarbyl, substituted halocarbyl, and halosubstituted-hydrocarbyl radical, preferably a fluorinated aryl group, such fluoro-phenyl or fluoro-naphthyl, more preferably perfluorophenyl or perfluoronaphthyl.

In some embodiments of activator compounds represented by Formula (AI), at least one of R¹, R², and R³ is a linear or branched C₃-C₄₀ alkyl group (alternately such as a linear or branched C₇ to C₄₀ alkyl group).

The present disclosure also provides activator compounds represented by Formula (AI), described above where R¹ is a C₁-C₃₀ alkyl group (preferably a C₁-C₁₀ alkyl group, preferably C₁ to C₂ alkyl, preferably methyl), wherein R¹ is optionally substituted, and each of R² and R³ is independently an optionally substituted branched or linear C₁-C₄₀ alkyl group or meta and/or para-substituted phenyl group, where the meta and para substituents are, independently, an optionally substituted C₁ to C₄₀ hydrocarbyl group, an optionally substituted alkoxy group, an optionally substituted silyl group, a halogen, or a halogen containing group, wherein R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms) and at least one of R¹, R², and R³ is a linear or branched alkyl (such as a C₃-C₄₀ branched alkyl, alternately C₇-C₄₀ branched alkyl).

The present disclosure further provides catalyst systems including activator compounds represented by Formula (AI), as described above where R¹ is methyl; and each of R² and R³ is independently C₁-C₄₀ branched or linear alkyl or C₅-C₅₀-aryl, wherein each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; wherein R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms).

The present disclosure also provides catalyst systems having activator compounds represented by Formula (I):

[R¹R²R³EH]⁺[BR⁴R⁵R⁶R⁷]⁻ (I)

where:

E is nitrogen or phosphorous;

each of R¹, R², and R³ is independently C₁-C₄₀ linear or branched alkyl or C₅-C₅₀-aryl (such as C₅ to C₂₂), where each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; where R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms); and

each of R⁴, R⁵, R⁶, and R⁷ is phenyl or naphthyl, wherein at least one of R⁴, R⁵, R⁶, and R⁷ is substituted with from one to seven fluorine atoms.

In some embodiments, at least one of R¹, R², and R³ is a linear or branched C₃-C₄₀ alkyl (such as a linear or branched C₇ to C₄₀ alkyl).

The present disclosure further provides catalyst systems including activator compounds represented by Formula (AI) as described above, where each of R¹, R², and R³ is independently C₁-C₄₀ linear or branched alkyl, C₅-C₅₀-aryl (such as C₅ to C₂₂), wherein each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; wherein R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms. In some embodiments, at least one of R¹, R², and R³ is a linear or branched alkyl (such as a linear or branched C₃-C₄₀ alkyl), such as at least two of R¹, R², and R³ are a branched alkyl (such as a C₃-C₄₀ branched alkyl), such as each of R¹, R², and R³ is a branched alkyl (such as a C₁₀-C₄₀ branched alkyl).

In at least one embodiment of formula (AI) or (I) herein M is an element selected from group 13 of the Periodic Table of the Elements, preferably boron or aluminum, preferably B.

In at least one embodiment of formula (AI) or (I) herein each Q is independently selected from a hydrogen, bridged or unbridged dialkylamido, halide, alkoxy, substituted alkoxy, aryloxy, substituted aryloxy, hydrocarbyl, substituted hydrocarbyl, halocarbyl, substituted halocarbyl, and halosubstituted-hydrocarbyl radical. Preferably, each Q is a fluorinated hydrocarbyl group having 1 to 30 carbon atoms, more preferably each Q is a fluorinated aryl (such as phenyl or naphthyl) group, and most preferably each Q is a perflourinated aryl (such as phenyl or naphthyl) group.

In at least one embodiment of formula (AI) herein, examples of suitable [M^{k+}Qₙ]^{d-} also include diboron compounds as disclosed in U.S. Pat. No. 5,447,895, which is fully incorporated herein by reference.

In at least one embodiment, the activator is represented by Formula (I):

[R¹R²R³EH]⁺[BR⁴R⁵R⁶R⁷]⁻ (I)

wherein:

E is nitrogen or phosphorous, preferably nitrogen;

each of R¹, R², and R³ is independently C₁-C₄₀ linear or branched alkyl, C₅-C₂₂-aryl, arylalkyl where the alkyl has from 1 to 30 carbon atoms and the aryl has from 6 to 20 carbon atoms, or five-, six- or seven-membered heterocyclyl comprising at least one atom selected from N, P, O and S, wherein each of R¹ R², and R³ is optionally substituted by halogen, wherein R² optionally bonds with R⁵ to independently form a five-, six- or seven-membered ring, preferably wherein, R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms; each of R⁴, R⁵, R⁶, and R⁷ is independently is independently a hydrogen, bridged or unbridged dialkylamido, halide, alkoxide, aryloxide, hydrocarbyl, substituted hydrocarbyl, halocarbyl, substituted halocarbyl, or halosubstituted-hydrocarbyl radical, preferably, each of R⁴, R⁵, R⁶, and R⁷ is independently is a fluorinated hydrocarbyl group having 1 to 30 carbon atoms, more preferably each Q is a fluorinated aryl (such as phenyl or naphthyl) group (substituted with from one to seven fluorine atoms), and most preferably each Q is a perflourinated aryl (such as phenyl or naphthyl) group.

In some embodiments of the activator represented by Formula (I), at least one of R¹, R², and R³ is a branched alkyl (such as a C₇-C₄₀ branched alkyl), alternately at least two of R¹, R², and R³ are a branched alkyl (such as a C₇-C₄ branched alkyl), alternately all three of R¹, R², and R³ are a branched alkyl (such as a C₇-C₄ branched alkyl).

In at least one embodiment, an activator is an ionic ammonium or phosphonium borate represented by Formula (I):

[R¹R²R³EH]⁺[BR⁴R⁵R⁶R⁷]⁻ (I)

where:

E is nitrogen or phosphorous;

R¹ is a C₁-C₄₀ linear alkyl, preferably methyl;

each of R², and R³ is independently C₁-C₄₀ linear or branched alkyl, C₅-C₂₂-aryl, C₅ to C₅₀ arylalkyl where the alkyl has from 1 to 30 carbon atoms and the aryl has from 6 to 20 carbon atoms, or five-, six- or seven-membered heterocyclyl comprising at least one atom selected from N, P, O and S, wherein each of R¹ R², and R³ is optionally substituted by halogen, wherein R² optionally bonds with R⁵ to independently form a five-, six- or seven-membered ring, preferably wherein, R, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms; and

each of R⁴, R⁵, R⁶, and R⁷ is independently each a fluorinated hydrocarbyl group having 1 to 30 carbon atoms, more preferably each of R⁴, R⁵, R⁶, and R⁷ is independently is a fluorinated aryl (such as phenyl or naphthyl) group, and most preferably each of R⁴, R⁵, R⁶, and R⁷ is independently is a perflourinated aryl (such as phenyl or naphthyl) group, wherein at least one of R⁴, R⁵, R⁶, and R⁷ is substituted with from one to seven fluorine atoms.

The present disclosure also provides catalyst systems including activator compounds represented by Formula (I):

[R¹R²R³EH]⁺[BR⁴R⁵R⁶R⁷]⁻ (I)

where:

E is nitrogen or phosphorous, preferably nitrogen;

each of R¹, R², and R³ is independently C₁-C₄₀ linear or branched alkyl, C₅-C₅₀-aryl, wherein each of R¹, R², and R³ is independently unsubstituted or substituted with at least one of halide, C₁-C₅₀ alkyl, C₅-C₅₀ aryl, C₆-C₃₅ arylalkyl, or C₆-C₃₅ alkylaryl, wherein R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms, provided that at least one of R¹, R², and R³ is a C₃-C₄₀ branched alkyl, alternately at least two of R¹, R², and R³ are a C₃-C₄ branched alkyl; and each of R⁴, R⁵, R⁶, and R⁷ is naphthyl, wherein at least one of R⁴, R⁵, R⁶, and R⁷ is substituted with from one to seven fluorine atoms, preferably seven fluorine atoms.

In a preferred aspect, the activator is an ionic ammonium borate represented by Formula (I):

[R¹R²R³EH]⁺[BR⁴R⁵R⁶R⁷]⁻ (I)

where:

E is nitrogen or phosphorous;

R¹ is a methyl group;

R² is C₆-C₅₀ aryl which is optionally substituted with at least one of halide, C₁-C₃₅ alkyl, C₅-C₁₅ aryl, C₆-C₃₅ arylalkyl, and C₆-C₃₅ alkylaryl;

R³ is C₁-C₄₀ branched alkyl which is optionally substituted with at least one of halide, C₁-C₃₅ alkyl, C₅-C₁₅ aryl, C₆-C₃₅ arylalkyl, and C₆-C₃₅ alkylaryl, wherein R² optionally bonds with R³ to independently form a five-, six- or seven-membered ring, and R² and R³ together comprise 20 or more carbon atoms, such as 21 or more carbon atoms, such as 22 or more carbon atoms, such as 25 or more carbon atoms, such as 30 or more carbon atoms, such as 35 or more carbon atoms, such as 40 or more carbon atoms, and

each of R⁴, R⁵, R⁶, and R⁷ is independently each a fluorinated hydrocarbyl group having 1 to 30 carbon atoms, wherein at least one of R⁴, R⁵, R⁶, and R⁷ is independently substituted with from one, two, three, four, five, six, or seven fluorine atoms, more preferably each of R⁴, R⁵, R⁶, and R⁷ is independently a fluorinated aryl (such as phenyl or naphthyl) group, and most preferably each of R⁴, R⁵, R⁶, and R⁷ is independently is a perfluorinated aryl (such as phenyl or naphthyl) group.

Catalyst systems of the present disclosure may be formed by combining the catalysts with activators in any suitable manner, including by supporting them for use in slurry or gas phase polymerization. The catalyst systems may also be added to or generated in solution polymerization or bulk polymerization (in the monomer, i.e., little or no solvent).

Both the cation part of formulas (AI) and (I) as well as the anion part thereof, which is an NCA, will be further illustrated below. Any combinations of cations and NCAs disclosed herein are suitable to be used in the processes of the present disclosure and are thus incorporated herein.

### Activators—The Cations

The cation component of the activators described herein (such as those of formulas (AI) and (I) above), is a protonated Lewis base that can be capable of protonating a moiety, such as an alkyl or aryl, from the transition metal compound. Thus, upon release of a neutral leaving group (e.g. an alkane resulting from the combination of a proton donated from the cationic component of the activator and an alkyl substituent of the transition metal compound) transition metal cation results, which is the catalytically active species.

In any embodiment of formula (I) or (A), where the cation is [R¹R²R³EH]⁺, E is nitrogen or phosphorous, preferably nitrogen; each of R¹, R², and R³ is independently hydrogen, C₁-C₄₀ branched or linear alkyl or C₅-C₅₀-aryl, wherein each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; where R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 37 or more carbon atoms, such as 40 or more carbon atoms, such as 45 or more carbon atoms. In some embodiment, at least one (alternately one, two or three) of R¹, R², and R³ is a linear or branched alkyl, (such as a linear or branched C₃-C₄₀ alkyl, alternately such as a linear or branched C₇ to C₄₀ alkyl).

In at least one embodiment of formula (I) or (A), where the cation is [R¹R²R³EH]⁺, E is nitrogen or phosphorous, and each of R¹, R², and R³ is independently C₁-C₄₀ linear or branched alkyl, C₅-C₅₀-aryl (such as C₅-C₂₂-aryl, preferably an arylalkyl (where the alkyl has from 1 to 10 carbon atoms and the aryl has from 6 to 20 carbon atoms), or five-, six- or seven-membered heterocyclyl comprising at least one atom selected from N, P, O and S, where each of R¹ R², and R³ is optionally substituted by halogen, —NR′₂, —OR′ or —SiR′₃ (where R′ is independently hydrogen or C₁-C₂₀ hydrocarbyl), where R² optionally bonds with R⁵ to independently form a five-, six- or seven-membered ring. R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 37 or more carbon atoms, such as 40 or more carbon atoms, such as 45 or more carbon atoms. In some embodiments, at least one of R¹, R², and R³ is a linear or branched C₃-C₄₀ alkyl, alternately at least two of R¹, R², and R³ are a linear or branched C₃-C₄₀ alkyl.

In at least one embodiment of formula (I) or (AI) described herein one, two or three of R¹, R² and R³ may independently be represented by the formula (AIII):

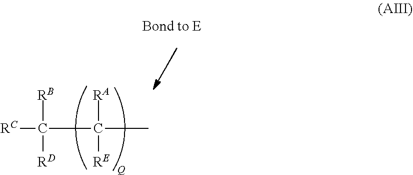

where each of R^{A} and R^{E} are independently H, a C₁-C₄₀ linear or branched alkyl or C₅-C₅₀-aryl, where each of R^{A} and R^{E} is optionally substituted with one or more of halide, C₅-C₅₀ aryl, C₆-C₃₅ arylalkyl, C₆-C₃₅ alkylaryl and, in the case of the C₅-C₅₀-aryl, C₁-C₅₀ alkyl, provided that in at least one (R^{A}—C—R^{E}) group, one or both of R^{A} and R^{E} is not H; and

R^{C}, R^{B} and R^{D} are hydrogen; and Q is an integer from 5 to 40.

In at least one embodiment of Formula (I) or (AI) herein, one, two or three of R¹, R² and R³ may independently be represented by the Formula (IV) where:

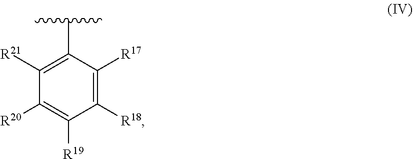

where each of R¹⁷, R¹⁸, R¹⁹, R²⁰, and R²¹ is independently selected from hydrogen, C₁-C₄₀ hydrocarbyl or C₁-C₄₀ substituted hydrocarbyl, a heteroatom, such as halogen, a heteroatom-containing group, or is represented by formula (BIII), for example at least one of R¹⁷, R¹⁸, R¹⁹, R²⁰, and R²¹ is not hydrogen.

In any embodiment of formula (I) or (AI) one, two or three of R¹, R² and R³ may independently be represented by the formula (AIII) or (IV):

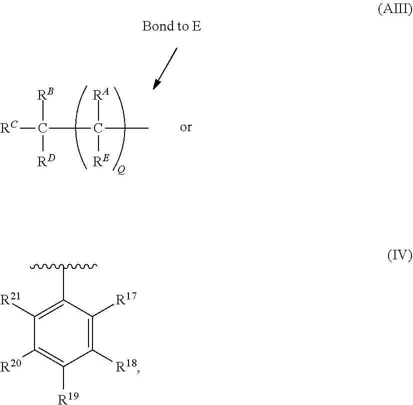

where each of R^{A} and R^{E} are independently selected from H, a C₁-C₄₀ linear or branched alkyl or C₅-C₅₀-aryl, where each of R^{A} and R^{E} is optionally substituted with one or more of halide, C₅-C₅₀ aryl, C₆-C₃₅ arylalkyl, C₆-C₃₅ alkylaryl and, in the case of the C₅-C₅₀-aryl, C₁-C₅₀ alkyl, provided that in at least one (R^{A}—C—R^{E}) group, one or both of R^{A} and R^{E} is not H;

R^{C}, R^{B} and R^{D} are hydrogen; and

Q is an integer from 5 to 40,

each of R¹⁷, R¹⁸, R¹⁹, R²⁰, and R²¹ is independently selected from hydrogen, C₁-C₄₀ hydrocarbyl or C₁-C₄₀ substituted hydrocarbyl, a heteroatom, such as halogen, a heteroatom-containing group, or is represented by Formula (AIII). In some embodiments, at least one of R¹⁷, R¹⁸, R¹⁹, R²⁰, and R²¹ is a branched alkyl, preferably one, two, three, four, or five of R¹⁷, R¹⁸, R¹⁹, R²⁰, and R²¹ are represented by Formula (AIII).

In at least one embodiment, the branched alkyl may have 1 to 30 tertiary or quaternary carbons, alternately 2 to 10 tertiary or quaternary carbons, alternately 2 to 4 tertiary or quaternary carbons, alternately the branched alkyl has 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 tertiary or quaternary carbons.

In any embodiment of Formula (I) or (AI), each of R, R² and R³ may independently be selected from:

1) optionally substituted linear alkyls (such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, or n-tricontyl);

2) optionally substituted branched alkyls (such as alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, alkyl-icosyl (including multi-alkyl analogs, i.e., dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl, etc.), and isomers thereof where each alkyl group is independently a C₁ to C₄₀, (alternately C₂ to C₃₀, alternately C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl);

3) optionally substituted arylalkyls, such as (methylphenyl, ethylphenyl, propylphenyl, butylphenyl, pentylphenyl, hexylphenyl, heptylphenyl, octylphenyl, nonylphenyl, decylphenyl, undecylphenyl, dodecylphenyl, tridecylphenyl, tetradecylphenyl, pentadecylphenyl, hexadecylphenyl, heptadecylphenyl, octadecylphenyl, nonadecylphenyl, icosylphenyl, henicosylphenyl, docosylphenyl, tricosylphenyl, tetracosylphenyl, pentacosylphenyl, hexacosylphenyl, heptacosylphenyl, octacosylphenyl, nonacosylphenyl, tricontylphenyl, 3,5,5-trimethylhexylphenyl, dioctylphenyl, 3,3,5-trimethylhexylphenyl, 2,2,3,3,4 pentamethypentylylphenyl, and the like);

4) optionally substituted silyl groups, such as a trialkylsilyl group, where each alkyl is independently an optionally substituted C₁ to C₂₀ alkyl (such as trimethylsilyl, triethylsilyl, tripropylsilyl, tributylsilyl, trihexylsilyl, triheptylsilyl, trioctylsilyl, trinonylsilyl, tridecylsilyl, triundecylsilyl, tridodecylsilyl, tri-tridecylsilyl, tri-tetradecylsilyl, tri-pentadecylsilyl, tri-hexadecylsilyl, tri-heptadecylsilyl, tri-octadecylsilyl, tri-nonadecylsilyl, tri-icosylsilyl);

5) optionally substituted alkoxy groups (such as —OR*, where R* is an optionally substituted C₁ to C₂₀ alkyl or aryl (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, phenyl, alkylphenyl (such as methyl phenyl, propyl phenyl, etc.), naphthyl, or anthracenyl);

6) halogens (such as Br or Cl); and

7) halogen containing groups (such as bromomethyl, bromophenyl, and the like).

In any embodiment of formula (I) or (AI), R¹ is methyl.

In any embodiment of Formula (I) or (AI), R² is unsubstituted phenyl or substituted phenyl. In at least one embodiment, R² is phenyl, methyl phenyl, n-butyl phenyl, n-octadecyl-phenyl, or an isomer thereof, preferably R² is meta or para substituted phenyl, such as meta- or para-substituted alkyl substituted phenyl.

In any embodiment of Formula (I) or (AI), R³ is linear or branched alkyl such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, n-tricontyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoicosyl, isohenicosyl, isodocosyl, isotricosyl, isotetracosyl, isopentacosyl, isohexacosyl, isoheptacosyl, isooctacosyl, isononacosyl, or isotricontyl, alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, alkyl-icosyl (including multi-alkyl analogs, i.e., dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl), and isomers thereof where each alkyl group is independently a C₁ to C₄₀, (alternately C₂ to C₃₀, alternately C₃ to C₂₀) linear, branched or cyclic alkyl group, preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl).

In any embodiment of Formula (I) or (AI), R¹ is methyl, and R² is phenyl, methyl phenyl, n-butyl phenyl, n-octadecyl-phenyl, or an isomer thereof, preferably R² is meta or para substituted phenyl, such as meta- or para-substituted alkyl substituted phenyl, and R³ is linear or branched alkyl.

In any embodiment of Formula (I) or (AI), R¹ is methyl, and R² is branched alkyl, and R³ is linear or branched alkyl.

In a preferred embodiment, R¹ is methyl, R² is substituted phenyl, R³ is C₁₀ to C₃₀ linear or branched alkyl.

In some embodiments, R² is not meta substituted phenyl. In some embodiments, R² is not ortho substituted phenyl.

In at least one embodiment, R¹ is methyl, R² is C₁ to C₃₅ alkyl substituted phenyl (preferably ortho- or meta-substituted), R³ is C₈ to C₃₀ branched alkyl.

In at least one embodiment, R¹ is C₁ to C₁₀ alkyl, R² is C₁ to C₃₅ alkyl substituted phenyl (preferably para substituted phenyl), R³ is C₈ to C₃₀ linear or branched alkyl.

In at least one embodiment, R¹ is methyl; R² is C₁ to C₃₅ alkyl substituted phenyl, such as methylphenyl, ethylphenyl, n-propylphenyl, n-butylphenyl, n-pentylphenyl, n-hexylphenyl, n-heptylphenyl, n-octylphenyl, n-nonylphenyl, n-decylphenyl, n-undecyl,phenyln-dodecylphenyl, n-tridecylphenyl, n-butadecylphenyl, n-pentadecylphenyl, n-hexadecylphenyl, n-heptadecylphenyl, n-octadecylphenyl, n-nonadecylphenyl, and n-icosylphenyl, n-henicosylphenyl, n-docosylphenyl, n-tricosylphenyl, n-tetracosylphenyl, n-pentacosylphenyl, n-hexacosylphenyl, n-heptacosylphenyl, n-octacosylphenyl, n-nonacosylphenyl, n-triacontylphenyl; and R³ is C₈ to C₃₀ linear or branched alkyl, such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, n-tricontyl, i-propyl, alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, and alkyl-icosyl (such as 2-alkyl-pentyl, 2-alkyl-hexyl, 2-alkyl-heptyl, 2-alkyl-octyl, 2-alkyl-nonyl, 2-alkyl-decyl, 2-alkyl-undecyl, 2-alkyl-dodecyl, 2-alkyl-tridecyl, 2-alkyl-butadecyl, 2-alkyl-pentadecyl, 2-alkyl-hexadecyl, 2-alkyl-heptadecyl, 2-alkyl-octadecyl, 2-alkyl-nonadecyl, 2-alkyl-icosyl or a multi-alkyl analogs, i.e., dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl, etc.), or an isomer thereof where each alkyl group is independently a C₁ to C₄₀, (alternately C₂ to C₃₀, alternately C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl).

In some embodiments, R² is C₁ to C₃₅ alkyl substituted phenyl, such as methylphenyl, ethylphenyl, n-propylphenyl, n-butylphenyl, n-pentylphenyl, n-hexylphenyl, n-heptylphenyl, n-octylphenyl, n-nonylphenyl, n-decylphenyl, n-undecyl,phenyl n-dodecylphenyl, n-tridecylphenyl, n-butadecylphenyl, n-pentadecylphenyl, n-hexadecylphenyl, n-heptadecylphenyl, n-octadecylphenyl, n-nonadecylphenyl, and n-icosylphenyl, n-henicosylphenyl, n-docosylphenyl, n-tricosylphenyl, n-tetracosylphenyl, n-pentacosylphenyl, n-hexacosylphenyl, n-heptacosylphenyl, n-octacosylphenyl, n-nonacosylphenyl, n-triacontylphenyl; and R³ is C₈ to C₃₀ linear or branched alkyl, such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, n-tricontyl, i-propyl, alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, and alkyl-icosyl (such as 2-alkyl-pentyl, 2-alkyl-hexyl, 2-alkyl-heptyl, 2-alkyl-octyl, 2-alkyl-nonyl, 2-alkyl-decyl, 2-alkyl-undecyl, 2-alkyl-dodecyl, 2-alkyl-tridecyl, 2-alkyl-butadecyl, 2-alkyl-pentadecyl, 2-alkyl-hexadecyl, 2-alkyl-heptadecyl, 2-alkyl-octadecyl, 2-alkyl-nonadecyl, 2-alkyl-icosyl or a multi-alkyl analog, i.e., dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl, etc.), or an isomer thereof where each alkyl group is independently a C₁ to C₄₀, (alternately C₂ to C₃₀, alternately C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl).

In at least one embodiment of Formula (I), R¹ is methyl, R² is substituted phenyl, R³ is C₈ to C₃₀ linear or branched alkyl, and R⁴, R⁵, R⁶, and R⁷ are perfluoronaphthyl.

In at least one embodiment of Formula (AI), R¹ is methyl, R² is substituted phenyl, R³ is C₈ to C₃₀ linear or branched alkyl, E is nitrogen, and each Q is perfluoronaphthyl.

In a preferred embodiment, R¹ is methyl; R² is C₁ to C₃₅ alkyl substituted phenyl, such as methylphenyl, ethylphenyl, n-propylphenyl, n-butylphenyl, n-pentylphenyl, n-hexylphenyl, n-heptylphenyl, n-octylphenyl, n-nonylphenyl, n-decylphenyl, n-undecyl,phenyln-dodecylphenyl, n-tridecylphenyl, n-butadecylphenyl, n-pentadecylphenyl, n-hexadecylphenyl, n-heptadecylphenyl, n-octadecylphenyl, n-nonadecylphenyl, and n-icosylphenyl, n-henicosylphenyl, n-docosylphenyl, n-tricosylphenyl, n-tetracosylphenyl, n-pentacosylphenyl, n-hexacosylphenyl, n-heptacosylphenyl, n-octacosylphenyl, n-nonacosylphenyl, n-triacontylphenyl; R³ is a linear or branched alkyl (such as C₁₀ to C₃₀ branched alkyl) or alternately is methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, n-tricontyl, i-propyl, alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, and alkyl-icosyl (such as 2-alkyl-pentyl, 2-alkyl-hexyl, 2-alkyl-heptyl, 2-alkyl-octyl, 2-alkyl-nonyl, 2-alkyl-decyl, 2-alkyl-undecyl, 2-alkyl-dodecyl, 2-alkyl-tridecyl, 2-alkyl-butadecyl, 2-alkyl-pentadecyl, 2-alkyl-hexadecyl, 2-alkyl-heptadecyl, 2-alkyl-octadecyl, 2-alkyl-nonadecyl, and 2-alkyl-icosyl or a multi-alkyl analog, i.e., dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, trialkyl-icosyl, etc.), or an isomer thereof where each alkyl group is independently a C₁ to C₄₀, (alternately C₂ to C₃₀, alternately C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl); and each Q is or each of R⁴, R⁵, R⁶, R⁷ are perfluoronaphthyl.

In at least one embodiment herein the branched alkyl can be isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoicosyl, isohenicosyl, isodocosyl, isotricosyl, isotetracosyl, isopentacosyl, isohexacosyl, isoheptacosyl, isooctacosyl, isononacosyl, or isotricontyl.

In at least one embodiment, R¹ is o-MePh, R² and R³ are iso-octadecyl.

In at least one embodiment, R¹, R² and R³ together comprise 20 or more carbon atoms, such as 21 or more carbon atoms, such as 22 or more carbon atoms, such as 25 or more carbon atoms, such as 30 or more carbon atoms, such as 35 or more carbon atoms, such as 37 or more carbon atoms, such as 40 or more carbon atoms, such as 45 or more carbon atoms.

### Activators—The Anion

The anion component of the activators described herein includes those represented by the formula [M^{k+}Qₙ] where k is 1, 2, or 3; n is 1, 2, 3, 4, 5, or 6 (preferably 1, 2, 3, or 4); M is an element selected from Group 13 of the Periodic Table of the Elements, preferably boron or aluminum, and Q is independently a hydrogen, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group, optionally having 1 to 20 carbon atoms, more preferably each Q is a fluorinated aryl group, and most preferably each Q is a perfluorinated aryl group. Preferably at least one Q is not substituted phenyl, such as perfluorophenyl, preferably all Q are not substituted phenyl, such as perfluorophenyl.

Alternately, in any embodiment described herein, at least one Q is not substituted phenyl, alternately all Q are not substituted phenyl. Alternately, at least one Q is not fluoro-substituted phenyl, alternately all Q are not fluoro-substituted phenyl. Alternately, at least one Q is not perfluorophenyl, alternately, all Q are not perfluorophenyl.

In at least one embodiment of Formula (AI), when R¹ is methyl, R² is Cis and R³ is C₁₈, then each Q is not perfluorophenyl.

In at least one embodiment, for the borate moiety ([BR⁴R⁵R⁶R⁷]⁻) of the activator represented by Formula (I), each of R⁴, R⁵, R⁶, and R⁷ is independently aryl (such as naphthyl), where at least one of R⁴, R⁵, R⁶, and R⁷ is substituted with from one to seven fluorine atoms. In at least one embodiment, each of R⁴, R⁵, R⁶, and R⁷ is naphthyl, where at least one of R⁴, R⁵, R⁶, and R⁷ is substituted with from one to seven fluorine atoms.

In at least one embodiment, each of R⁴, R⁵, R⁶, and R⁷ is independently naphthyl comprising one fluorine atom, two fluorine atoms, three fluorine atoms, four fluorine atoms, five fluorine atoms, six fluorine atoms, or seven fluorine atoms.

In at least one embodiment of Formula (I), when R¹ is methyl, R² is C₁₈ and R³ is C₁₈, then each of R⁴, R⁵, R⁶, and R⁷ is not perfluorophenyl.

In at least one embodiment, R⁴ is independently naphthyl comprising one fluorine atom, two fluorine atoms, three fluorine atoms, four fluorine atoms, five fluorine atoms, six fluorine atoms, or seven fluorine atoms, and each of R⁵, R⁶, and R⁷ is independently phenyl comprising one fluorine atom, two fluorine atoms, three fluorine atoms, four fluorine atoms, or five fluorine atoms or naphthyl comprising one fluorine atom, two fluorine atoms, three fluorine atoms, four fluorine atoms, five fluorine atoms, six fluorine atoms, or seven fluorine atoms.

In any embodiment of Formula (I) or (AI), each of R⁴, R⁵, R⁶, and R⁷ is independently naphthyl, where at least one of R⁴, R⁵, R⁶, and R⁷ is naphthyl substituted with one, two, three, four, five, six or seven fluorine atoms.

In any embodiment of Formula (I) or (AI), each of R⁴, R⁵, R⁶, and R⁷ is independently phenyl, where at least one of R⁴, R⁵, R⁶, and R⁷ is phenyl substituted with one, two, three, four, or five fluorine atoms.

Alternately, in at least one embodiment of Formula (I) or (AI), preferably at least one R⁴, R⁵, R⁶, and R⁷ is not substituted phenyl, preferably all of R⁴, R⁵, R⁶, and R⁷ are not substituted phenyl. In a preferred embodiment, R¹ is not methyl, R² is not Cis and R³ is not C₁₈.

In any embodiment of Formula (I) or (AI), preferably all Q or all of R⁴, R⁵, R⁶, and R⁷ are not perfluoroaryl, such as perfluorophenyl.

In any embodiment of Formula (I) or (AI), all of R⁴, R⁵, R⁶, and R⁷ are naphthyl, where at least one, two, three, or four of R⁴, R⁵, R⁶, and R⁷ is/are substituted with one, two, three, four, five, six or seven fluorine atoms.

In at least one embodiment, preferably each of R⁴, R⁵, R⁶, and R⁷ is independently a naphthyl comprising one fluorine atom, two fluorine atoms, three fluorine atoms, four fluorine atoms, five fluorine atoms, six fluorine atoms, or seven fluorine atoms, preferably seven fluorine atoms.

In at least one embodiment, R⁴ is independently naphthyl comprising one fluorine atom, two fluorine atoms, three fluorine atoms, four fluorine atoms, five fluorine atoms, six fluorine atoms, or seven fluorine atoms.

In at least one embodiment, each of R⁴, R⁵, R⁶, and R⁷ is independently each a fluorinated hydrocarbyl group having 1 to 30 carbon atoms, more preferably each of R⁴, R⁵, R⁶, and R⁷ is independently a fluorinated aryl (such as phenyl, biphenyl, [(C₆H₃(C₆H₅)₂)₄B], or naphthyl) group, and most preferably each of R⁴, R⁵, R⁶, and R⁷ is independently is a perflourinated aryl (such as bi-phenyl, [(C₆H₃(C₆H₅)₂)₄B], or naphthyl) group, preferably at least one R⁴, R⁵, R⁶, and R⁷ is not perfluorophenyl.

In at least one embodiment, the borate activator comprises tetrakis(heptafluoronaphth-2-yl)borate.

Preferred anions for use in the non-coordinating anion activators described herein include those represented by Formula 7 below:

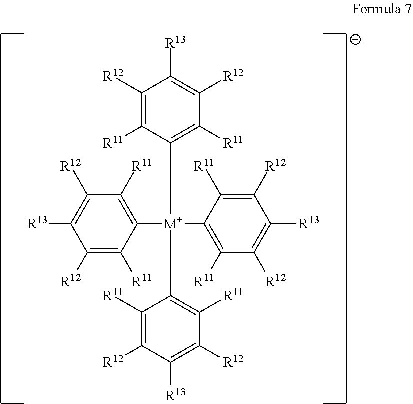

where:

M* is a group 13 atom, preferably B or Al, preferably B;

each R¹¹ is, independently, a halide, preferably a fluoride;

each R¹² is, independently, a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹² is a fluoride or a perfluorinated phenyl group;

each R¹³ is a halide, a C₆ to C₂₀ substituted aromatic hydrocarbyl group or a siloxy group of the formula —O—Si—Rₐ, where R^{a} is a C₁ to C₂ hydrocarbyl or hydrocarbylsilyl group, preferably R¹³ is a fluoride or a C₆ perfluorinated aromatic hydrocarbyl group;

where an R¹² and R¹³ can form one or more saturated or unsaturated, substituted or unsubstituted rings, preferably an R¹² and R¹³ form a perfluorinated phenyl ring. Preferably the anion has a molecular weight of greater than 700 g/mol, and, preferably, at least three of the substituents on the M* atom each have a molecular volume of greater than 180 cubic A.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in Girolami, G. S. (1994) “A Simple “Back of the Envelope” Method for Estimating the Densities and Molecular Volumes of Liquids and Solids,” Journal of Chemical Education, v. 71(11), pp. 962-964. Molecular volume (MV), in units of cubic Å, is calculated using the formula: MV=8.3V_{S}, where V_{S} is the scaled volume. V_{S} is the sum of the relative volumes of the constituent atoms, and is calculated from the molecular formula of the substituent using Table 1 below of relative volumes. For fused rings, the V_{S} is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

TABLE 1

| | Relative |
|---|---|
| Element | Volume |
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary anions useful herein and their respective scaled volumes and molecular volumes are shown in Table 2 below. The dashed bonds indicate bonding to boron.

TABLE 2

| | | Molecular | | MV | Calculated |
|---|---|---|---|---|---|
| | | Formula of | | Per | Total |
| | | Each | | subst. | MV |
| Ion | Structure of Boron Substituents | Substituent | Vₛ | (Å³) | (Å³) |
| tetrakis(perfluorophenyl)borate | 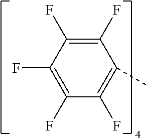 | C₆F₅ | 22 | 183 | 732 |
| tris(perfluorophenyl)- (perfluoronaphthyl)borate | 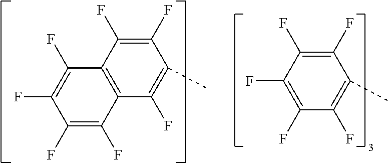 | C₆F₅ C₁₀F₇ | 22 34 | 183 261 | 810 |
| (perfluorophenyl)tris- (perfluoronaphthyl)borate | 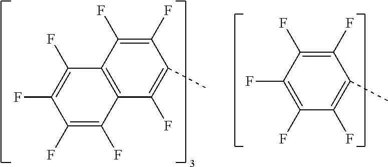 | C₆F₅ C₁₀F₇ | 22 34 | 183 261 | 966 |
| tetrakis(perfluoronaphthyl)borate | 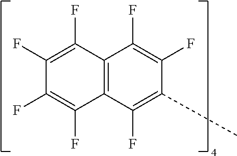 | C₁₀F₇ | 34 | 261 | 1044 |
| tetrakis(perfluoronaphthyl)borate | 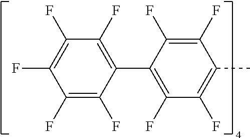 | C₁₂F₉ | 42 | 349 | 1396 |
| [(C₆F₃(C₆F₅)₂)₄B] | 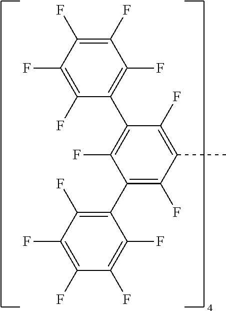 | C₁₈F₁₃ | 62 | 515 | 2060 |

The activators may be added to a polymerization in the form of an ion pair using, for example, [DEBAH]+ [NCA]− in which the 4-butyl-N,N-bis(isotridecyl)benzenaminium-(“DEBAH)”) cation reacts with a basic leaving group on the transition metal complex to form a transition metal complex cation and [NCA]−. Alternatively, the transition metal complex may be reacted with a neutral NCA precursor, such as B(C₁₀F₇)₃, which abstracts an anionic group from the complex to form an activated species.

In at least one embodiment, the activators obtained in their salt form used for a borate activator compound are: Lithium tetrakis(heptafluoronaphthalen-2-yl)borate etherate (Li-BF28), N,N-Dimethylanilinium tetrakis(heptafluoronaphthalen-2-yl)borate (DMAH-BF28), Sodium tetrakis(heptafluoronaphthalen-2-yl)borate (Na-BF28) and N,N-dimethylaniliniumtetrakis(heptafluoronaphthalen-2-yl)borate(DMAH-BF28).

In at least one embodiment of the activator represented by Formula (AI), when Q is a fluorophenyl group, then R² is not a C₁-C₄₀ linear alkyl group, preferably R² is not an optionally substituted C₁-C₄₀ linear alkyl group (alternately when Q is a substituted phenyl group, then R² is not a C₁-C₄₀ linear alkyl group, preferably R² is not an optionally substituted C₁-C₄₀ linear alkyl group). Optionally, when Q is a fluorophenyl group (alternately when Q is a substituted phenyl group), then R² is a meta- and/or para-substituted phenyl group, where the meta and para substituents are, independently, an optionally substituted C₁ to C₄₀ hydrocarbyl group (such as a C₆ to C₄₀ aryl group or linear alkyl group, a C₁₂ to C₃₀ aryl group or linear alkyl group, or a C₁₀ to C₂₀ aryl group or linear alkyl group), an optionally substituted alkoxy group, or an optionally substituted silyl group. Optionally, each Q is a fluorinated hydrocarbyl group having 1 to 30 carbon atoms, more preferably each Q is a fluorinated aryl (such as phenyl or naphthyl) group, and most preferably each Q is a perflourinated aryl (such as phenyl or naphthyl) group. Optionally, at least one Q is not substituted phenyl. Optionally all Q are not substituted phenyl. Optionally at least one Qis not perfluorophenyl. Optionally all Q are not perfluorophenyl.

In some embodiments, R¹ is not methyl, R² is not C₁₈ alkyl and R³ is not C₁₈ alkyl, alternately R¹ is not methyl, R² is not C₁₈ alkyl and R³ is not C₁₈ alkyl and at least one Qis not substituted phenyl, optionally all Q are not substituted phenyl.

Useful cation components in Formulas (AI) or (I) include those represented by the formula:

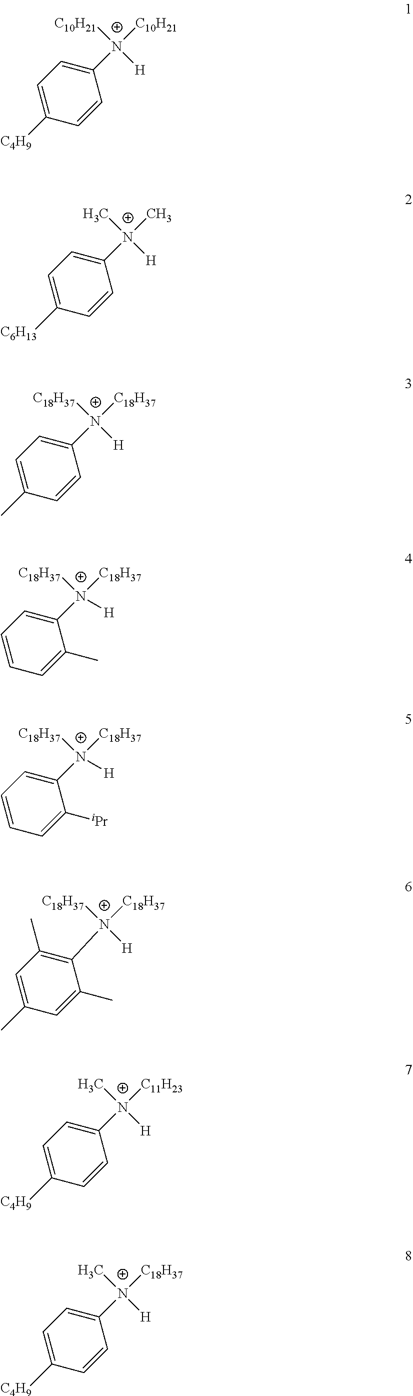

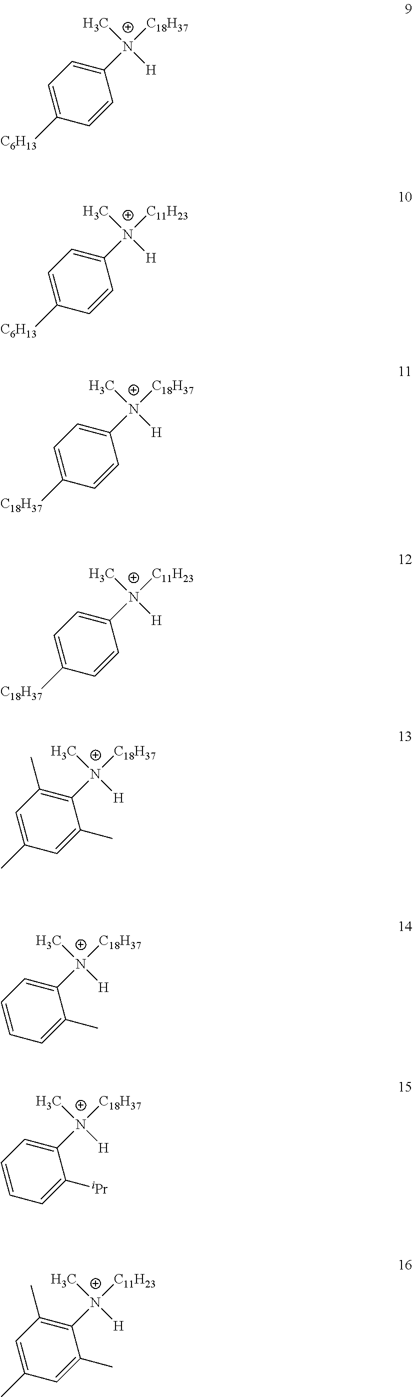

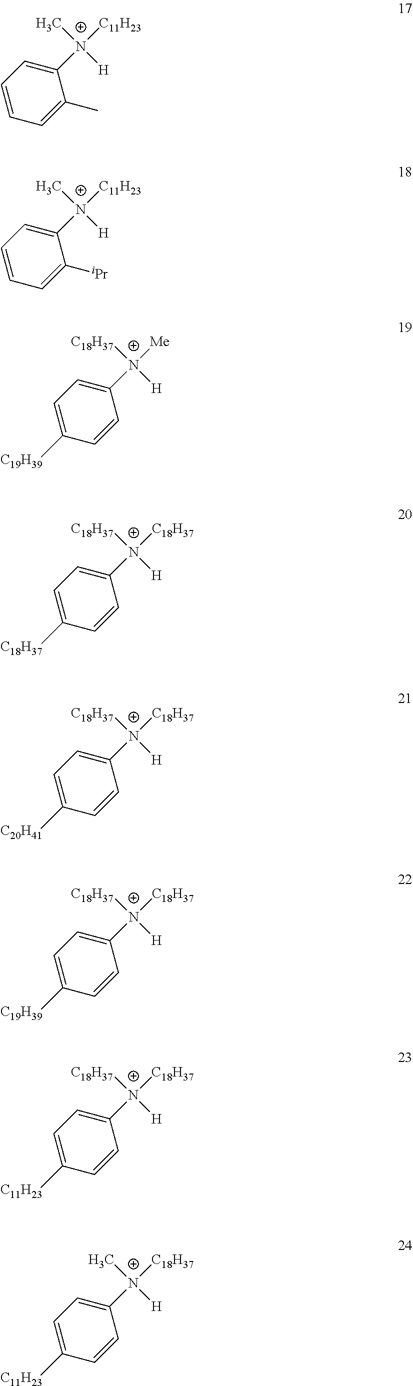

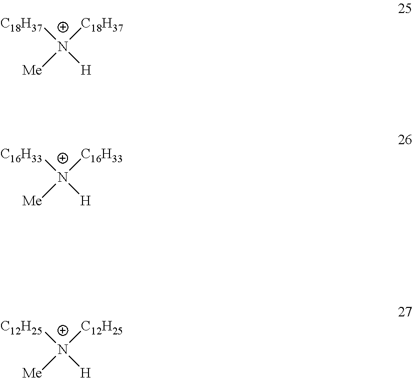

Useful cation components in Formulas (AI) or (I) include those represented by the formula:

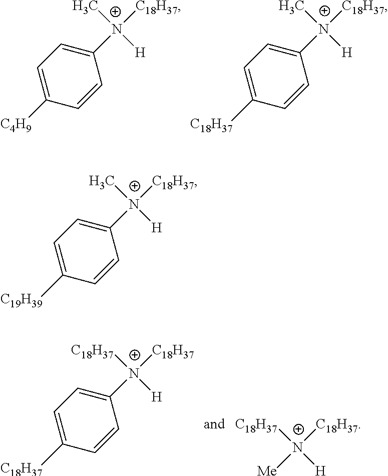

The activators may be added to a polymerization in the form of an ion pair using, for example, [M2HTH]+ [NCA]− in which the di(hydrogenated tallow)methylamine (“M2HTH”) cation reacts with a basic leaving group on the transition metal complex to form a transition metal complex cation and [NCA]−. Alternatively, the transition metal complex may be reacted with a neutral NCA precursor, such as B(C₆F5)₃, which abstracts an anionic group from the complex to form an activated species. Useful activators include di(hydrogenated tallow)methylammonium[tetrakis(pentafluorophenyl)borate] (i.e., [M2HTH]B(C₆F₅)₄) and di(octadecyl)tolylammonium [tetrakis(pentafluorophenyl)borate] (i.e., [DOdTH]B(C₆F₅)₄).

Activator compounds can include one or more of: N,N-di(hydrogenated tallow)methylammonium [tetrakis(perfluorophenyl)borate], N-methyl-4-nonadecyl-N-octadecylanilinium [tetrakis(perfluorophenyl)borate], N-methyl-4-hexadecyl-N-octadecylanilinium [tetrakis(perfluorophenyl)borate], N-methyl-4-tetradecyl-N-octadecylanilinium [tetrakis(perfluorophenyl)borate], N-methyl-4-dodecyl-N-octadecylanilinium [tetrakis(perfluorophenyl)borate], N-methyl-4-decyl-N-octadecylanilinium [tetrakis(perfluorophenyl)borate], N-methyl-4-octyl-N-octadecylanilinium [tetrakis(perfluorophenyl)borate], N-methyl-4-hexyl-N-octadecylanilinium [tetrakis(perfluorophenyl)borate], N-methyl-4-butyl-N-octadecylanilinium [tetrakis(perfluorophenyl)borate], N-methyl-4-octadecyl-N-decylanilinium [tetrakis(perfluorophenyl)borate], N-methyl-4-nonadecyl-N-dodecylanilinium [tetrakis(perfluorophenyl)borate], N-methyl-4-nonadecyl-N-tetradecylanilinium [tetrakis(perfluorophenyl)borate], N-methyl-4-nonadecyl-N-hexadecylanilinium [tetrakis(perfluorophenyl)borate], N-ethyl-4-nonadecyl-N-octadecylanilinium [tetrakis(perfluorophenyl)borate], N-methyl-N,N-dioctadecylammonium [tetrakis(perfluorophenyl)borate], N-methyl-N,N-dihexadecylammonium [tetrakis(perfluorophenyl)borate], N-methyl-N,N-ditetradecylammonium [tetrakis(perfluorophenyl)borate], N-methyl-N,N-didodecylammonium [tetrakis(perfluorophenyl)borate], N-methyl-N,N-didecylammonium [tetrakis(perfluorophenyl)borate], N-methyl-N,N-dioctylammonium [tetrakis(perfluorophenyl)borate], N-ethyl-N,N-dioctadecylammonium [tetrakis(perfluorophenyl)borate], N,N-di(octadecyl)tolylammonium [tetrakis(perfluorophenyl)borate], N,N-di(hexadecyl)tolylammonium [tetrakis(perfluorophenyl)borate], N,N-di(tetradecyl)tolylammonium [tetrakis(perfluorophenyl)borate], N,N-di(dodecyl)tolylammonium [tetrakis(perfluorophenyl)borate], N-octadecyl-N-hexadecyl-tolylammonium [tetrakis(perfluorophenyl)borate], N-octadecyl-N-hexadecyl-tolylammonium [tetrakis(perfluorophenyl)borate], N-octadecyl-N-tetradecyl-tolylammonium [tetrakis(perfluorophenyl)borate], N-octadecyl-N-dodecyl-tolylammonium [tetrakis(perfluorophenyl)borate], N-octadecyl-N-decyl-tolylammonium [tetrakis(perfluorophenyl)borate], N-hexadecyl-N-tetradecyl-tolylammonium [tetrakis(perfluorophenyl)borate], N-hexadecyl-N-dodecyl-tolylammonium [tetrakis(perfluorophenyl)borate], N-hexadecyl-N-decyl-tolylammonium [tetrakis(perfluorophenyl)borate], N-tetradecyl-N-dodecyl-tolylammonium [tetrakis(perfluorophenyl)borate], N-tetradecyl-N-decyl-tolylammonium [tetrakis(perfluorophenyl)borate], N-dodecyl-N-decyl-tolylammonium [tetrakis(perfluorophenyl)borate], N-methyl-N-octadecylanilinium [tetrakis(perfluorophenyl)borate], N-methyl-N-hexadecylanilinium [tetrakis(perfluorophenyl)borate], N-methyl-N-tetradecylanilinium [tetrakis(perfluorophenyl)borate], N-methyl-N-dodecylanilinium [tetrakis(perfluorophenyl)borate], N-methyl-N-decylanilinium [tetrakis(perfluorophenyl)borate], and N-methyl-N-octylanilinium [tetrakis(perfluorophenyl)borate].

Additional useful activators and the synthesis thereof, are described in U.S. Ser. No. 16/394,166 filed Apr. 25, 2019, U.S. Ser. No. 16/394,186, filed Apr. 25, 2019, and U.S. Ser. No. 16/394,197, filed Apr. 25, 2019, which are incorporated by reference herein.

In at least one embodiment, the activator is not:

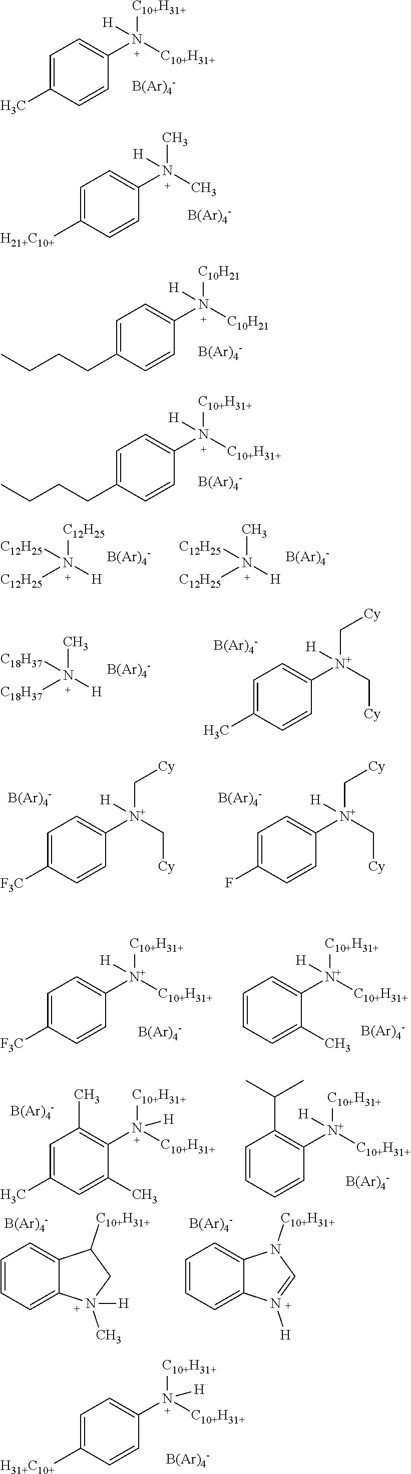

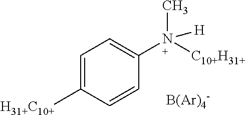

In at least one embodiment, an activator of the present disclosure, when combined with a catalyst compound to form an active olefin polymerization catalyst, produces a higher molecular weight polymer (e.g., Mw) than comparative activators that use other borate anions.

In at least one embodiment, an activator of the present disclosure where R¹ is methyl, when combined with a catalyst compound to form an active olefin polymerization catalyst, produces a higher molecular weight polymer (e.g., Mw) than comparative activators that use other borate anions.

The typical activator-to-catalyst ratio, e.g., all NCA activators-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

It is also within the scope of the present disclosure that the catalyst compounds can be combined with combinations of alumoxanes and the activators described herein.

### Synthesis of Activators

In at least one embodiment, the general synthesis of the activators can be performed using a two-step process. In the first step, an amine or phosphine is dissolved in a solvent (e.g. hexane, cyclohexane, methylcyclohexane, ether, dichloromethane, toluene) and an excess (e.g., 1.2 molar equivalents) of hydrogen chloride is added to form a chloride salt. This salt is typically isolated by filtration from the reaction medium and dried under reduced pressure. The isolated chloride is then heated to reflux with about one molar equivalent of an alkali metal metallate or metalloid (such as a borate or aluminate) in a solvent (e.g. cyclohexane, dichloromethane, methylcyclohexane) to form the desired borate or aluminate along with byproduct alkali metal chloride, the latter of which can typically be removed by filtration.

In at least one embodiment, the general synthesis of the ammonium borate activators can be performed using a two-step process. In the first step, an amine is dissolved in a solvent (e.g. hexane, cyclohexane, methylcyclohexane, ether, dichloromethane, toluene) and an excess (e.g., 1.2 molar equivalents) of hydrogen chloride is added to form an ammonium chloride salt. This salt is typically isolated by filtration from the reaction medium and dried under reduced pressure. The isolated ammonium chloride is then heated to reflux with about one molar equivalent of an alkali metal borate in a solvent (e.g. cyclohexane, dichloromethane, methylcyclohexane) to form the ammonium borate along with byproduct alkali metal chloride, the latter of which can typically be removed by filtration.

In at least one embodiment, an activator of the present disclosure is soluble in an aliphatic solvent at a concentration of about 10 mM or greater, such as about 20 mM or greater, such as about 30 mM or greater, such as about 50 mM or greater, such as about 75 mM or greater, such as about 100 mM or greater, such as about 200 mM or greater, such as about 300 mM or greater. In at least one embodiment, an activator of the present disclosure dissolves in isohexane or methylcyclohexane at 25° C. to form a homogeneous solution of at least 10 mM concentration.

In at least one embodiment, the solubility of the borate or aluminate activators of the present disclosure in aliphatic hydrocarbon solvents increases with the number of aliphatic carbons in the cation group (i.e., the ammonium or the phosphonium). In at least one embodiment, a solubility of at least 10 mM is achieved with an activator having an ammonium or phosphonium group of about 21 aliphatic carbon atoms or more, such as about 25 aliphatic carbons atoms or more, such as about 35 carbon atoms or more.

In at least one embodiment, the solubility of the ammonium borate activators of the present disclosure in aliphatic hydrocarbon solvents increases with the number of aliphatic carbons in the ammonium group. In at least one embodiment, a solubility of at least 10 mM is achieved with an activator having an ammonium group of about 21 aliphatic carbon atoms or more, such as about 25 aliphatic carbons atoms or more, such as about 35 carbon atoms or more.

Useful aliphatic hydrocarbon solvent can be isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In at least one embodiment, aromatics are present in the solvent at less than 1 wt %, such as less than 0.5 wt %, such as at 0 wt % based upon the weight of the solvents. The activators of the present disclosure can be dissolved in one or more additional solvents. Additional solvent includes ethereal, halogenated and N,N-dimethylformamide solvents.

In at least one embodiment, the aliphatic solvent is isohexane and/or methylcyclohexane.

### Optional Scavengers or Co-Activators

In addition to these activator compounds, scavengers or co-activators may be used. Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and diethyl zinc.

In at least one embodiment, little or no scavenger is used in the process to produce the ethylene polymer. Scavenger (such as trialkyl aluminum) can be present at zero mol %, alternately the scavenger is present at a molar ratio of scavenger metal to transition metal of less than 100:1, such as less than 50:1, such as less than 15:1, such as less than 10:1.

### Transition Metal Catalyst Compounds

Transition metal compounds capable of catalyzing a reaction, such as a polymerization reaction, upon activation with an activator as described above are suitable for use in polymerization processes of the present disclosure.

### Catalyst Compounds

Catalyst compounds for producing polyolefins include various catalyst compounds having an oxadiazole group. Catalyst compounds having an oxadiazole group can provide polyolefins having high comonomer content, low molecular weight, and or a melt temperature of about 120° C. or greater. Furthermore, catalyst compounds having an oxadiazole group may have little to no hydrogen response during a polymerization, which makes the catalyst compounds good catalysts for dual catalyst systems having two or more catalysts. In such dual catalyst systems, the catalyst that is not the catalyst having an oxadiazole group can respond to hydrogen content in a polymerization reactor. For example, in a conventional dual catalyst system, an increase in hydrogen content may increase the activity of a first catalyst while decreasing the activity of a second catalyst. Thus, processes which utilize hydrogen typically require rigorous characterization of the system to determine the proper amount of hydrogen required for a particular dual catalyst system used. In contrast, oxadiazole-containing catalyst compounds disclosed herein can have essentially no hydrogen response, and the molecular weight of the resulting polymer produced is not influenced significantly by the hydrogen concentration in the reactor. Therefore, the relative proportions of the various components produced by a dual catalyst system may be controlled in a predictable way and thus the physical properties of the resultant polymers may be manipulated in a predictable way by simply controlling the hydrogen concentration during polymerization.

A catalyst compound comprising an oxadiazole group may be represented by Formula (CI):

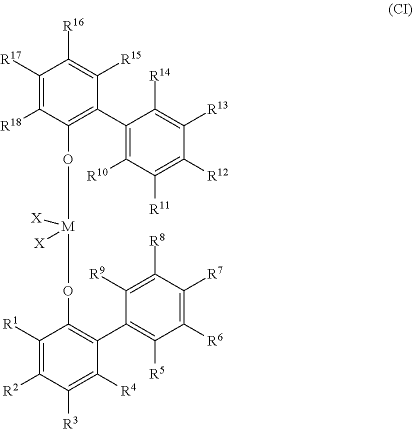

where:

M is selected from the group consisting of Ti, Zr, and Hf;

where each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is independently selected from the group consisting of hydrogen, hydrocarbyl, substituted hydrocarbyl, heterohydrocarbyl, substituted heterohydrocarbyl, alkoxy, substituted alkoxy, aryloxy, substituted aryloxy, hydroxyl, alkylthio, substituted alkylthio, arylthio, substituted arylthio, aryl, substituted aryl, heteroaryl, substituted heteroaryl, halide, silyl, boryl, phosphinyl, and amino; with the proviso that at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is an oxadiazole group having the following structure:

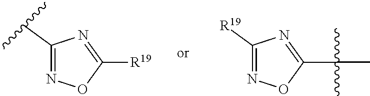

where R¹⁹ is independently selected from the group consisting of hydrogen, hydrocarbyl, substituted hydrocarbyl, heterohydrocarbyl, substituted heterohydrocarbyl, alkoxy, substituted alkoxy, aryloxy, substituted aryloxy, hydroxyl, alkylthio, substituted alkylthio, arylthio, substituted arylthio, aryl, substituted aryl, heteroaryl, substituted heteroaryl, halide, silyl, boryl, phosphinyl, and amino; and

each X is independently a leaving group.

In at least one embodiment, for the catalyst compound of Formula (CI), each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ is independently selected from the group consisting of hydrogen, alkyl, substituted alkyl, heteroalkyl, substituted heteroalkyl, alkoxy, substituted alkoxy, aryloxy, aryl, substituted aryl, heteroaryl, substituted heteroaryl, aralkyl, substituted aralkyl, alkaryl, substituted alkaryl, and halide, where at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is the oxadiazole group.

In at least one embodiment, for the catalyst compound of Formula (CI), each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ is independently selected from the group consisting of hydrogen, hydrocarbyl, substituted hydrocarbyl, and halide, where at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is the oxadiazole group.

In at least one embodiment, for the catalyst compound of Formula (CI), each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ is independently selected from the group consisting of hydrogen, alkyl, haloalkyl, and halide, where at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is the oxadiazole group.

In some embodiments, one or more of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ are selected from the group consisting of:

1) optionally substituted linear alkyls (such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, or n-tricontyl);

2) optionally substituted branched alkyls (such as alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, alkyl-icosyl (including multi-alkyl analogs, i.e., dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl, etc.), and isomers thereof where each alkyl group is independently a C₁ to C₄₀, (alternately C₂ to C₃₀, alternately C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl);

3) optionally substituted arylalkyls, such as (methylphenyl, ethylphenyl, propylphenyl, butylphenyl, pentylphenyl, hexylphenyl, heptylphenyl, octylphenyl, nonylphenyl, decylphenyl, undecylphenyl, dodecylphenyl, tridecylphenyl, tetradecylphenyl, pentadecylphenyl, hexadecylphenyl, heptadecylphenyl, octadecylphenyl, nonadecylphenyl, icosylphenyl, henicosylphenyl, docosylphenyl, tricosylphenyl, tetracosylphenyl, pentacosylphenyl, hexacosylphenyl, heptacosylphenyl, octacosylphenyl, nonacosylphenyl, tricontylphenyl, 3,5,5-trimethylhexylphenyl, dioctylphenyl, 3,3,5-trimethylhexylphenyl, 2,2,3,3,4 pentamethypentylylphenyl, and the like);

4) optionally substituted silyl groups, such as a trialkylsilyl group, where each alkyl is independently an optionally substituted C₁ to C₂ alkyl (such as trimethylsilyl, triethylsilyl, tripropylsilyl, tributylsilyl, trihexylsilyl, triheptylsilyl, trioctylsilyl, trinonylsilyl, tridecylsilyl, triundecylsilyl, tridodecylsilyl, tri-tridecylsilyl, tri-tetradecylsilyl, tri-pentadecylsilyl, tri-hexadecylsilyl, tri-heptadecylsilyl, tri-octadecylsilyl, tri-nonadecylsilyl, tri-icosylsilyl);

5) optionally substituted alkoxy groups (such as —OR*, where R* is an optionally substituted C₁ to C₂₀ alkyl or aryl (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, phenyl, alkylphenyl (such as methyl phenyl, propyl phenyl, etc.), naphthyl, or anthracenyl);

6) halogens (such as Br or Cl); and

7) halogen containing groups (such as bromomethyl, bromophenyl, and the like).

In some embodiments, catalyst compounds comprising an oxadiazole compound may be represented by Formula (III):

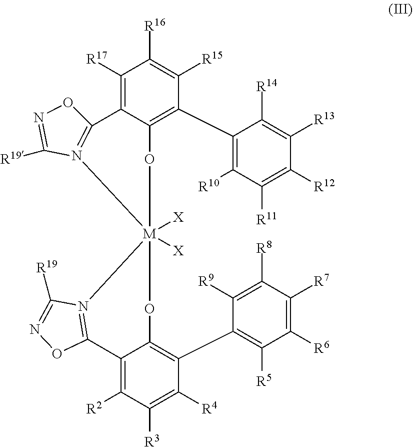

where:

M is selected from the group consisting of Ti, Zr, and Hf;

where each of R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁹, and R^{19′} is independently selected from the group consisting of hydrogen, alkyl, substituted alkyl, heteroalkyl, substituted heteroalkyl, alkoxy, substituted alkoxy, aryloxy, aryl, substituted aryl, heteroaryl, substituted heteroaryl, aralkyl, substituted aralkyl, alkaryl, substituted alkaryl, and halide;

each X is independently a leaving group.

In at least one embodiment, each of R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁹, and R^{19′} of Formula (III) is independently selected from the group consisting of hydrogen, methyl, ethyl, n-propyl, isopropyl, n-butyl, isobutyl, t-butyl, n-pentyl, isopentyl, n-hexyl, isohexyl, n-heptyl, isoheptyl, n-octyl, isooctyl, n-nonyl, isononyl, n-decyl, isodecyl, phenyl, chlorophenyl, dichlorophenyl, trichlorophenyl, tetrachlorophenyl, perchlorophenyl, fluorophenyl, difluorophenyl, trifluorophenyl, tetrafluorophenyl, perfluorophenyl, —CF₃, —C₂F₂CF₃, —C₂F₂C₂F₂CF₃, F, and Cl.

In some embodiments, one or more of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹ and R^{19′} of Formula (III) are selected from the group consisting of:

1) optionally substituted linear alkyls (such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, or n-tricontyl);

2) optionally substituted branched alkyls (such as alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, alkyl-icosyl (including multi-alkyl analogs, i.e., dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl, etc.), and isomers thereof where each alkyl group is independently a C₁ to C₄₀, (alternately C₂ to C₃₀, alternately C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl);

3) optionally substituted arylalkyls, such as (methylphenyl, ethylphenyl, propylphenyl, butylphenyl, pentylphenyl, hexylphenyl, heptylphenyl, octylphenyl, nonylphenyl, decylphenyl, undecylphenyl, dodecylphenyl, tridecylphenyl, tetradecylphenyl, pentadecylphenyl, hexadecylphenyl, heptadecylphenyl, octadecylphenyl, nonadecylphenyl, icosylphenyl, henicosylphenyl, docosylphenyl, tricosylphenyl, tetracosylphenyl, pentacosylphenyl, hexacosylphenyl, heptacosylphenyl, octacosylphenyl, nonacosylphenyl, tricontylphenyl, 3,5,5-trimethylhexylphenyl, dioctylphenyl, 3,3,5-trimethylhexylphenyl, 2,2,3,3,4 pentamethypentylylphenyl, and the like);

4) optionally substituted silyl groups, such as a trialkylsilyl group, where each alkyl is independently an optionally substituted C₁ to C₂₀ alkyl (such as trimethylsilyl, triethylsilyl, tripropylsilyl, tributylsilyl, trihexylsilyl, triheptylsilyl, trioctylsilyl, trinonylsilyl, tridecylsilyl, triundecylsilyl, tridodecylsilyl, tri-tridecylsilyl, tri-tetradecylsilyl, tri-pentadecylsilyl, tri-hexadecylsilyl, tri-heptadecylsilyl, tri-octadecylsilyl, tri-nonadecylsilyl, tri-icosylsilyl);

5) optionally substituted alkoxy groups (such as —OR*, where R* is an optionally substituted C₁ to C₂₀ alkyl or aryl (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, phenyl, alkylphenyl (such as methyl phenyl, propyl phenyl, etc.), naphthyl, or anthracenyl);

6) halogens (such as Br or Cl); and

7) halogen containing groups (such as bromomethyl, bromophenyl, and the like).

In other non-limiting embodiments, the catalyst compounds comprising an oxadiazole compound may be represented by Formula (V):

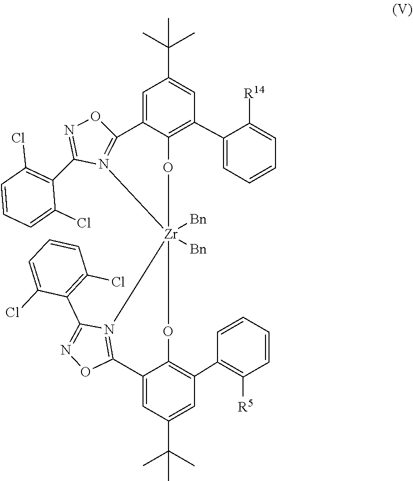

where each of R⁵ and R¹⁴ is independently selected from the group consisting of hydrogen, C₁ to C₄ alkyl, halogen, and C₁ to C₄ haloalkyl. In some embodiments, each of R⁵ and R¹⁴ is C₁ to C₄ haloalkyl. In at least one embodiment, each of R⁵ and R¹⁴ is independently selected from the group consisting of —F, —CF₃, —CF₂CF₃, and —CF₂CF₂CF₃.

Each X in the catalyst compound of Formula (CI), (III), or (V) is independently selected from the group consisting of halogen, hydrogen, C₁ to C₁₂ alkyls, C₂ to C₁₂ alkenyl, C₆ to C₁₂ aryl, C₇ to C₂₀ alkylaryl, C₁ to C₁₂ alkoxy, C₆ to C₁₂ aryloxy, C₇ to Cis alkylaryloxy, C₁ to C₁₂ fluoroalkyl, C₆ to C₁₂ fluoroaryl, and C₁ to C₁₂ heteroatom-containing hydrocarbyl, and substituted derivatives thereof. In at least one embodiment, each X is independently selected from the group consisting of hydrogen, halogen, C₁ to C₆ alkyl, C₂ to C₆ alkenyl, C₇ to Cis alkylaryl, C₁ to C₆ alkoxy, C₆ to C₁₄ aryloxy, C₇ to C₁₈ alkylaryloxy, C₁ to C₆ alkylcarboxylate, C₁ to C₆ fluorinated alkylcarboxylate, C₆ to C₁₂ arylcarboxylate, C₇ to C₁₈ alkylarylcarboxylate, C₁ to C₆ fluoroalkyl, C₂ to C₁₂ fluoroalkenyl, and C₇ to C₁₈ fluoroalkylaryl. In at least one embodiment, each X is independently selected from the group consisting of hydrogen, chloride, fluoride, methyl, phenyl, phenoxy, benzoxy, tosyl, fluoromethyl and fluorophenyl. In at least one embodiment, each X is independently selected from the group consisting of C₁ to C₁₂ alkyl, C₂ to C₁₂ alkenyl, C₆ to C₁₂ aryl, C₇ to C₂₀ alkylaryl, substituted C₁ to C₁₂ alkyl, substituted C₆ to C₁₂ aryl, substituted C₇ to C₂₀ alkylaryl, and C₁ to C₁₂ heteroatom-containing alkyl, C₁ to C₁₂ heteroatom-containing aryl and C₁ to C₁₂ heteroatom-containing alkylaryl. In at least one embodiment, each X is independently selected from the group consisting of chloride, fluoride, C₁ to C₆ alkyl, C₂ to C₆ alkenyl, C₇ to Cis alkylaryl, halogenated C₁ to C₆ alkyl, halogenated C₂ to C₆ alkenyl, and halogenated C₇ to C₁₈ alkylaryl. In at least one embodiment, each X is independently selected from the group consisting of fluoride, methyl, ethyl, propyl, phenyl, methylphenyl, dimethylphenyl, trimethylphenyl, fluoromethyl and fluorophenyl.

Other non-limiting examples of X groups include amines, phosphines, ethers, carboxylates, dienes, hydrocarbon radicals having from 1 to 20 carbon atoms, fluorinated hydrocarbyl radicals (e.g., —C₆F₅ (pentafluorophenyl)), fluorinated alkylcarboxylates (e.g., CF₃C(O)O—), hydrogens and halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, dimethylphosphide radicals and the like. In one embodiment, two or more X's form a part of a fused ring or ring system.

In some embodiments, the catalyst compound of Formula (CI) is selected from the group consisting of:

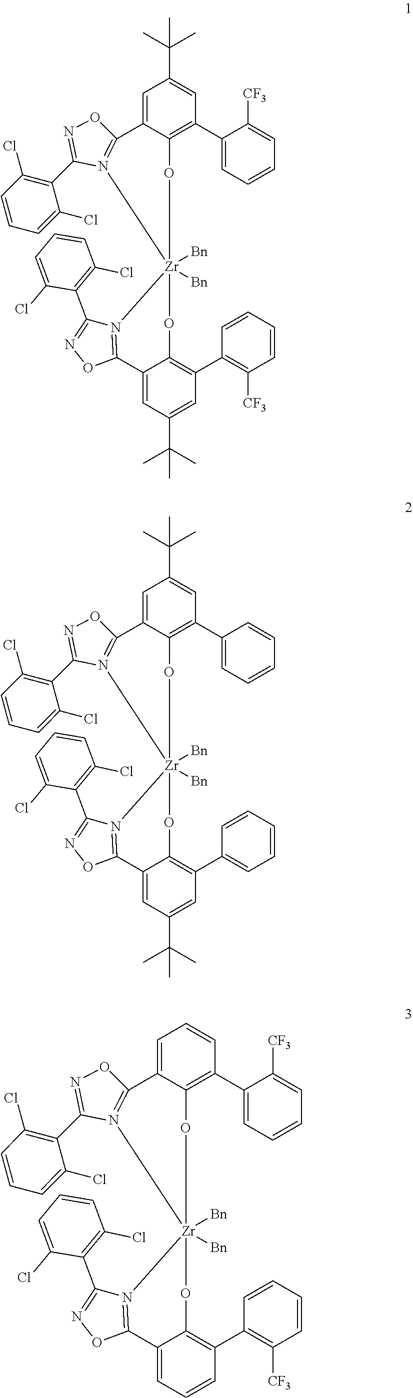

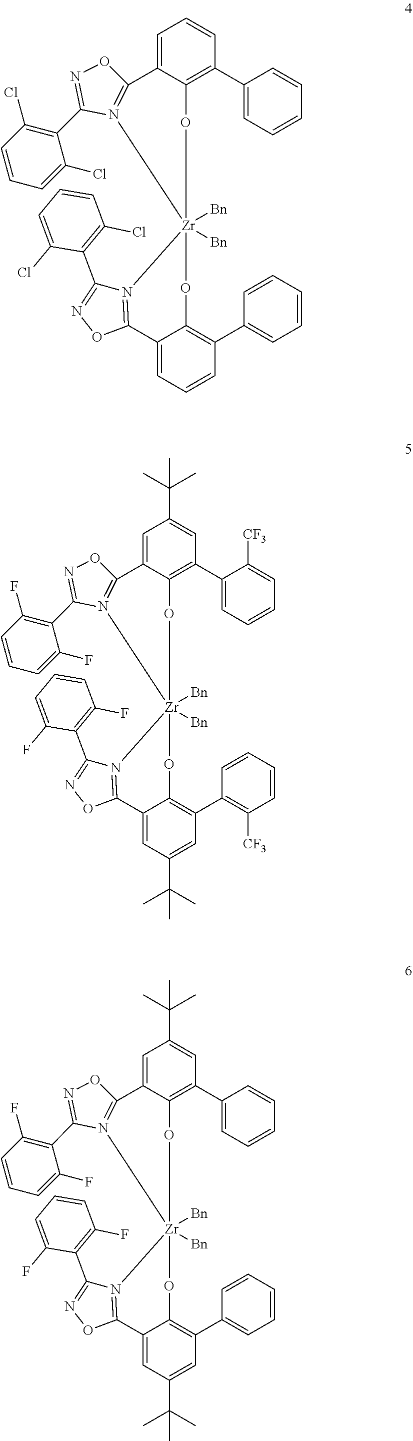

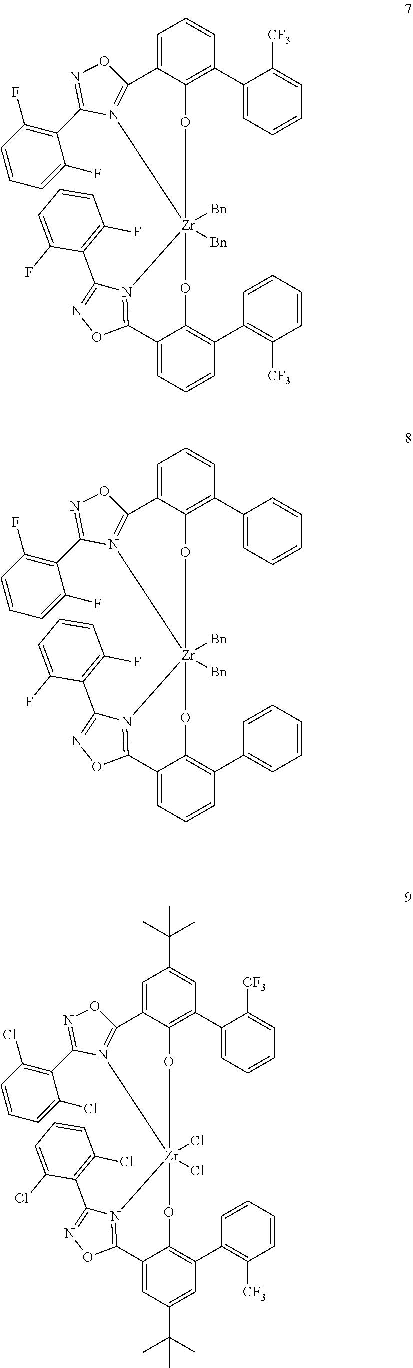

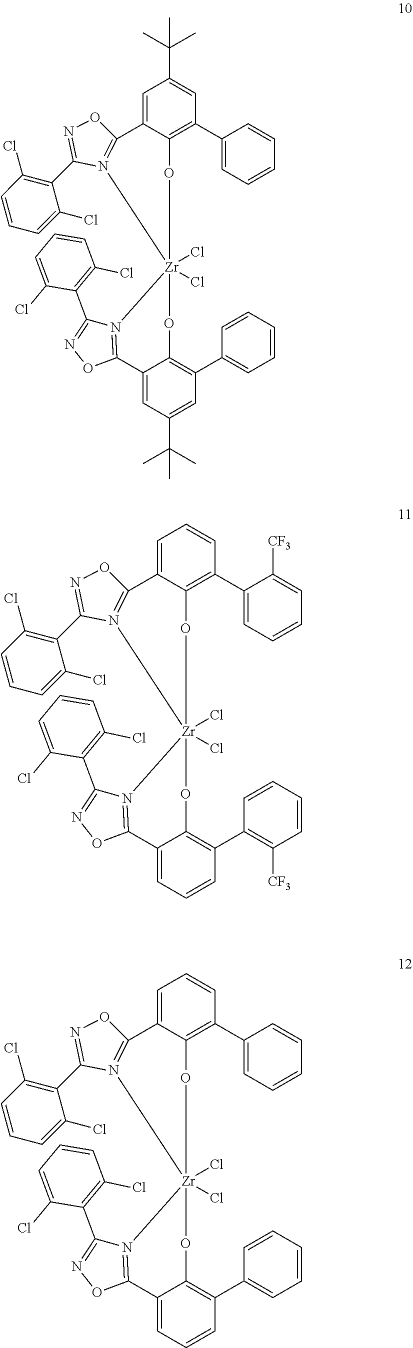

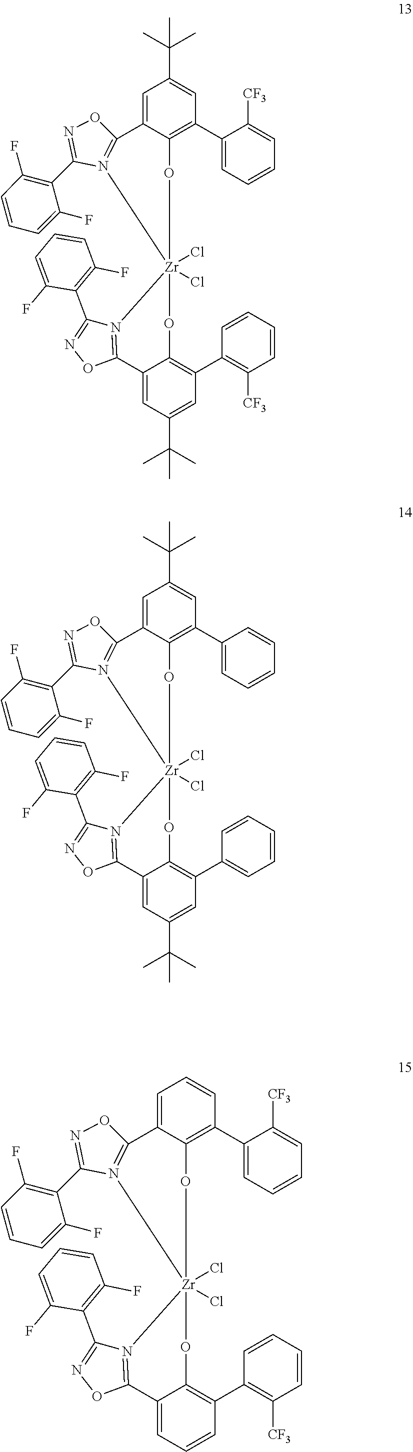

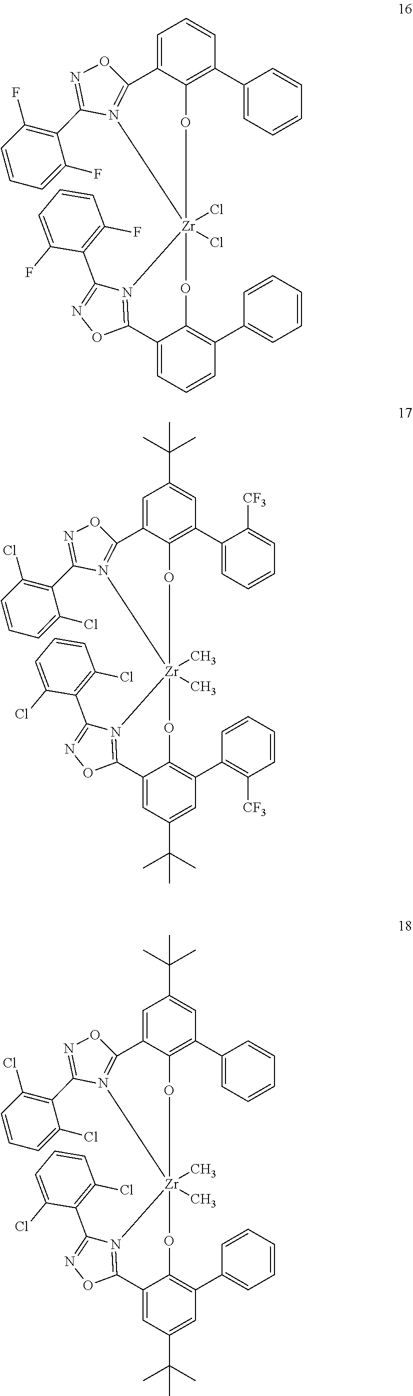

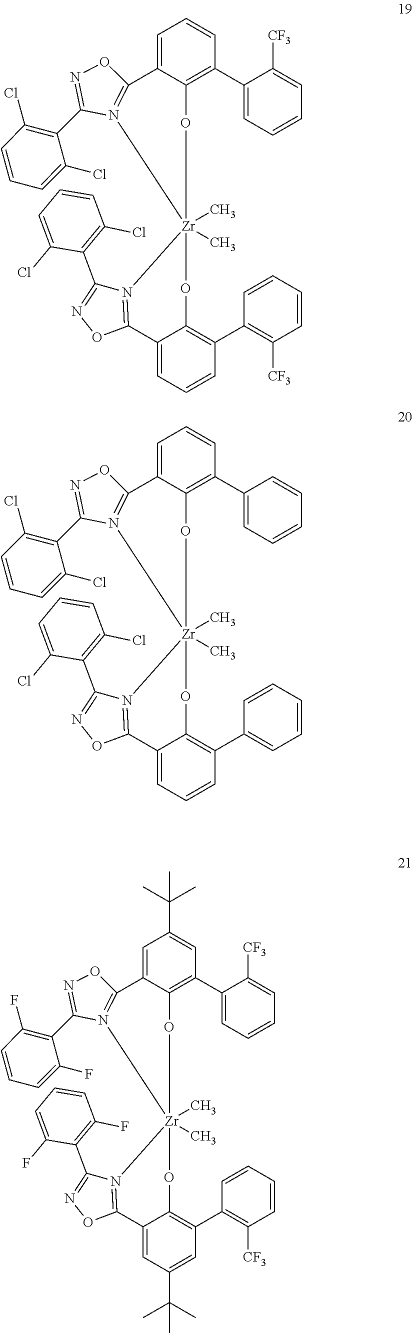

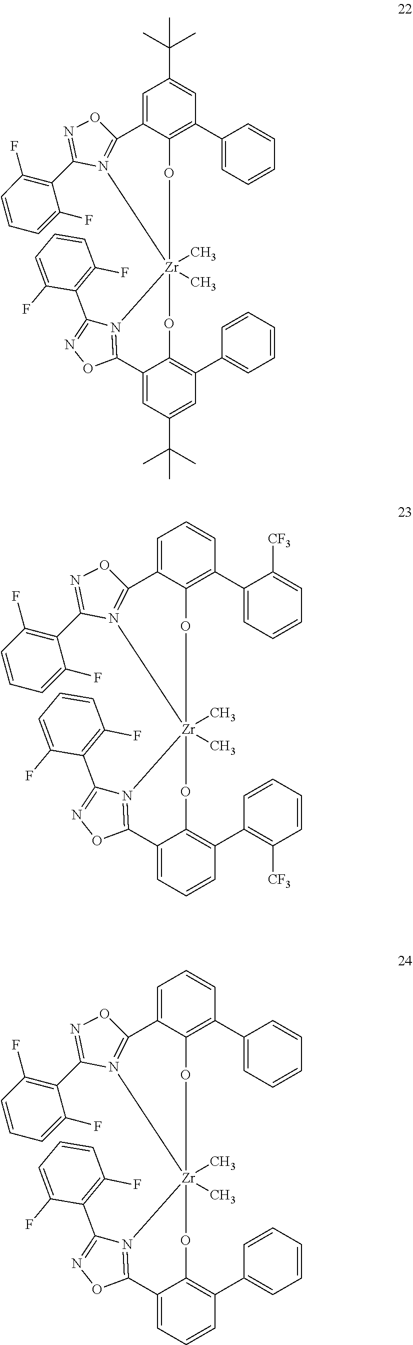

In some embodiments, the catalyst compound of Formula (CI) is:

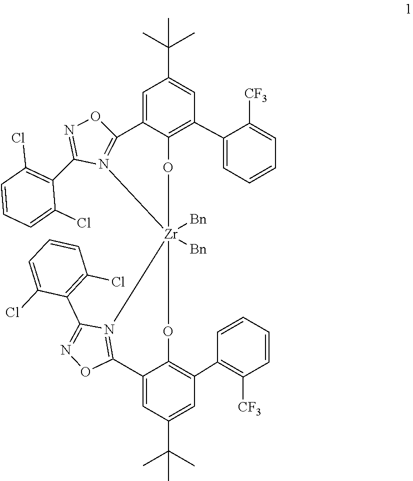

Catalyst compounds having one or more oxadiazole groups of the present disclosure can be synthesized as described in WO2010/132811 A1 or WO2006/066126 A2, each incorporated herein by reference. For example, substituted cyanides can be treated with substituted oxime compounds in the presence of 2,6-lutidine, N-chloro succinimide in cyclohexane under elevated temperature (e.g., 80° C.) to form an oxadiazole ligand.

Oxadiazole ligands can be prepared using known procedures, such as those described, for example, in March, Advanced Organic Chemistry, Wiley, New York 1992 (4^{th} Ed.), and in Katritzky et al, Comprehensive Heterocyclic Chemistry, Elsevier, New York 1984 (1^{st} Ed.) & 1996 (2^{nd} Ed.).

Once the desired ligand is formed, it can be combined with a metal atom, ion, compound or other metal precursor compound, and in some embodiments, compositions can include oxadiazole ligands in combination with an appropriate metal precursor and an optional activator. For example, in some embodiments, the metal precursor can be an activated metal precursor, which refers to a metal precursor (described below) that has been combined or reacted with an activator (described below) prior to combination or reaction with the ancillary ligand. As noted above, in one aspect the invention provides compositions that include such combinations of ligand and metal atom, ion, compound or precursor. In some applications, the ligands are combined with a metal compound or precursor and the product of such combination is not determined, if a product forms. For example, the ligand may be added to a reaction vessel at the same time as the metal or metal precursor compound along with the reactants, activators, scavengers, etc. Additionally, the ligand can be modified prior to addition to or after the addition of the metal precursor, e.g. through a deprotonation reaction or some other modification.

In general, the metal precursor compounds can be characterized by the general formula M(L)ₘ where M is a metal selected from the group consisting of Ti, Hf, and Zr. Each L is a ligand independently selected from the group consisting of hydrogen, halogen, optionally substituted alkyl, heteroalkyl, diene, alkenyl, heteroalkenyl, alkynyl, heteroalkynyl, aryl, heteroaryl, alkoxy, aryloxy, boryl, silyl, amino, phosphino, ether, thioether, phosphine, amine, carboxylate, alkylthio, arylthio, 1,3-dionate, oxalate, carbonate, nitrate, sulphate, and combinations thereof. Optionally, two or more L groups are joined into a ring structure. One or more of the ligands L may be ionically bonded to the metal M and, for example, L may be a non-coordinated or loosely coordinated or weakly coordinated anion (e.g., L may be selected from the group consisting of those anions described below in the conjunction with the activators). (See Marks et al. (2000) Chem. Rev., v. 100, pp. 1391-1434, for a detailed discussion of these weak interactions.) The metal precursors may be monomeric, dimeric or higher orders thereof. In more specific embodiments, the metal precursor includes a metal selected from Zr and Hf. Examples of suitable titanium, hafnium and zirconium precursors include TiCl₄, Ti(CH₂Ph)₄, Ti(CH₂CMe₃)₄, Ti(CH₂SiMe₃)₄, Ti(CH₂Ph)₃C, Ti(CH₂CMe₃)₃Cl, Ti(CH₂SiMe₃)₃Cl, Ti(CH₂Ph)₂Cl₂, Ti(CH₂CMe₃)₂Cl₂, Ti(CH₂SiMe₃)₂Cl₂, Ti(NMe₂)₄, Ti(NEt₂)₄, Ti(O-ⁱPr)₄, and Ti(N(SiMe₃)₂)₂Cl₂; HfCl₄, Hf(CH₂Ph)₄, Hf(CH₂CMe₃)₄, Hf(CH₂SiMe₃)₄, Hf(CH₂Ph)₃Cl, Hf(CH₂CMe₃)₃Cl, Hf(CH₂SiMe₃)₃α Hf(CH₂Ph)₂Cl₂, Hf(CH₂CMe₃)₂Cl₂, Hf(CH₂SiMe₃)₂Cl₂, Hf(NMe₂)₄, Hf(NEt₂)₄, Hf(N(SiMe₃)₂)₂Cl₂, Hf(N(SiMe₃)CH₂CH₂CH₂N(SiMe₃))C₂, and Hf(N(Ph)CH₂CH₂CH₂N(Ph))C₂; ZrCl₄, Zr(CH₂Ph)₄, Zr(CH₂CMe₃)₄, Zr(CH₂SiMe₃)₄, Zr(CH₂Ph)₃Cl, Zr(CH₂CMe₃)₃Cl, Zr(CH₂SiMe₃)₃Cl, Zr(CH₂Ph)₂Cl₂, Zr(CH₂CMe₃)₂Cl₂, Zr(CH₂SiMe₃)₂Cl₂, Zr(NMe₂)₄, Zr(NEt₂)₄, Zr(NMe₂)₂Cl₂, Zr(NEt₂)₂Cl₂, Zr(N(SiMe₃)₂)₂Cl₂)Zr(N(SiMe₃)CH₂CH₂CH₂N(SiMe₃))C₂, and Zr(N(Ph)CH₂CH₂CH₂N(Ph))C₂.

The ligand to metal precursor compound ratio is typically in the range of about 0.01:1 to about 100:1, more specifically in the range of about 0.1:1 to about 10:1 and even more specifically about 1:1, 2:1 or 3:1.

In some embodiments, a co-activator is combined with the catalyst compound (such as halogenated catalyst compounds described above) to form an alkylated catalyst compound. Organoaluminum compounds which may be utilized as co-activators include, for example, trialkyl aluminum compounds, such as trimethylaluminum, triethylaluminum, triisobutylaluminum, tri-n-hexylaluminum, tri-n-octylaluminum, and the like, or alumoxanes.

In some embodiments, as mentioned above, two or more different catalyst compounds are present in the catalyst system used herein (e.g., a dual catalyst system). In some embodiments, two or more different catalyst compounds are present in the reaction zone where the process(es) described herein occur. When two transition metal compound based catalysts are used in one reactor as a mixed catalyst system, the two transition metal compounds are preferably chosen such that the two are compatible. A simple screening method such as by ¹H or ¹³C NMR, known to those of ordinary skill in the art, can be used to determine which transition metal compounds are compatible. It is preferable to use the same activator for the transition metal compounds, however, two different activators can be used in combination. If one or more transition metal compounds contain an anionic ligand as a leaving group which is not a hydrogen, hydrocarbyl, or substituted hydrocarbyl, then the alumoxane or other alkyl aluminum is typically contacted with the transition metal compounds prior to addition of the non-coordinating anion activator.

The two transition metal compounds (pre-catalysts) may be used in any ratio. Preferred molar ratios of (A) transition metal compound to (B) transition metal compound fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

### Support Materials

In embodiments herein, the catalyst system may comprise a support material. In at least one embodiment, the support material is a porous support material, for example, talc, or inorganic oxides. Other support materials include zeolites, clays, organoclays, or any other suitable organic or inorganic support material and the like, or mixtures thereof.

In at least one embodiment, the support material is an inorganic oxide. Suitable inorganic oxide materials for use in catalyst systems herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be used, for example, functionalized polyolefins, such as polypropylene. Supports include magnesia, titania, zirconia, montmorillonite, phyllosilicate, zeolites, talc, clays, and the like. Also, combinations of these support materials may be used, for example, silica-chromium, silica-alumina, silica-titania, and the like. Support materials include Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of from 10 m²/g to 700 m²/g, pore volume in the range of from 0.1 cc/g to 4.0 cc/g and average particle size in the range of from 5 μm to 500 μm. In at least one embodiment, the surface area of the support material is in the range of from 50 m²/g to 500 m²/g, pore volume of from 0.5 cc/g to 3.5 cc/g and average particle size of from 10 μm to 200 μm. In at least one embodiment, the surface area of the support material is in the range is from 100 m²/g to 400 m²/g, pore volume from 0.8 cc/g to 3.0 cc/g and average particle size is from 5 μm to 100 μm. The average pore size of the support material useful in the present disclosure is in the range of from 10 Å to 1000 Å, such as 50 Å to 500 Å, such as 75 Å to 350 Å. In some embodiments, the support material is a high surface area, amorphous silica (surface area=300 m²/gm; pore volume of 1.65 cm³/gm). Exemplary silicas are marketed under the tradenames of DAVISON 952 or DAVISON 955 by the Davison Chemical Division of W.R. Grace and Company. In other embodiments DAVISON 948 is used.

The support material should be dry, that is, substantially free of absorbed water. Drying of the support material can be effected by heating or calcining at 100° C. to 1,000° C., such as at least about 600° C. When the support material is silica, it is heated to at least 200° C., such as 200° C. to 850° C., such as at about 600° C.; and for a time of 1 minute to about 100 hours, from 12 hours to 72 hours, or from 24 hours to 60 hours. The calcined support material should have at least some reactive hydroxyl (OH) groups to produce supported catalyst systems of the present disclosure. The calcined support material is then contacted with at least one polymerization catalyst comprising at least one catalyst compound and an activator.

The support material, having reactive surface groups, typically hydroxyl groups, is slurried in a non-polar solvent and the resulting slurry is contacted with a solution of a catalyst compound and an activator. In some embodiments, the slurry of the support material is first contacted with the activator for a period of time in the range of from 0.5 hours to 24 hours, from 2 hours to 16 hours, or from 4 hours to 8 hours. The solution of the catalyst compound is then contacted with the isolated support/activator. In some embodiments, the supported catalyst system is generated in situ. In at least one embodiment, the slurry of the support material is first contacted with the catalyst compound for a period of time in the range of from 0.5 hours to 24 hours, from 2 hours to 16 hours, or from 4 hours to 8 hours. The slurry of the supported catalyst compound is then contacted with the activator solution.

The mixture of the catalyst, activator and support is heated to 0° C. to 70° C., such as to 23° C. to 60° C., such as at room temperature. Contact times typically range from 0.5 hour to 24 hours, from 2 hours to 16 hours, or from 4 hours to 8 hours.

Suitable non-polar solvents are materials in which all of the reactants used herein, e.g., the activator, and the catalyst compound, are at least partially soluble and which are liquid at room temperature. Non-limiting example non-polar solvents are alkanes, such as isopentane, hexane, n-heptane, octane, nonane, and decane, cycloalkanes, such as cyclohexane, aromatics, such as benzene, toluene, and ethylbenzene.

In at least one embodiment, the support material comprises a support material treated with an electron-withdrawing anion. The support material can be silica, alumina, silica-alumina, silica-zirconia, alumina-zirconia, aluminum phosphate, heteropolytungstates, titania, magnesia, boria, zinc oxide, mixed oxides thereof, or mixtures thereof; and the electron-withdrawing anion is selected from fluoride, chloride, bromide, phosphate, triflate, bisulfate, sulfate, or any combination thereof.

The electron-withdrawing component used to treat the support material can be any component that increases the Lewis or Brønsted acidity of the support material upon treatment (as compared to the support material that is not treated with at least one electron-withdrawing anion). In at least one embodiment, the electron-withdrawing component is an electron-withdrawing anion derived from a salt, an acid, or other compound, such as a volatile organic compound, that serves as a source or precursor for that anion. Electron-withdrawing anions can be sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, or mixtures thereof, or combinations thereof. An electron-withdrawing anion can be fluoride, chloride, bromide, phosphate, triflate, bisulfate, or sulfate, or any combination thereof, at least one embodiment of this disclosure. In at least one embodiment, the electron-withdrawing anion is sulfate, bisulfate, fluoride, chloride, bromide, iodide, fluorosulfate, fluoroborate, phosphate, fluorophosphate, trifluoroacetate, triflate, fluorozirconate, fluorotitanate, or combinations thereof.

Thus, for example, the support material suitable for use in the catalyst systems of the present disclosure can be one or more of fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, sulfated silica-coated alumina, phosphated silica-coated alumina, or combinations thereof. In at least one embodiment, the activator-support can be, or can comprise, fluorided alumina, sulfated alumina, fluorided silica-alumina, sulfated silica-alumina, fluorided silica-coated alumina, sulfated silica-coated alumina, phosphated silica-coated alumina, or combinations thereof. In another embodiment, the support material includes alumina treated with hexafluorotitanic acid, silica-coated alumina treated with hexafluorotitanic acid, silica-alumina treated with hexafluorozirconic acid, silica-alumina treated with trifluoroacetic acid, fluorided boria-alumina, silica treated with tetrafluoroboric acid, alumina treated with tetrafluoroboric acid, alumina treated with hexafluorophosphoric acid, or combinations thereof. Further, any of these activator-supports optionally can be treated with a metal ion.

Nonlimiting examples of cations suitable for use in the present disclosure in the salt of the electron-withdrawing anion include ammonium, trialkyl ammonium, tetraalkyl ammonium, tetraalkyl phosphonium, H+, [H(OEt₂)₂]+, or combinations thereof.

Further, combinations of one or more different electron-withdrawing anions, in varying proportions, can be used to tailor the specific acidity of the support material to a desired level. Combinations of electron-withdrawing components can be contacted with the support material simultaneously or individually, and in any order that provides a desired chemically-treated support material acidity. For example, in at least one embodiment, two or more electron-withdrawing anion source compounds in two or more separate contacting steps.

In at least one embodiment of the present disclosure, one example of a process by which a chemically-treated support material is prepared is as follows: a selected support material, or combination of support materials, can be contacted with a first electron-withdrawing anion source compound to form a first mixture; such first mixture can be calcined and then contacted with a second electron-withdrawing anion source compound to form a second mixture; the second mixture can then be calcined to form a treated support material. In such a process, the first and second electron-withdrawing anion source compounds can be either the same or different compounds.

The method by which the oxide is contacted with the electron-withdrawing component, typically a salt or an acid of an electron-withdrawing anion, can include gelling, co-gelling, impregnation of one compound onto another, or combinations thereof. Following a contacting method, the contacted mixture of the support material, electron-withdrawing anion, and optional metal ion, can be calcined.

According to another embodiment of the present disclosure, the support material can be treated by a process comprising: (i) contacting a support material with a first electron-withdrawing anion source compound to form a first mixture; (ii) calcining the first mixture to produce a calcined first mixture; (iii) contacting the calcined first mixture with a second electron-withdrawing anion source compound to form a second mixture; and (iv) calcining the second mixture to form the treated support material.

### Polymer Processes

In embodiments herein, the present disclosure provides polymerization processes where monomer (such as propylene or ethylene), and optionally comonomer, are contacted with a catalyst system comprising an activator and at least one catalyst compound, as described above. The catalyst compound and activator may be combined in any order, and are combined typically prior to contacting with the monomer.

In at least one embodiment, a polymerization process includes a) contacting one or more olefin monomers with a catalyst system comprising: i) an activator and ii) a catalyst compound of the present disclosure. The activator is a non-coordination anion activator. The one or more olefin monomers may be propylene and/or ethylene and the polymerization process further comprises heating the one or more olefin monomers and the catalyst system to 70° C. or more to form propylene polymers or ethylene polymers, such as propylene polymers.

Monomers useful herein include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer comprises propylene and an optional comonomers comprising one or more propylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups. In at least one embodiment, the monomer comprises propylene and an optional comonomers comprising one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups.

Exemplary C₂ to C₄₀ olefin monomers and optional comonomers include propylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

In at least one embodiment, one or more dienes are present in the polymer produced herein at up to 10 wt %, such as at 0.00001 to 1.0 wt %, such as 0.002 to 0.5 wt %, such as 0.003 to 0.2 wt %, based upon the total weight of the composition. In some embodiments, 500 ppm or less of diene is added to the polymerization, such as 400 ppm or less, such as 300 ppm or less. In other embodiments at least 50 ppm of diene is added to the polymerization, or 100 ppm or more, or 150 ppm or more.

Diene monomers include any hydrocarbon structure, such as C₄ to C₃₀, having at least two unsaturated bonds, where at least two of the unsaturated bonds are readily incorporated into a polymer by either a stereospecific or a non-stereospecific catalyst(s). The diene monomers can be selected from alpha, omega-diene monomers (i.e. di-vinyl monomers). The diolefin monomers are linear di-vinyl monomers, such as those containing from 4 to 30 carbon atoms. Examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes include cyclopentadiene, vinylnorbornene, norbornadiene, ethylidene norbornene, divinylbenzene, dicyclopentadiene or higher ring containing diolefins with or without substituents at various ring positions.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be performed. (A useful homogeneous polymerization process is one where at least 90 wt % of the product is soluble in the reaction media.) A bulk homogeneous process can be used. (An example bulk process is one where monomer concentration in all feeds to the reactor is 70 volume % or more.) Alternately, no solvent or diluent is present or added in the reaction medium, (except for the small amounts used as the carrier for the catalyst system or other additives, or amounts typically found with the monomer; e.g., propane in propylene). In at least one embodiment, the process is a slurry polymerization process. As used herein the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄-C₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, the solvent is not aromatic, such that aromatics are present in the solvent at less than 1 wt %, such as less than 0.5 wt %, such as 0 wt % based upon the weight of the solvents.

In at least one embodiment, the feed concentration of the monomers and comonomers for the polymerization is 60 vol % solvent or less, such as 40 vol % or less, such as 20 vol % or less, based on the total volume of the feedstream. The polymerization can be performed in a bulk process.

Polymerizations can be performed at any temperature and/or pressure suitable to obtain the desired polymers, such as ethylene and or propylene polymers. Typical temperatures and/or pressures include a temperature in the range of from 0° C. to 300° C., such as 20° C. to 200° C., such as 35° C. to 150° C., such as 40° C. to 120° C., such as 45° C. to 80° C., for example about 74° C., and at a pressure in the range of from 0.35 MPa to 10 MPa, such as 0.45 MPa to 6 MPa, such as 0.5 MPa to 4 MPa.

In a typical polymerization, the run time of the reaction is up to 300 minutes, such as in the range of from 5 to 250 minutes, such as 10 to 120 minutes.

In at least one embodiment, hydrogen is present in the polymerization reactor at a partial pressure of 0.001 to 50 psig (0.007 to 345 kPa), such as from 0.01 to 25 psig (0.07 to 172 kPa), such as 0.1 to 10 psig (0.7 to 70 kPa).

In at least one embodiment, the activity of the catalyst is from 500 kgP/mmolCat/hour to 20,000 kgP/mmolCat/hr, such as from 1,000 kgP/mmolCat/hr to 15,000 kgP/mmolCat/hr, such as from 1,000 kgP/mmolCat/hr to 4,000 kgP/mmolCat/hr, such as about 2,000 kgP/mmolCat/hr or more, such as 3,000 kgP/mmolCat/hr or more.

In at least one embodiment, the conversion of olefin monomer is at least 10%, based upon polymer yield and the weight of the monomer entering the reaction zone, such as 20% or more, such as 30% or more, such as 50% or more, such as 80% or more.

In at least one embodiment, a catalyst system of the present disclosure is capable of producing a polyolefin. In at least one embodiment, the polyolefin is a homopolymer of ethylene or propylene or a copolymer of ethylene such as a copolymer of ethylene having from 0.1 to 25 wt % (such as from 0.5 to 20 wt %, such as from 1 to 15 wt %, such as from 5 to 17 wt %) of ethylene with the remainder balance being one or more C₃ to C₂₀ olefin comonomers (such as C₃ to C₁₂ alpha-olefin, such as propylene, butene, hexene, octene, decene, dodecene, such as propylene, butene, hexene, octene). The polyolefin can be a copolymer of propylene such as a copolymer of propylene having from 0.1 to 25 wt % (such as from 0.5 to 20 wt %, such as from 1 to 15 wt %, such as from 3 to 10 wt %) of propylene and from 99.9 to 75 wt % of one or more of C₂ or C₄ to C₂₀ olefin comonomer (such as ethylene or C₄ to C₁₂ alpha-olefin, such as butene, hexene, octene, decene, dodecene, such as ethylene, butene, hexene, octene).

In at least one embodiment, a catalyst system of the present disclosure is capable of producing a polyolefin that is a copolymer of ethylene and a comonomer, where the copolymer has a comonomer content of from 0.1 to 25 wt % (such as from 1 to 15 wt %, such as from 5 to 15 wt %, such as from 6 to 10 wt %). Comonomers can be one or more of a C₃ to C₂₀ olefin comonomer (such as C₃ to C₁₂ alpha-olefin, such as propylene, butene, hexene, octene, decene, dodecene, such as propylene, butene, hexene, octene). For example, a comonomer can be octene.

In at least one embodiment, a catalyst system of the present disclosure is capable of producing polyolefins, such as polypropylene or ethylene-alpha olefin copolymer, having an Mw from 5,000 to 500,000 g/mol, such as from 10,000 to 300,000 g/mol, such as from 5,000 to 500,000 g/mol, such as from 10,000 to 100,000 g/mol, such as from 20,000 to 80,000 g/mol, such as from 20,000 to 40,000 g/mol.

In at least one embodiment, a catalyst system of the present disclosure is capable of producing polyolefins, such as polypropylene or ethylene-alpha olefin copolymer, having an Mn from 1,000 to 200,000 g/mol, such as from 5,000 to 100,000 g/mol, such as from 10,000 to 50,000 g/mol, such as from 10,000 to 20,000 g/mol.

In at least one embodiment, a catalyst system of the present disclosure is capable of producing polypropylene or ethylene-alpha olefin copolymer having an Mw/Mn value from 1 to 10, such as from 1.5 to 9, such as from 1.5 to 7, such as from 2 to 4, such as from 2 to 3, for example about 2.

In at least one embodiment, little or no scavenger is used in the process to produce polymer, such as propylene polymer. Scavenger (such as trialkyl aluminum) can be present at zero mol %, alternately the scavenger is present at a molar ratio of scavenger metal to transition metal of less than 100:1, such as less than 50:1, such as less than 15:1, such as less than 10:1.

In at least one embodiment, the polymerization: 1) is conducted at temperatures of 0 to 300° C. (such as 25 to 150° C., such as 40 to 120° C., such as 70 to 110° C., such as 85 to 100° C.); 2) is conducted at a pressure of atmospheric pressure to 10 MPa (such as 0.35 to 10 MPa, such as from 0.45 to 6 MPa, such as from 0.5 to 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, where aromatics are present in the solvent at less than 1 wt %, such as less than 0.5 wt %, such as at 0 wt % based upon the weight of the solvents); and 4) the activity of the catalyst compound is at least 2,000 kgP/mmolCat/hr (such as at least 2.5,000 kgP/mmolCat/hr, such as at least 3,000 kgP/mmolCat/hr).

In at least one embodiment, the catalyst system used in the polymerization comprises no more than one catalyst compound. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In at least one embodiment, the polymerization occurs in one reaction zone.

Other additives may also be used in the polymerization, as desired, such as one or more scavengers, promoters, modifiers, chain transfer agents (such as diethyl zinc), hydrogen, or aluminum alkyls. Useful chain transfer agents are typically alkylalumoxanes, a compound represented by the formula AlR₃, ZnR₂ (where each R is, independently, a C₁-C₈ aliphatic radical, such as methyl, ethyl, propyl, butyl, phenyl, hexyl, octyl or an isomer thereof) or a combination thereof, such as diethyl zinc, methylalumoxane, trimethylaluminum, triisobutylaluminum, trioctylaluminum, or a combination thereof.

### Gas Phase Polymerization

Generally, in a fluidized gas bed process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference.)

### Slurry Phase Polymerization

A slurry polymerization process generally operates between 1 to about 50 atmosphere pressure range (15 psi to 735 psi, 103 kPa to 5,068 kPa) or even greater and temperatures in the range of 0° C. to about 120° C. In a slurry polymerization, a suspension of solid, particulate polymer is formed in a liquid polymerization diluent medium to which monomer and comonomers, along with catalysts, are added. The suspension including diluent is intermittently or continuously removed from the reactor where the volatile components are separated from the polymer and recycled, optionally after a distillation, to the reactor. The liquid diluent used in the polymerization medium is typically an alkane having from 3 to 7 carbon atoms, such as a branched alkane. The medium employed should be liquid under the conditions of polymerization and relatively inert. When a propane medium is used, the process must be operated above the reaction diluent critical temperature and pressure. For example, a hexane or an isobutane medium is employed.

In at least one embodiment, a polymerization process is a particle form polymerization, or a slurry process, where the temperature is kept below the temperature at which the polymer goes into solution. Such technique is well known in the art, and described in for instance U.S. Pat. No. 3,248,179 which is fully incorporated herein by reference. The temperature in the particle form process can be from about 85° C. to about 110° C. Two example polymerization methods for the slurry process are those using a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484, which is herein fully incorporated by reference.

In another embodiment, the slurry process is carried out continuously in a loop reactor. The catalyst, as a slurry in isohexane or as a dry free flowing powder, is injected regularly to the reactor loop, which is itself filled with circulating slurry of growing polymer particles in a diluent of isohexane containing monomer and optional comonomer. Hydrogen, optionally, may be added as a molecular weight control. (In one embodiment hydrogen is added from 50 ppm to 500 ppm, such as from 100 ppm to 400 ppm, such as 150 ppm to 300 ppm.)

The reactor may be maintained at a pressure of 2,000 kPa to 5,000 kPa, such as from 3,620 kPa to 4,309 kPa, and at a temperature of from about 60° C. to about 120° C. depending on the desired polymer melting characteristics. Reaction heat is removed through the loop wall since much of the reactor is in the form of a double-jacketed pipe. The slurry is allowed to exit the reactor at regular intervals or continuously to a heated low pressure flash vessel, rotary dryer and a nitrogen purge column in sequence for removal of the isohexane diluent and all unreacted monomer and comonomer. The resulting hydrocarbon free powder is then compounded for use in various applications.

Other additives may also be used in the polymerization, as desired, such as one or more scavengers, promoters, modifiers, chain transfer agents (such as diethyl zinc), reducing agents, oxidizing agents, hydrogen, aluminum alkyls, or silanes.

Useful chain transfer agents are typically alkylalumoxanes, a compound represented by the formula AlR₃, ZnR₂ (where each R is, independently, a C₁-C₈ hydrocarbyl, such as methyl, ethyl, propyl, butyl, penyl, hexyl octyl or an isomer thereof). Examples can include diethyl zinc, methylalumoxane, trimethylaluminum, triisobutylaluminum, trioctylaluminum, or a combination thereof.

### Solution Polymerization

A solution polymerization is a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. Such systems are typically not turbid as described in in Oliveira, J. V. et al. (2000) “High-Pressure Phase Equilibria for Polypropylene-Hydrocarbon Systems,” Ind. Eng. Chem. Res., v. 39, pp. 4627-4633. Generally solution polymerization involves polymerization in a continuous reactor in which the polymer formed and the starting monomer and catalyst materials supplied, are agitated to reduce or avoid concentration gradients and in which the monomer acts as a diluent or solvent or in which a hydrocarbon is used as a diluent or solvent. Suitable processes typically operate at temperatures from about 0° C. to about 250° C., such as about 10° C. to about 150° C., such as about 40° C. to about 140° C., such as about 50° C. to about 120° C., and at pressures of about 0.1 MPa or more, such as 2 MPa or more. The upper pressure limit is not critically constrained but typically can be about 200 MPa or less, such as 120 MPa or less. Temperature control in the reactor can generally be obtained by balancing the heat of polymerization and with reactor cooling by reactor jackets or cooling coils to cool the contents of the reactor, auto refrigeration, pre-chilled feeds, vaporization of liquid medium (diluent, monomers or solvent) or combinations of all three. Adiabatic reactors with pre-chilled feeds can also be used. The purity, type, and amount of solvent can be optimized for the maximum catalyst productivity for a particular type of polymerization. The solvent can be also introduced as a catalyst carrier. The solvent can be introduced as a gas phase or as a liquid phase depending on the pressure and temperature. Advantageously, the solvent can be kept in the liquid phase and introduced as a liquid. Solvent can be introduced in the feed to the polymerization reactors.

### Polyolefin Products

The present disclosure also provides compositions of matter, such as polyolefins, which can be produced by the methods described herein.

In at least one embodiment, the polyolefin is a propylene homopolymer, a propylene copolymer, an ethylene homopolymer or an ethylene copolymer, such as propylene-ethylene and/or ethylene-alphaolefin (such as C₄ to C₂₀) copolymer (such as an ethylene-hexene copolymer or an ethylene-octene copolymer). The polyolefin can have an Mw/Mn of greater than 1 to 4 (such as greater than 1 to 3).

In at least one embodiment, the polyolefin is a homopolymer of ethylene or propylene or a copolymer of ethylene such as a copolymer of ethylene having from 0.1 to 25 wt % (such as from 0.5 to 20 wt %, such as from 1 to 15 wt %, such as from 5 to 17 wt %) of ethylene with the remaining balance being one or more C₃ to C₂₀ olefin comonomers (such as C₃ to C₁₂ alpha-olefin, such as propylene, butene, hexene, octene, decene, dodecene, such as propylene, butene, hexene, octene). The polyolefin can be a copolymer of propylene such as a copolymer of propylene having from 0.1 to 25 wt % (such as from 0.5 to 20 wt %, such as from 1 to 15 wt %, such as from 3 to 10 wt %) of propylene and from 99.9 to 75 wt % of one or more of C₂ or C₄ to C₂₀ olefin comonomer (such as ethylene or C₄ to C₁₂ alpha-olefin, such as butene, hexene, octene, decene, dodecene, such as ethylene, butene, hexene, octene).

In at least one embodiment, the polyolefin is a copolymer of ethylene and a comonomer, where the copolymer has a comonomer content of from 0.1 to 25 wt % (such as from 1 to 15 wt %, such as from 5 to 15 wt %, such as from 6 to 10 wt %). Comonomers can be one or more of a C₃ to C₂₀ olefin comonomer (such as C₃ to C₁₂ alpha-olefin, such as propylene, butene, hexene, octene, decene, dodecene, such as propylene, butene, hexene, octene). For example, a comonomer can be octene.

In at least one embodiment, the polyolefin can be a polypropylene or ethylene-alpha olefin copolymer having an Mw from 5,000 to 500,000 g/mol, such as from 10,000 to 300,000 g/mol, such as from 5,000 to 500,000 g/mol, such as from 10,000 to 100,000 g/mol, such as from 20,000 to 80,000 g/mol, such as from 20,000 to 40,000 g/mol.

In at least one embodiment, the polyolefin can be a polypropylene or ethylene-alpha olefin copolymer having an Mn from 1,000 to 200,000 g/mol, such as from 5,000 to 100,000 g/mol, such as from 10,000 to 50,000 g/mol, such as from 10,000 to 20,000 g/mol.

In at least one embodiment, the polyolefin can be a polypropylene or ethylene-alpha olefin copolymer having an Mw/Mn value from 1 to 10, such as from 1.5 to 9, such as from 1.5 to 7, such as from 2 to 4, such as from 2 to 3, for example about 2.

In at least one embodiment, the polyolefin, such as a polypropylene or ethylene-alpha olefin copolymer, has a melt temperature (Tm) of from 100° C. to 150° C., such as 110° C. to 140° C., such as 120° C. to 135°, such as 120° C. to 125° C.

In at least one embodiment, the polyolefin is an ethylene copolymer, and the comonomer is octene, at a comonomer content of from 1 wt % to 15 wt % octene, such as from 5 wt % to 11 wt %, such as from 6 wt % to 10 wt %, such as from 8 wt % to 10 wt %.

Molecular Weight, Comonomer Composition and Long Chain Branching Determination by Polymer Char GPC-IR Hyphenated with Multiple Detectors (GPC-4D)

In the event of conflict between this GPC-4D procedure and the Rapid GPC procedure below, this GPC-4D procedure shall be used.

For purposes of the claims, and unless otherwise indicated, the distribution and the moments of molecular weight (Mw, Mn, Mz, Mw/Mn, etc.), the comonomer content (C₂, C₃, C₆, etc.) and the branching index (g′) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1 m Teflon filter and degassed with an online degasser before entering the GPC instrument. The nominal flow rate is 1.0 mL/min and the nominal injection volume is 200 μL. The whole system including transfer lines, columns, detectors are contained in an oven maintained at 145° C. Given amount of polymer sample is weighed and sealed in a standard vial with 80 μL flow marker (heptane) added to it. After loading the vial in the autosampler, polymer is automatically dissolved in the instrument with 8 mL added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples.

The concentration (c), at each point in the chromatogram is calculated from the baseline-subtracted IR5 broadband signal intensity (I), using the following equation:

c=βI

where β is the mass constant determined with PE or PP standards. The mass recovery is calculated from the ratio of the integrated area of the concentration chromatography over elution volume and the injection mass which is equal to the pre-determined concentration multiplied by injection loop volume.

The conventional molecular weight (IR MW) is determined by combining universal calibration relationship with the column calibration which is performed with a series of monodispersed polystyrene (PS) standards ranging from 700 to 10M. The MW at each elution volume is calculated with following equation.

$$log M = \frac{log ( {K}_{PS} \text{/} K )}{a + 1} + \frac{{a}_{PS} + 1}{a + 1} log {M}_{PS}$$

where the variables with subscript “PS” stands for polystyrene while those without a subscript are for the test samples. In this method, a_{PS}=0.67 and K_{PS}=0.000175 while a and K are calculated as described in the published in literature (Sun, T. et al. (2001) “Effect of Short Chain Branching on the Coil Dimensions of Polyolefins in Dilute Solutions,” Macromolecules, v. 34(19), pp. 6812-6820), except that for purposes of this invention and claims thereto, α=0.695 and K=0.000579 for polyethylene, α=0.705 and K=0.0002288 for polypropylene, α=0.695+(0.01*(wt. fraction propylene)) and K=0.000579-(0.0003502*(wt. fraction propylene)) for ethylene-propylene copolymers and ethylene-propylene-diene terpolymers, α=0.695 and K=0.000181 for linear butene polymers, α is 0.695 and K is 0.000579*(1-0.0087*w2b+0.000018*(w2b)\hat{ }2) for ethylene-butene copolymer where w2b is a bulk weight percent of butene comonomer, a is 0.695 and K is 0.000579*(1-0.0075*w2b) for ethylene-hexene copolymer where w2b is a bulk weight percent of hexene comonomer, and α is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR.

The LS detector is the 18-angle Wyatt Technology High Temperature DAWN HELEOSII. The LS molecular weight (M) at each point in the chromatogram is determined by analyzing the LS output using the Zimm model for static light scattering (M. B. Huglin, Light Scattering from Polymer Solutions, Academic Press, 1971):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A₂ is the second virial coefficient. P(0) is the form factor for a monodisperse random coil, and Kₒ is the optical constant for the system:

$${K}_{o} = \frac{4 {π}^{2} {{n}^{2} ( dn \text{/} dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

[η]=ηₛ/c

where c is concentration and was determined from the IR5 broadband channel output. The viscosity MW at each point is calculated from the below equation:

M=K_{PS}M^{α}^{_{PS}}⁺¹/[η].

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} = \frac{Σ {{c}_{i} [ η ]}_{i}}{Σ {c}_{i}}$$

where the summations are over the chromatographic slices, i, between the integration limits. The branching index g′ᵥᵢₛ is defined as:

$${g}_{vis}^{′} = \frac{{[ η ]}_{avg}}{{kM}_{v}^{α}}$$

Mᵥ is the viscosity-average molecular weight based on molecular weights determined by LS analysis. The K/a are for the reference linear polymers are as described above.

All the concentration is expressed in g/cm³, molecular weight is expressed in g/mole, and intrinsic viscosity is expressed in dL/g unless otherwise noted.

All molecular weights are reported in g/mol unless otherwise noted.

Differential Scanning Calorimetry (DSC-Procedure-2). Melt Temperature, Tm, is measured by differential scanning calorimetry (“DSC”) using a DSCQ200 unit. The sample is first equilibrated at 25° C. and subsequently heated to 220° C. using a heating rate of 10° C./min (first heat). The sample is held at 220° C. for 3 minutes. The sample is subsequently cooled down to −100° C. with a constant cooling rate of 10° C./min (first cool). The sample is equilibrated at −100° C. before being heated to 220° C. at a constant heating rate of 10° C./min (second heat). The exothermic peak of crystallization (first cool) is analyzed using the TA Universal Analysis software and the corresponding to 10° C./min cooling rate is determined. The endothermic peak of melting (second heat) is also analyzed using the TA Universal Analysis software and the peak melt temperature (Tm) corresponding to 10° C./min heating rate is determined. In the event of conflict between the DSC Procedure-1 and DSC procedure-2, DSC procedure-2 is used.

### Blends

In another embodiment, the polymer (such as the polyethylene or polypropylene) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, low density polyethylene (LDPE), linear low density polyethylene (LLDPE), high density polyethylene (HDPE), ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In at least one embodiment, the polymer (such as polyethylene or polypropylene) is present in the above blends, at from 10 to 99 wt %, based upon the weight of the polymers in the blend, such as 20 to 95 wt %, such as at least 30 to 90 wt %, such as at least 40 to 90 wt %, such as at least 50 to 90 wt %, such as at least 60 to 90 wt %, such as at least 70 to 90 wt %.

The blends described above may be produced by mixing the polymers of the present disclosure with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; and talc.

### Films

One or more of the foregoing polymers, such as the foregoing polyethylenes, polypropylenes, or blends thereof, may be used in a variety of end-use applications. Such applications include, for example, mono- or multi-layer blown, extruded, and/or shrink films. These films may be formed by any number of well-known extrusion or coextrusion techniques, such as a blown bubble film processing technique, where the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, such as between 5 and 7, and in the Transverse Direction (TD) at a ratio of up to 15, such as 7 to 9. However, in at least one embodiment the film is oriented to the same extent in both the MD and TD directions.

The films may vary in thickness depending on the intended application; however, films of a thickness from 1 μm to 50 μm are usually suitable. Films intended for packaging are usually from 10 μm to 50 μm thick. The thickness of the sealing layer is typically 0.2 μm to 50 μm. There may be a sealing layer on both the inner and outer surfaces of the film or the sealing layer may be present on only the inner or the outer surface.

In at least one embodiment, one or more layers may be modified by corona treatment, electron beam irradiation, gamma irradiation, flame treatment, or microwave. In at least one embodiment, one or both of the surface layers is modified by corona treatment.

### Additional Aspects

The present disclosure provides, among others, the following aspects, each of which may be considered as optionally including any alternate aspects.

Clause 1. A catalyst system comprising:

(1) a catalyst compound represented by the Formula (CI):

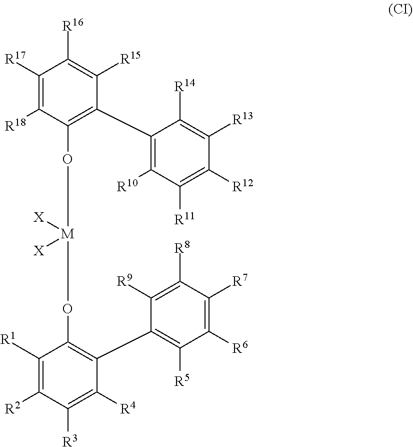

M is selected from the group consisting of Ti, Zr, and Hf;

wherein each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is independently selected from the group consisting of hydrogen, hydrocarbyl, substituted hydrocarbyl, heterohydrocarbyl, substituted heterohydrocarbyl, alkoxy, substituted alkoxy, aryloxy, substituted aryloxy, hydroxyl, alkylthio, substituted alkylthio, arylthio, substituted arylthio, aryl, substituted aryl, heteroaryl, substituted heteroaryl, halide, silyl, boryl, phosphinyl, and amino; with the proviso that at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is an oxadiazole group having the following structure:

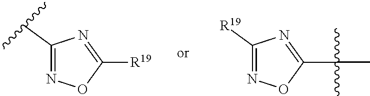

wherein R¹⁹ is independently selected from the group consisting of hydrogen, hydrocarbyl, substituted hydrocarbyl, heterohydrocarbyl, substituted heterohydrocarbyl, alkoxy, substituted alkoxy, aryloxy, substituted aryloxy, hydroxyl, alkylthio, substituted alkylthio, arylthio, substituted arylthio, aryl, substituted aryl, heteroaryl, substituted heteroaryl, halide, silyl, boryl, phosphinyl, and amino; and

each X is independently a leaving group; and

(2) an activator represented by Formula (AI):

[R¹R²R³EH]_{d}⁺[M^{k+}Qₙ]^{d-} (AI)

wherein:

E is nitrogen or phosphorous;

d is 1, 2 or 3; k is 1, 2, or 3; n is 1, 2, 3, 4, 5, or 6; n−k=d;

each of R¹, R², and R³ is independently hydrogen, a C₁-C₄ alkyl, or a C₅-C₅₀-aryl, wherein each of R¹, R², and R³ is independently unsubstituted or substituted; wherein R¹, R², and R³ together comprise 15 or more carbon atoms;

M is an element selected from group 13 of the Periodic Table of the Elements; and

each Q is independently selected from the group consisting of a hydrogen, bridged or unbridged dialkylamido, halide, alkoxy, substituted alkoxy, aryloxy, substituted aryloxy, hydrocarbyl, substituted hydrocarbyl, halocarbyl, substituted halocarbyl, and halosubstituted-hydrocarbyl radical.

Clause 2. The catalyst system of Clause 1, wherein the activator compound of Formula (AI) is represented by Formula (I):

[R¹R²R³EH]⁺[BR⁴R⁵R⁶R⁷]⁻ (I)

wherein:

E is nitrogen or phosphorous;

each of R¹, R², and R³ is independently C₁-C₄₀ branched or linear alkyl or C₅-C₅₀-aryl, wherein each of R¹, R², and R³ is independently unsubstituted or substituted with at least one of halide, C₅-C₅₀ aryl, C₆-C₃₅ arylalkyl, C₆-C₃₅ alkylaryl or, in the case of the C₅-C₅₀-aryl, C₁-C₅₀ alkyl; wherein R¹, R², and R³ together comprise 15 or more carbon atoms; and

each of R⁴, R⁵, R⁶, and R⁷ is naphthyl, wherein at least one of R⁴, R⁵, R⁶, and R⁷ is substituted with from one to seven fluorine atoms.

Clause 3. The catalyst system of Clause 1 or 2, wherein: at least one of R¹, R², and R³ of Formula (AI) or (I) is independently a C₃-C₄₀ alkyl which is unsubstituted or substituted with at least one of halide, C₅-C₁₅ aryl, C₆-C₂₅ arylalkyl, and C₆-C₂₅ alkylaryl.
Clause 4. The catalyst system of Clause 1 or 2, wherein, for the activator of Formula (AI) or (I): R¹ is methyl; R² is C₁₀-C₄₂ aryl; R³ is C₁-C₄₀ branched alkyl; wherein each of R² and R³ is independently unsubstituted or substituted with at least one of halide, C₅-C₁₅ aryl, C₆-C₂₅ arylalkyl, C₆-C₂₅ alkylaryl, and in the case of the C₁₀ to C₄₂ aryl, C₁-C₁₀ alkyl; and R² and R³ together comprise 20 or more carbon atoms.
Clause 5. The catalyst system of Clauses 1, 2, 3, or 4 wherein, for the activator of Formula (AI) or (I), E is nitrogen.
Clause 6. The catalyst system of any of Clauses 1, 2, 3, 4 or 5, wherein, for the activator of Formula (I), R⁴, R⁵, R⁶, and R⁷ are perfluoroaryl.
Clause 7. The catalyst system of any of Clauses 1, 2, 3, 4, or 5, wherein, for the activator of Formula (I), each of R⁴, R⁵, R⁶, and R⁷ is substituted with from one to seven fluorine atoms, preferably seven fluorine atoms.
Clause 8. The catalyst system of any of Clauses 1, 2, 3, 4, 5, 6, or 7, wherein R¹, R², and R³ together comprise 21 or more carbon atoms.
Clause 9. The catalyst system of any of Clauses 1 to 7, wherein all Q in Formula (AI) are not perfluorophenyl, and each of R⁴, R⁵, R⁶, and R⁷ in Formula (I) are not perfluorophenyl.
Clause 10. The catalyst system of Clause 2, wherein at least one of R¹, R², and R³ of Formula (AI) or (I) is an alkyl group represented by the formula:

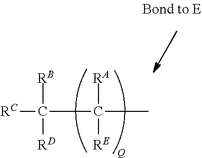

wherein each of R^{A} and R^{E} are independently selected from the group consisting of H, a C₁-C₄₀ linear or branched alkyl, and C₅-C₅₀-aryl, wherein each of R^{A} and R^{E} is optionally substituted with one or more of halide, C₅-C₅₀ aryl, C₆-C₃₅ arylalkyl, C₆-C₃₅ alkylaryl and, in the case of the C₅-C₅₀-aryl, C₁-C₅₀ alkyl, provided that in at least one (R^{A}—C—R^{E}) group, one or both of R^{A} and R^{E} is not H; and

R^{C}, R^{B} and R^{D} are hydrogen; and Q is an integer from 5 to 40.

Clause 11. The catalyst system of any of the above Clauses wherein one, two or three of R¹, R² and R³ are independently represented by the Formula (IV):

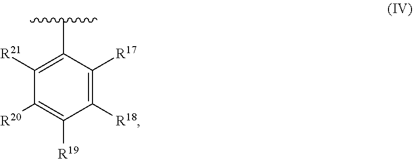

wherein each of R¹⁷, R¹⁸, R¹⁹, R²⁰, and R²¹ is independently selected from the group consisting of hydrogen, C₁-C₄₀ hydrocarbyl, C₁-C₄₀ substituted hydrocarbyl, a heteroatom, a heteroatom-containing group, or is represented by Formula (BIII), provided that at least one of R¹⁷, R¹⁸, R¹⁹, R²⁰, and R²¹ is not hydrogen, wherein Formula (BIII) is:

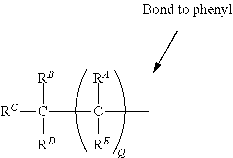

wherein each of R^{A} and R^{E} is independently selected from the group consisting of H, a C₁-C₄₀ linear or branched alkyl, and C₅-C₅-aryl, wherein each of R^{A} and R^{E} is optionally substituted with one or more groups selected from the group consisting of halide, C₅-C₅₀ aryl, C₆-C₃₅ arylalkyl, C₆-C₃₅ alkylaryl, and, in the case of the C₅-C₅₀-aryl, C₁-C₅₀ alkyl, provided that in at least one (R^{A}—C—R^{E}) group, one or both of R^{A} and R^{E} is not H;

R^{C}, R^{B} and R^{D} are hydrogen; and

Q is an integer from 5 to 40.

Clause 12. The catalyst system of Clause 1 or 2, wherein R¹ is C₁-C₁₀ alkyl and each of R² and R³ is independently a linear or branched C₁₀-C₄₀ alkyl.
Clause 13. The catalyst system of Clause 1 or 2, wherein R¹ is C₅-C₂₂-aryl and each of R² and R³ is independently a linear or branched C₁-C₄₀ alkyl, wherein R¹ is unsubstituted or substituted with at least one C₁-C₁₀ alkyl.
Clause 14. The catalyst system of Clause 13, wherein R¹ is phenyl, R² is methyl, and R³ is a C₁₀-C₄₀ branched alkyl.
Clause 15. The catalyst system of any of Clauses 1 to 14, wherein the activator compound has a solubility of more than 10 mM at 25° C. (stirred 2 hours) in methylcyclohexane and/or a solubility of more than 1 mM at 25° C. (stirred 2 hours) in isohexane.
Clause 16. The catalyst system of any of Clauses 1 to 14, wherein the catalyst system has a solubility of more than 20 mM at 25° C. (stirred 2 hours) in methylcyclohexane and/or a solubility of more than 10 mM at 25° C. (stirred 2 hours) in isohexane.
Clause 17. The catalyst system of any of Clauses 1 to 16, wherein for the catalyst compound of Formula (CI), each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ is independently selected from the group consisting of hydrogen, alkyl, substituted alkyl, heteroalkyl, substituted heteroalkyl, alkoxy, substituted alkoxy, aryloxy, aryl, substituted aryl, heteroaryl, substituted heteroaryl, aralkyl, substituted aralkyl, alkaryl, substituted alkaryl, and halide, wherein at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is the oxadiazole group.
Clause 18. The catalyst system of any of Clauses 1 to 17, wherein, for the catalyst compound of Formula (CI), each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ is independently selected from the group consisting of hydrogen, hydrocarbyl, substituted hydrocarbyl, and halide, wherein at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is the oxadiazole group.
Clause 19. The catalyst system of any of Clauses 1 to 18, wherein, for the catalyst compound of Formula (CI), each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is independently selected from the group consisting of hydrogen, alkyl, haloalkyl, and halide, wherein R¹⁹ is substituted aryl, and wherein at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is the oxadiazole group.
Clause 20. The catalyst system of Clause 19, wherein R¹⁹ is an aryl group substituted with one or more halides.
Clause 21. The catalyst system of any of Clauses 1 to 16, wherein the catalyst compound of Formula (CI) is represented by Formula (III):

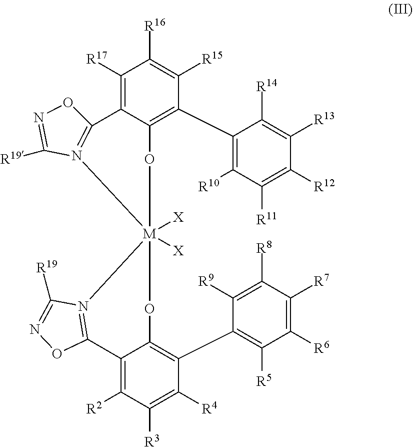

wherein:

M is selected from the group consisting of Ti, Zr, and Hf;

each of R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁹, and R^{19′} is independently selected from the group consisting of hydrogen, alkyl, substituted alkyl, heteroalkyl, substituted heteroalkyl, alkoxy, substituted alkoxy, aryloxy, aryl, substituted aryl, heteroaryl, substituted heteroaryl, aralkyl, substituted aralkyl, alkaryl, substituted alkaryl, and halide; and

each X is independently a leaving group.

Clause 22. The catalyst system of Clause 21, wherein R¹⁹ and R^{19′} are independently an aryl group substituted with one or more halides.
Clause 23. The catalyst system of Clauses 21 or 22, wherein, for the catalyst compound represented by Formula (III), each of R², R³, R⁴, R⁵, R⁶, R⁷, R⁸, R⁹, R¹⁰, R¹¹, R¹², R¹³, R¹⁴, R¹, R¹⁶, R¹⁷, R¹⁹, and R^{19′} is independently selected from the group consisting of hydrogen, methyl, ethyl, n-propyl, isopropyl, n-butyl, isobutyl, t-butyl, n-pentyl, isopentyl, n-hexyl, isohexyl, n-heptyl, isoheptyl, n-octyl, isooctyl, n-nonyl, isononyl, n-decyl, isodecyl, phenyl, chlorophenyl, dichlorophenyl, trichlorophenyl, tetrachlorophenyl, perchlorophenyl, fluorophenyl, difluorophenyl, trifluorophenyl, tetrafluorophenyl, perfluorophenyl, —CF₃, —C₂F₂CF₃, —C₂F₂C₂F₂CF₃, F, and Cl.
Clause 24. The catalyst system of any of Clauses 21 to 23, wherein, for the catalyst compound represented by Formula (III), each of R¹⁹ and R^{19′} is independently selected from the group consisting of chlorophenyl, dichlorophenyl, trichlorophenyl, tetrachlorophenyl, and perchlorophenyl.
Clause 25. The catalysts system of any of Clauses 21 to 24, wherein, for the catalyst compound represented by Formula (III), each of R³ and R¹⁶ is independently selected from the group consisting of methyl, ethyl, n-propyl, isopropyl, n-butyl, isobutyl, t-butyl, n-pentyl, isopentyl, n-hexyl, isohexyl, n-heptyl, isoheptyl, n-octyl, isooctyl, n-nonyl, isononyl, n-decyl, and isodecyl.
Clause 26. The catalyst system of any of Clauses 21 to 25, wherein, for the catalyst compound represented by Formula (III), each of R⁵ and R¹⁴ is independently selected from the group consisting of —CF₃, —C₂F₂CF₃, —C₂F₂C₂F₂CF₃, F, and Cl.
Clause 27. The catalyst system of any of Clauses 21 to 26, wherein, for the catalyst compound represented by Formula (III), each of R², R⁴, R⁵, R⁶, R⁷, R⁸, R⁹, R¹⁰, R¹¹, R¹², R¹³, R¹⁴, R¹⁵, and R¹⁷ is hydrogen.
Clause 28. The catalyst system of any of Clauses 1 to 27, wherein, for the catalyst compound represented by Formula (CI) or (III), each X is benzyl.
Clause 29. The catalyst system of Clause 1, wherein the catalyst compound represented by Formula (CI) is selected from the group consisting of:

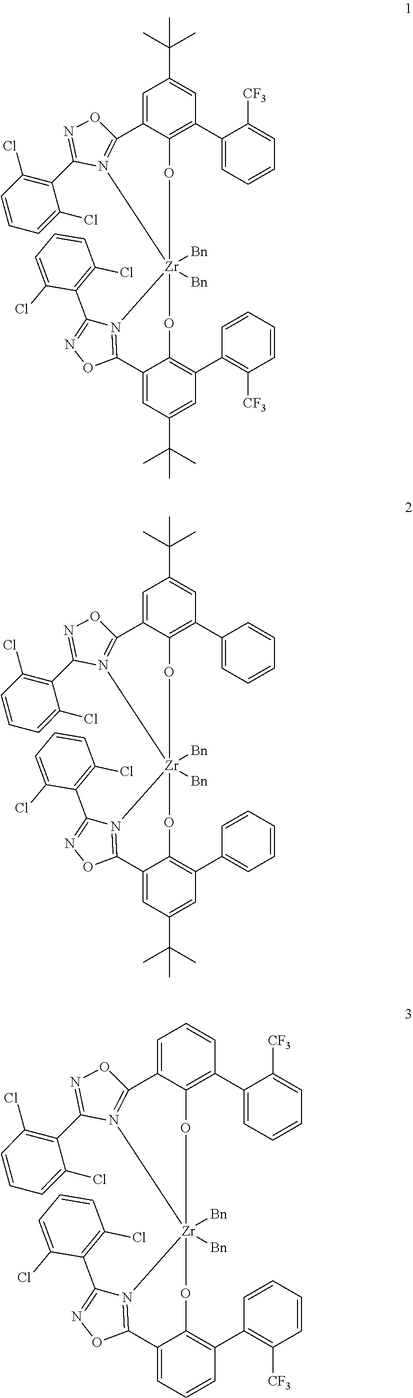

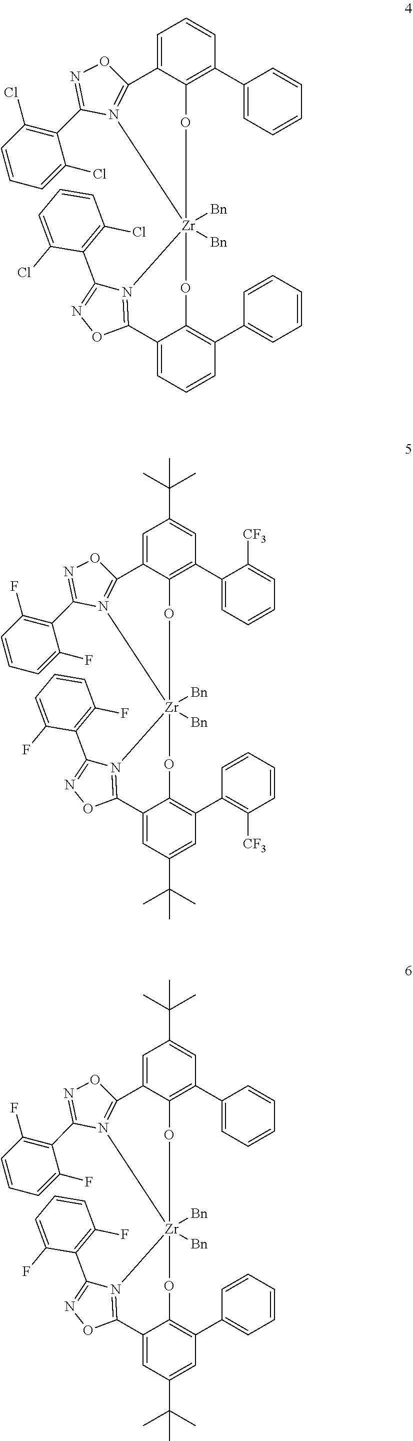

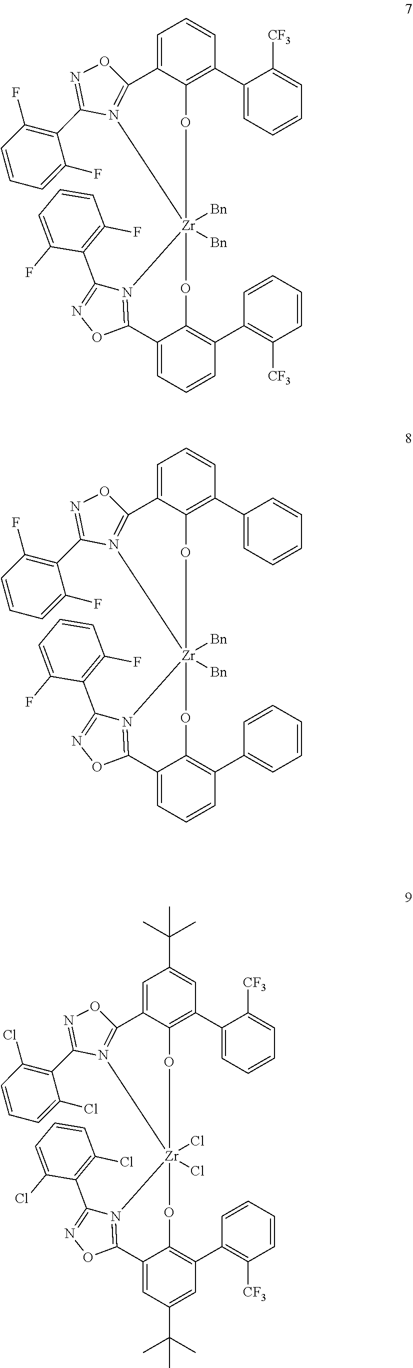

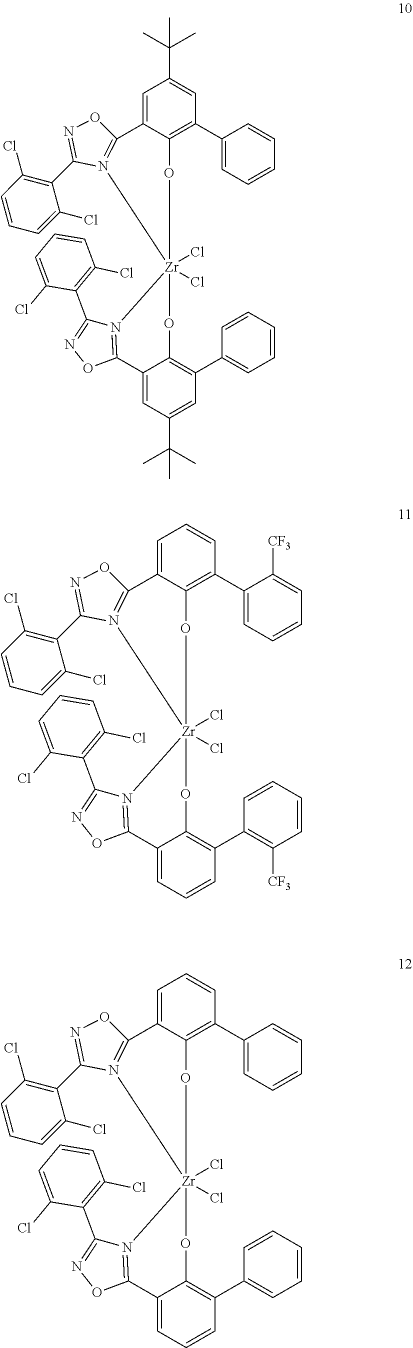

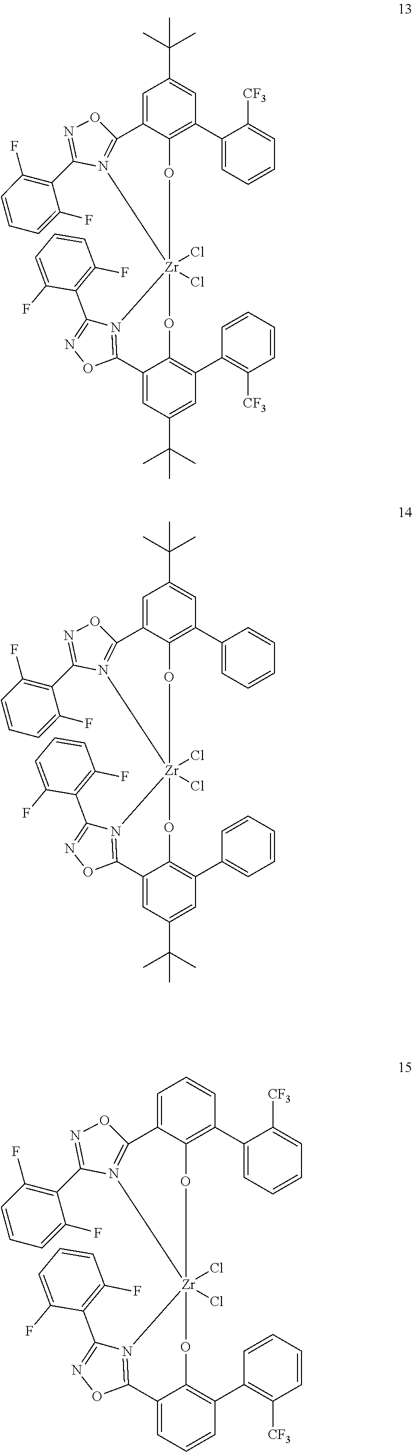

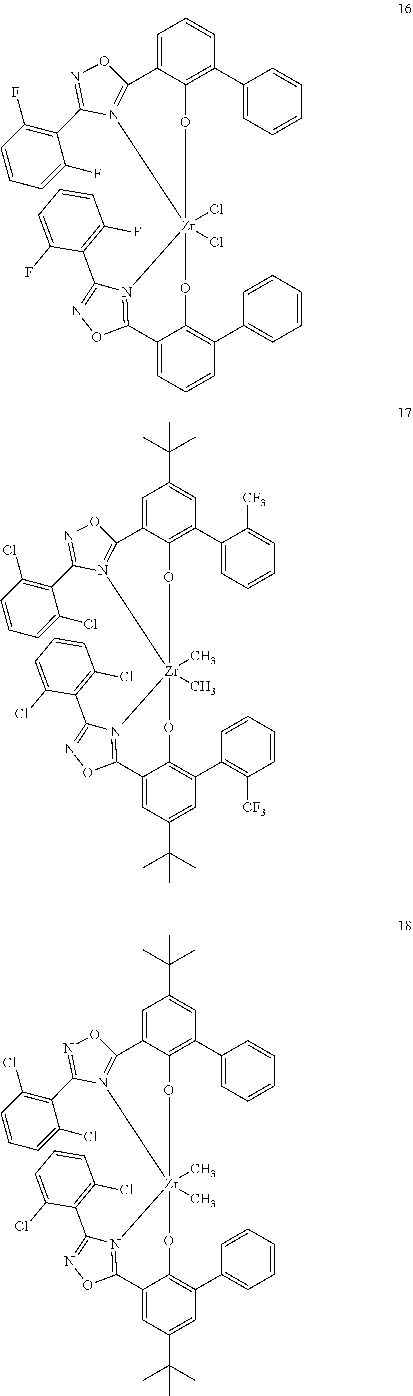

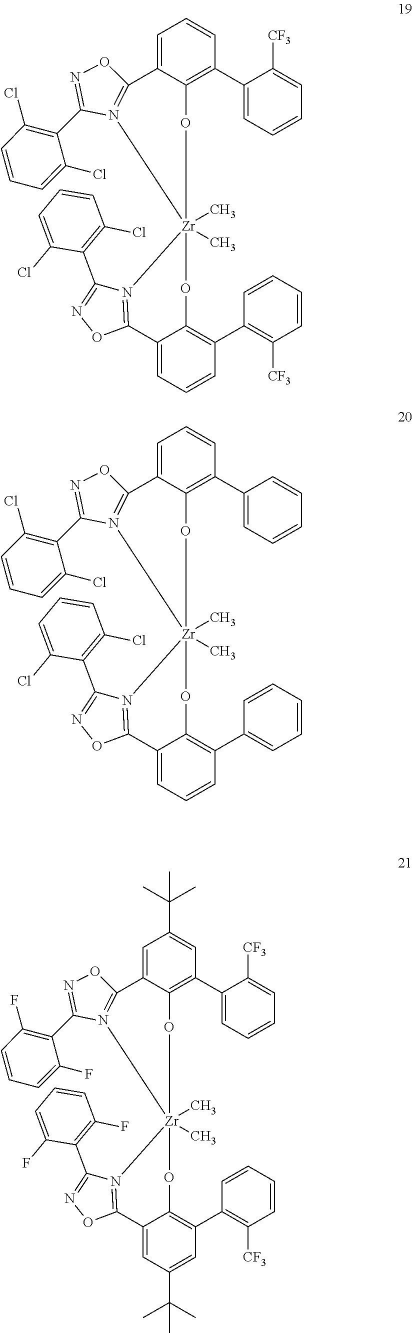

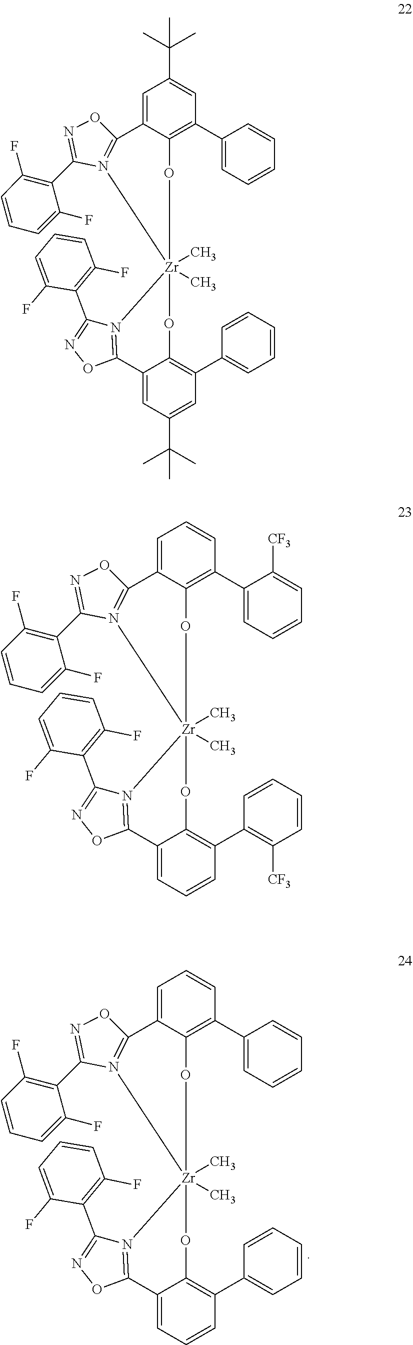

Clause 30. The catalyst system of Clause 29, wherein the catalyst compound of Formula (CI) is:

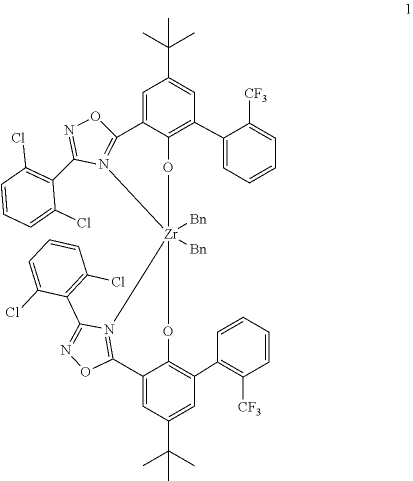

Clause 31. The catalyst system of any of Clauses 1 to 30, further comprising a support material, preferably selected from Al₂O₃, ZrO₂, SiO₂, SiO₂/Al₂O₃, SiO₂/TiO₂, silica clay, silicon oxide/clay, or mixtures thereof.
Clause 32. A method of polymerizing olefins to produce at least one polyolefin, the method comprising contacting at least one olefin with the catalyst system of any of Clauses 1 to 31, and obtaining a polyolefin.
Clause 33. The method of Clause 32, wherein two or more different olefins are contacted with the catalyst system.
Clause 34. The method of Clause 33, wherein the two or more olefins are ethylene and octene.
Clause 35. The method of Clause 33 or 34, wherein the two or more olefins further comprise a diene.
Clause 36. The method of any of Clauses 32 to 35, wherein the method is performed in the gas phase or slurry phase.
Clause 37. The method of any of Clauses 32 to 36, wherein the method is performed in the solution phase.

### Experimental

Lithium tetrakis(pentafluorophenyl)borate etherate (Li-BF20) was purchased from Boulder Scientific. N,N-Dimethylanilinium tetrakis(pentafluorophenyl)borate (DMAH-BF20) was purchased from Grace Davison and converted to sodium tetrakis(heptafluoronaphthalen-2-yl)borate (Na-BF28) by reaction with sodium hydrogen in toluene. N,N-dimethylanilinium tetrakis(heptafluoronaphthalen-2-yl)borate (DMAH-BF28) were purchased from Grace Davison. All other reagents were purchased from Sigma-Aldrich and used as received. All anhydrous solvents were purchased from Sigma-Aldrich. Solvents (Sigma-Aldrich) were sparged with nitrogen and stored over molecular sieves.

BF20 is tetrakis(pentafluorophenyl)borate.

BF28 is tetrakis(heptafluoronaphthalen-2-yl)borate.

Catalyst 1 is bis((5-(tert-butyl)-3-(3-(2,6-dichlorophenyl)-1,2,4-oxadiazol-5-yl)-3′-(trifluoromethyl)-[1,1′-biphenyl]-2-yl)oxy)zirconium dibenzyl.

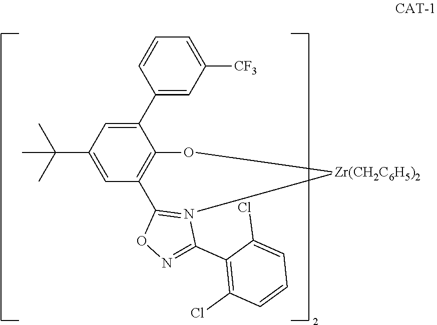

¹H NMR for Compound Characterization: Chemical structures are determined by 1H NMR. 1H NMR data are collected at room temperature (e.g., 23° C.) in a 5 mm probe. The ¹H NMR measurements were recorded on a 400 MHz or 500 MHz Bruker spectrometer with chemical shifts referenced to residual solvent peaks (CDCl₃: 7.27 ppm for ¹H, 77.23 ppm for ¹³C).

### EXAMPLES

Borate anions and ammonium cations used as activator components are shown in Scheme 1.

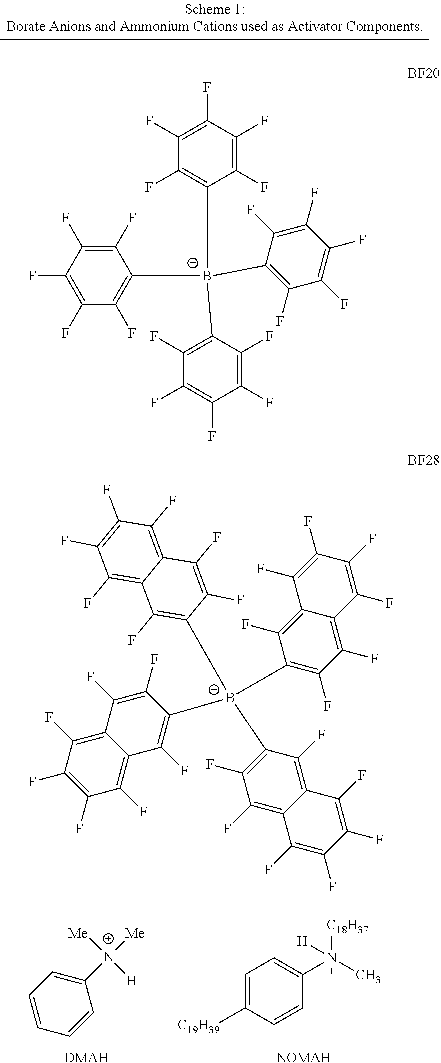

### Synthesis of Activators

N,N-Dimethylanilinium tetrakis(pentafluorophenyl)borate (DMAH-BF20) was purchased from Albemarle. Sodium tetrakis(heptafluoronaphthalen-2-yl)borate (Na-BF28) and N,N-dimethylanilinium tetrakis(heptafluoronaphthalen-2-yl)borate (DMAH-BF28) were purchased from Grace Davison.

N-methyl-4-nonadecyl-N-octadecylanilinium tetrakis(perfluoronaphthalen-2-yl)borate (NOMAH-BF28): The above N-methylaniline (15 g, 24 mmol) was dissolved in 250 mL of hexane in a 500 mL round bottom flask. A 2 M solution of HCl in ether (12 mL, 24 mmol) was added slowly, causing a white precipitate to appear, and the mixture was allowed to stir overnight. The solid was collected by gravity filtration, washed with hexane, and dried under vacuum. The HCl salt (13.1 g, 20 mmol) and Na-BF28 (20.7 g, 20 mmol) was heated at reflux for 1.5 hours in 100 mL of cyclohexane. Once cooled to ambient, the mixture was filtered and concentrated to a brown oil. The oil was redissolved in hexane and filtered through Celite. The filtrate was concentrated to give the product as a thick oil in 57% yield.

N-methyl-4-nonadecyl-N-octadecylanilinium tetrakis(pentafluorophenyl)borate (NOMAH-BF20): Made from N-methyl-4-nonadecyl-N-octadecylanilinum chloride (1.50 g, 2.26 mmol) and Li-BF20 (1.72 g, 2.26 mmol) in a similar procedure as described above. The product was obtained as a colorless oil in 61% yield.

### Catalysts

Catalyst 1 is represented by the structure:

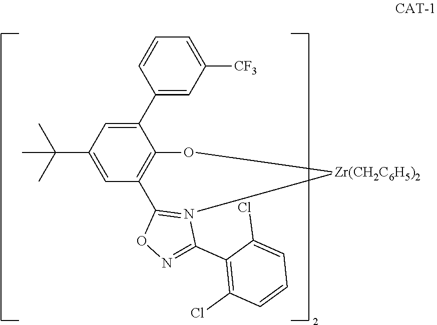

### Synthesis of Catalysts

Synthesis of bis((5-(tert-butyl)-3-(3-(2,6-dichlorophenyl)-1,2,4-oxadiazol-5-yl)-3′-(trifluoromethyl)-[1,1′-biphenyl]-2-yl)oxy)zirconium dibenzyl. (Catalyst-1):

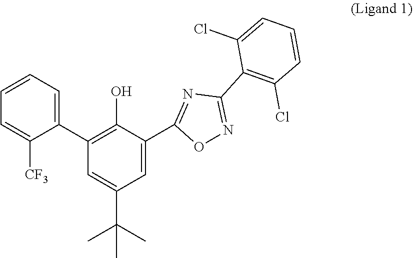 [SMILES: CC(C)(C)c1cc(-c2nc(-c3c(Cl)cccc3Cl)no2)c(O)c(-c2ccccc2C(F)(F)F)c1]

Ligand 1 was obtained from Syngene International Ltd. Zirconium tetrabenzyl was synthesized according to U.S. Pat. No. 7,067,686, incorporated herein by reference. Zirconium tetrabenzyl (0.788 g; 1.73 mmol) and Ligand 1 (1.75 g; 3.46 mmol) were added together in a 50 mL round bottom flask and toluene (ca. 20 mL) was added forming an orange solution. The solution was stirred overnight resulting in a cloudy solution. Iso-hexane (ca. 20 mL) was added forming a precipitate, which precipitated out over the course of an hour. The flask was then cooled to −20° C. The orange powder was isolated by filtration, washed with iso-hexane (ca. 10 mL) dried under vacuum to provide a yield of 0.70 g. The supernatant was concentrated to about 5 mL and about 20 mL iso-hexane was added an orange powder precipitated out; isolated by filtration; washed with iso-hexane; and then dried under vacuum to provide a yield of 0.68 g.

### Polymerization in Parallel Pressure Reactor

Solvents, polymerization-grade toluene, and isohexane were supplied by ExxonMobil Chemical Company and purified by passing through a series of columns: two 500 cc Oxyclear cylinders in series from Labclear (Oakland, Calif.), followed by two 500 cc columns in series packed with dried 3 Å mole sieves (8-12 mesh; Aldrich Chemical Company), and two 500 cc columns in series packed with dried 5 Å mole sieves (8-12 mesh; Aldrich Chemical Company). 1-octene (C₈) (98%, Aldrich Chemical Company) were dried by stirring over NaK overnight followed by filtration through basic alumina (Aldrich Chemical Company, Brockman Basic 1).

Polymerization-grade ethylene (C₂) was used and further purified by passing the gas through a series of columns: 500 cc Oxyclear cylinder from Labclear (Oakland, Calif.) followed by a 500 cc column packed with dried 3 Å mole sieves (8-12 mesh; Aldrich Chemical Company) and a 500 cc column packed with dried 5 Å mole sieves (8-12 mesh; Aldrich Chemical Company).

Solutions of the metal complexes and activators were prepared in a drybox using toluene or methylcyclohexane. Concentrations were typically 0.2 mmol/L. Tri-n-octylaluminum (TNOAL, neat, AkzoNobel) was typically used as a scavenger. Concentration of the TNOAL solution in toluene ranged from 0.5 to 2.0 mmol/L.

Polymerizations were carried out in a parallel pressure reactor, as generally described in U.S. Pat. Nos. 6,306,658; 6,455,316; 6,489,168; WO 2000/009255; and Murphy, V. et al. (2003) “A Fully Integrated High-Throughput Screening Methodology for the Discovery of New Polyolefin Catalysts: Discovery of a New Class of High Temperature Single-Site Group (IV) Copolymerization Catalysts,” J. Am. Chem. Soc., v. 125, pp. 4306-4317, each of which is fully incorporated herein by reference. The experiments were conducted in an inert atmosphere (N₂) drybox using autoclaves equipped with an external heater for temperature control, glass inserts (internal volume of reactor=23.5 mL for C₂ and C₂/C₈; 22.5 mL for C₃ runs), septum inlets, regulated supply of nitrogen, ethylene and propylene, and equipped with disposable PEEK mechanical stirrers (800 RPM). The autoclaves were prepared by purging with dry nitrogen at 110° C. or 115° C. for 5 hours and then at 25° C. for 5 hours. Although the specific quantities, temperatures, solvents, reactants, reactant ratios, pressures, and other variables are frequently changed from one polymerization run to the next, the following describes a typical polymerization performed in a parallel pressure reactor.

Catalyst systems dissolved in solution were used in the polymerization examples below, unless specified otherwise.

Ethylene-Octene Copolymerization (EO). A pre-weighed glass vial insert and disposable stirring paddle were fitted to each reaction vessel of the reactor, which contains 48 individual reaction vessels. The reactor was then closed and purged with ethylene. Each vessel was charged with enough solvent (typically isohexane) to bring the total reaction volume, including the subsequent additions, to the desired volume, typically 5 mL 1-octene, if required, was injected into the reaction vessel and the reactor was heated to the set temperature and pressurized to the predetermined pressure of ethylene, while stirring at 800 rpm. The aluminum compound (such as tri-n-octylaluminum) in toluene was then injected as scavenger followed by addition of the activator solution (typically 1.0-1.2 molar equivalents).

The catalyst (and activator solutions for the runs below) were all prepared in toluene. The catalyst solution (typically 0.020-0.080 μmol of metal complex) was injected into the reaction vessel and the polymerization was allowed to proceed until a pre-determined amount of ethylene (quench value typically 20 psi) had been used up by the reaction. Alternatively, the reaction may be allowed to proceed for a set amount of time (maximum reaction time typically 30 minutes). Ethylene was added continuously (through the use of computer controlled solenoid valves) to the autoclaves during polymerization to maintain reactor gauge pressure (P setpt, +/−2 psig) and the reactor temperature (T) was monitored and typically maintained within +/−1° C. The reaction was quenched by pressurizing the vessel with compressed air. After the reactor was vented and cooled, the glass vial insert containing the polymer product and solvent was removed from the pressure cell and the inert atmosphere glove box, and the volatile components were removed using a Genevac HT-12 centrifuge and Genevac VC3000D vacuum evaporator operating at elevated temperature and reduced pressure. The vial was then weighed to determine the yield of the polymer product. The resultant polymer was analyzed by Rapid GPC to determine the molecular weight, by FT-IR to determine percent octene incorporation, and by DSC to determine melting point (Tₘ).

Polymer Characterization. Polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB.

To determine various molecular weight related values by GPC, high temperature size exclusion chromatography was performed using an automated “Rapid GPC” system as generally described in U.S. Pat. Nos. 6,491,816; 6,491,823; 6,475,391; 6,461,515; 6,436,292; 6,406,632; 6,175,409; 6,454,947; 6,260,407; and 6,294,388; each of which is fully incorporated herein by reference. This apparatus has a series of three 30 cm×7.5 mm linear columns, each containing PLgel 10 μm, Mix B. The GPC system was calibrated using polystyrene standards ranging from 580 to 3,390,000 g/mol. The system was operated at an eluent flow rate of 2.0 mL/minutes and an oven temperature of 165° C. 1,2,4-trichlorobenzene was used as the eluent. The polymer samples were dissolved in 1,2,4-trichlorobenzene at a concentration of 0.28 mg/mL and 400 uL of a polymer solution was injected into the system. The concentration of the polymer in the eluent was monitored using an evaporative light scattering detector. The molecular weights presented are relative to linear polystyrene standards and are uncorrected, unless indicated otherwise.

RAPID DSC: Differential Scanning Calorimetry (DSC) measurements were performed on a TA-Q100 instrument to determine the melting point (Tₘ) of the polymers. Samples were pre-annealed at 220° C. for 15 minutes and then allowed to cool to room temperature overnight. The samples were then heated to 220° C. at a rate of 100° C./min and then cooled at a rate of 50° C./min. Melting points were collected during the heating period.

The weight percent of ethylene incorporated in polymers was determined by rapid FT-IR spectroscopy on a Bruker Equinox 55+IR in reflection mode. Samples were prepared in a thin film format by evaporative deposition techniques. FT-IR methods were calibrated using a set of samples with a range of known wt % ethylene content. For ethylene-1-octene copolymers, the wt % octene in the copolymer was determined via measurement of the methyl deformation band at ˜1,375 cm⁻¹. The peak height of this band was normalized by the combination and overtone band at ˜4,321 cm⁻¹, which corrects for path length differences.

Equivalence is determined based on the mole equivalents relative to the moles of the transition metal in the catalyst complex.

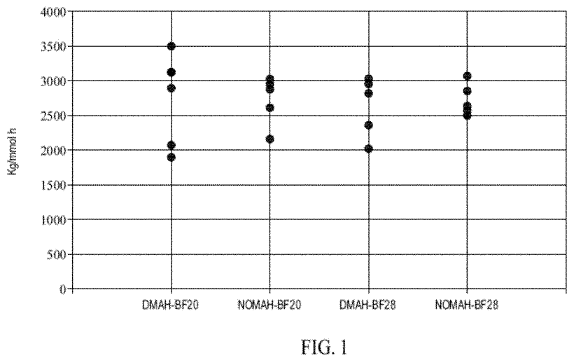

RUN 1: Ethylene-Octene copolymerization: A series of ethylene-octene polymerizations were performed in the parallel pressure reactor according to the procedure described above. In these studies bis((5-(tert-butyl)-3-(3-(2,6-dichlorophenyl)-1,2,4-oxadiazol-5-yl)-3′-(trifluoromethyl)-[1,1′-biphenyl]-2-yl)oxy)zirconium dibenzyl. (Catalyst-1) was used along with the activators identified in the tables below. In a typical experiment an automated syringe was used to introduce into the reactor the following reagents, if utilized, in the following order: isohexane (0.50 mL), 1-octene (100 μL), additional isohexane (0.50 mL) an isohexane solution of TNOAL scavenger (0.005 M, 100 μL), additional isohexane (0.50 mL), a toluene solution of the respective polymerization catalyst (50 μL, 0.4 mM), additional isohexane (0.50 mL), a toluene solution of the respective activator (55 μL, 0.4 mM), then additional isohexane so that the total solvent volume for each run was 5 mL. Catalyst and activator were used in a 1:1.1 ratio. Each reaction was performed at a specified temperature range between 50 and 120° C., typically 100° C., while applying about 135 psig of ethylene (monomer) gas. Each reaction was allowed to run for about 20 minutes (˜1,200 seconds) or until approximately 20 psig of ethylene gas uptake was observed, at which point the reactions were quenched with air (˜300 psig). When sufficient polymer yield was attained (e.g., at least ˜10 mg), the polyethylene product was analyzed by Rapid GPC. Run conditions and data are reported in Table 3. Activity data of the polymerizations are shown in FIG. 1.

TABLE 3
Data for the Copolymerization of Ethylene and Octene in isohexane.
General conditions: catalyst = 20 nmol; activator = 22 nmol;
1-octene = 100 μL; solvent = isohexane; volume = 5 mL;
tri(n-octyl)aluminum = 500 nmol, T = 100° C.; P = 135 PSI

| | | | | activity | | | | octene | |
|---|---|---|---|---|---|---|---|---|---|
| | | time | yield | (kg/ | | | | incorporation | Tₘ |
| Entry | Activator | (s) | (g) | mmol/h) | M_{w} | Mₙ | PDI | (wt %) | (° C.) |
| 1 | DMAH-BF20 | 7.7 | 0.134 | 3132 | 27,785 | 14,034 | 2.0 | 9.5 | 123.2 |
| 2 | DMAH-BF20 | 7.9 | 0.127 | 2894 | 26,680 | 14,034 | 1.9 | 9.6 | 123.2 |
| 3 | DMAH-BF20 | 6.8 | 0.133 | 3521 | 26,396 | 14,541 | 1.8 | 8.4 | 123.1 |
| 4 | DMAH-BF20 | 6.8 | 0.110 | 2912 | 28,449 | 14,458 | 2.0 | 6.5 | 123.9 |
| 5 | DMAH-BF20 | 9.5 | 0.101 | 1914 | 29,523 | 15,182 | 1.9 | 6.3 | 125.0 |
| 6 | DMAH-BF20 | 8.8 | 0.102 | 2086 | 27,739 | 14,966 | 1.9 | 5.6 | 124.5 |
| 7 | DMAH-BF28 | 7.9 | 0.133 | 3030 | 29,230 | 14,417 | 2.0 | 9.2 | 121.9 |
| 8 | DMAH-BF28 | 8.2 | 0.135 | 2963 | 31,854 | 18,310 | 1.7 | 10.1 | 122.0 |
| 9 | DMAH-BF28 | 7.9 | 0.131 | 2985 | 31,211 | 17,277 | 1.8 | 9.7 | 122.5 |
| 10 | DMAH-BF28 | 7.1 | 0.112 | 2839 | 31,031 | 15,368 | 2.0 | 7.7 | 122.6 |
| 11 | DMAH-BF28 | 7.6 | 0.100 | 2368 | 30,274 | 15,965 | 1.9 | 6.8 | 123.1 |
| 12 | DMAH-BF28 | 8.5 | 0.096 | 2033 | 31,653 | 17,115 | 1.8 | 7.3 | 122.8 |
| 13 | NOMAH-BF20 | 7.0 | 0.118 | 3034 | 25,831 | 13,411 | 1.9 | 10.0 | 123.8 |
| 14 | NOMAH-BF20 | 7.0 | 0.115 | 2957 | 26,771 | 13,930 | 1.9 | 10.1 | 124.3 |
| 15 | NOMAH-BF20 | 7.0 | 0.112 | 2880 | 28,063 | 15,386 | 1.8 | 10.0 | 124.4 |
| 16 | NOMAH-BF20 | 7.6 | 0.111 | 2629 | 27,917 | 13,099 | 2.1 | 7.4 | 123.7 |
| 17 | NOMAH-BF20 | 7.6 | 0.110 | 2605 | 29,387 | 15,772 | 1.9 | 7.4 | 124.1 |
| 18 | NOMAH-BF20 | 8.3 | 0.100 | 2169 | 25,721 | 13,703 | 1.9 | 6.9 | 124.4 |
| 19 | NOMAH-BF28 | 7.9 | 0.112 | 2552 | 27,388 | 13,631 | 2.0 | 9.2 | 122.3 |
| 20 | NOMAH-BF28 | 8.2 | 0.115 | 2524 | 29,829 | 15,755 | 1.9 | 8.7 | 122.8 |
| 21 | NOMAH-BF28 | 7.7 | 0.113 | 2642 | 28,958 | 14,480 | 2.0 | 8.8 | 122.8 |
| 22 | NOMAH-BF28 | 7.9 | 0.113 | 2575 | 30,269 | 15,761 | 1.9 | 6.5 | 122.8 |
| 23 | NOMAH-BF28 | 6.7 | 0.114 | 3063 | 29,697 | 15,585 | 1.9 | 8.4 | 122.6 |
| 24 | NOMAH-BF28 | 6.8 | 0.108 | 2859 | 30,487 | 16,095 | 1.9 | 8.1 | 123.3 |

Overall, the present disclosure provides catalyst systems and methods thereof. The catalyst systems include one or more phenol-oxadiazole catalysts and one or more catalyst activators (having a non-coordinating anion) that are soluble in an aliphatic hydrocarbon solvent. It has been discovered that catalyst systems having a phenol-oxadiazole catalyst and a catalyst activator having, for example, a cation having 15 or more carbon atoms can provide catalyst systems having activators that are soluble in aliphatic hydrocarbons, and the catalyst systems are capable of producing polyolefins at the same or improved catalyst activities, as compared to conventional activators. In addition, the polymers produced using catalyst systems of the present disclosure can have the same or improved polymer properties, as compared to polymers produced using conventional catalyst systems. For example, polyolefins of the present disclosure can have high comonomer incorporation, low molecular weight, and or a melt temperature of about 120° C. or greater. Accordingly, catalyst systems of the present disclosure provide soluble activators in addition to improved or maintained catalyst activities and polymer properties. Catalyst systems of the present disclosure therefore provide commercially viable catalyst systems without the use of toluene for preparation of the catalyst systems.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

What is claimed is:

1. A catalyst system comprising:
(1) a catalyst compound represented by the Formula (CI): 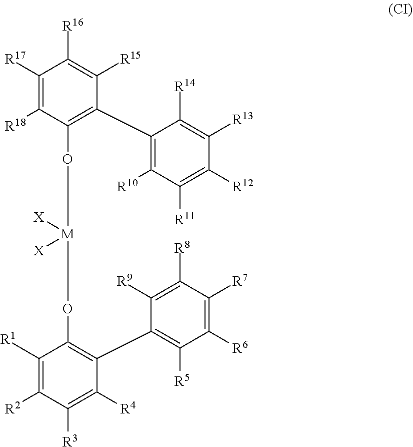
M is selected from the group consisting of Ti, Zr, and Hf;
wherein each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is independently selected from the group consisting of hydrogen, hydrocarbyl, substituted hydrocarbyl, heterohydrocarbyl, substituted heterohydrocarbyl, alkoxy, substituted alkoxy, aryloxy, substituted aryloxy, hydroxyl, alkylthio, substituted alkylthio, arylthio, substituted arylthio, aryl, substituted aryl, heteroaryl, substituted heteroaryl, halide, silyl, boryl, phosphinyl, and amino; with the proviso that at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is an oxadiazole group having the following structure: 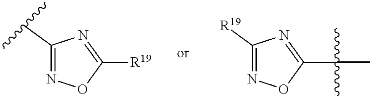
wherein R¹⁹ is independently selected from the group consisting of hydrogen, hydrocarbyl, substituted hydrocarbyl, heterohydrocarbyl, substituted heterohydrocarbyl, alkoxy, substituted alkoxy, aryloxy, substituted aryloxy, hydroxyl, alkylthio, substituted alkylthio, arylthio, substituted arylthio, aryl, substituted aryl, heteroaryl, substituted heteroaryl, halide, silyl, boryl, phosphinyl, and amino; and
each X is independently a leaving group; and
(2) an activator represented by Formula (AI):
[R¹R²R³EH]_{d}⁺[M^{k+}Qₙ]^{d-} (AI)
wherein:
E is nitrogen or phosphorous;
d is 1, 2 or 3; k is 1, 2, or 3; n is 1, 2, 3, 4, 5, or 6; n−k=d;
each of R¹, R², and R³ is independently hydrogen, a C₁-C₄ alkyl, or a C₅-C₅₀-aryl, wherein each of R¹, R², and R³ is independently unsubstituted or substituted; wherein R¹, R², and R³ together comprise 15 or more carbon atoms;
M is an element selected from group 13 of the Periodic Table of the Elements; and
each Q is independently selected from the group consisting of a hydrogen, bridged or unbridged dialkylamido, halide, alkoxy, substituted alkoxy, aryloxy, substituted aryloxy, hydrocarbyl, substituted hydrocarbyl, halocarbyl, substituted halocarbyl, and halosubstituted-hydrocarbyl radical.

2. The catalyst system of claim 1, wherein the activator compound of Formula (AI) is represented by Formula (I):
[R¹R²R³EH]⁺[BR⁴R⁵R⁶R⁷]⁻ (I)
wherein:
E is nitrogen or phosphorous;
each of R¹, R², and R³ is independently C₁-C₄₀ branched or linear alkyl or C₅-C₅₀-aryl, wherein each of R¹, R², and R³ is independently unsubstituted or substituted with at least one of halide, C₅-C₅₀ aryl, C₆-C₃₅ arylalkyl, C₆-C₃₅ alkylaryl or, in the case of the C₅-C₅₀-aryl, C₁-C₅₀ alkyl; wherein R¹, R², and R³ together comprise 15 or more carbon atoms; and
each of R⁴, R⁵, R⁶, and R⁷ is naphthyl, wherein at least one of R⁴, R⁵, R⁶, and R⁷ is substituted with from one to seven fluorine atoms.

3. The catalyst system of claim 1, wherein: at least one of R¹, R², and R³ of Formula (AI) or (I) is independently a C₃-C₄₀ alkyl which is unsubstituted or substituted with at least one of halide, C₅-C₁₅ aryl, C₆-C₂₅ arylalkyl, and C₆-C₂₅ alkylaryl.

4. The catalyst system of claim 2, wherein, for the activator of Formula (AI) or (I): R¹ is methyl; R² is C₁₀-C₄₂ aryl; R³ is C₁-C₄₀ branched alkyl; wherein each of R² and R³ is independently unsubstituted or substituted with at least one of halide, C₅-C₁₅ aryl, C₆-C₂₅ arylalkyl, C₆-C₂₅ alkylaryl, and in the case of the C₁₀ to C₄₂ aryl, C₁-C₁₀ alkyl; and R² and R³ together comprise 20 or more carbon atoms.

5. The catalyst system of claim 1, wherein, for the activator of Formula (AI) or (I), E is nitrogen.

6. The catalyst system of claim 2, wherein, for the activator of Formula (I), R⁴, R⁵, R⁶, and R⁷ are perfluoroaryl.

7. The catalyst system of claim 2, wherein, for the activator of Formula (I), each of R⁴, R⁵, R⁶, and R⁷ is substituted with from one to seven fluorine atoms.

8. The catalyst system of claim 1, wherein R¹, R², and R³ together comprise 21 or more carbon atoms.

9. The catalyst system of any of claim 2, wherein all Q in Formula (AI) are not perfluorophenyl, and each of R⁴, R⁵, R⁶, and R⁷ in Formula (I) are not perfluorophenyl.

10. The catalyst system of claim 2, wherein at least one of R¹, R², and R³ of Formula (AI) or (I) is an alkyl group represented by the formula: 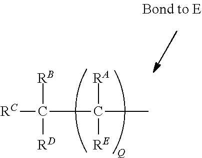
wherein each of R^{A} and R^{E} are independently selected from the group consisting of H, a C₁-C₄₀ linear or branched alkyl, and C₅-C₅₀-aryl, wherein each of R^{A} and R^{E} is optionally substituted with one or more of halide, C₅-C₅₀ aryl, C₆-C₃₅ arylalkyl, C₆-C₃₅ alkylaryl and, in the case of the C₅-C₅₀-aryl, C₁-C₅₀ alkyl, provided that in at least one (R^{A}—C—R^{E}) group, one or both of R^{A} and R^{E} is not H; and
R^{C}, R^{B} and R^{D} are hydrogen; and Q is an integer from 5 to 40.

11. The catalyst system claim 1, wherein one, two or three of R¹, R² and R³ are independently represented by the Formula (IV): 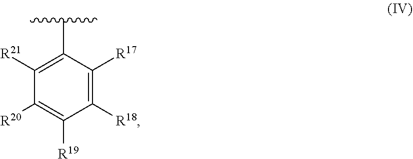
wherein each of R¹⁷, R¹⁸, R¹⁹, R²⁰, and R²¹ is independently selected from the group consisting of hydrogen, C₁-C₄₀ hydrocarbyl, C₁-C₄₀ substituted hydrocarbyl, a heteroatom, a heteroatom-containing group, or is represented by Formula (BIII), provided that at least one of R¹⁷, R¹⁸, R¹⁹, R²⁰, and R²¹ is not hydrogen, wherein Formula (BIII) is: 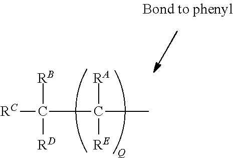
wherein each of R^{A} and R^{E} is independently selected from the group consisting of H, a C₁-C₄₀ linear or branched alkyl, and C₅-C₅-aryl, wherein each of R^{A} and R^{E} is optionally substituted with one or more groups selected from the group consisting of halide, C₅-C₅₀ aryl, C₆-C₃₅ arylalkyl, C₆-C₃₅ alkylaryl, and in the case of the C₅-C₅₀-aryl, C₁-C₅₀ alkyl, provided that in at least one (R^{A}—C—R^{E}) group, one or both of R^{A} and R^{E} is not H;
R^{C}, R^{B} and R^{D} are hydrogen; and
Q is an integer from 5 to 40.

12. The catalyst system of claim 1, wherein R¹ is C₁-C₁₀ alkyl and each of R² and R³ is independently a linear or branched C₁₀-C₄₀ alkyl.

13. The catalyst system of claim 1, wherein R¹ is C₅-C₂₂-aryl and each of R² and R³ is independently a linear or branched C₁-C₄₀ alkyl, wherein R¹ is unsubstituted or substituted with at least one C₁-C₁₀ alkyl.

14. The catalyst system of claim 13, wherein R¹ is phenyl, R² is methyl, and R³ is a C₁₀-C₄₀ branched alkyl.

15. The catalyst system of claim 1, wherein the activator compound has a solubility of more than 10 mM at 25° C. (stirred 2 hours) in methylcyclohexane and/or a solubility of more than 1 mM at 25° C. (stirred 2 hours) in isohexane.

16. The catalyst system of claim 1, wherein the catalyst system has a solubility of more than 20 mM at 25° C. (stirred 2 hours) in methylcyclohexane and/or a solubility of more than 10 mM at 25° C. (stirred 2 hours) in isohexane.

17. The catalyst system of claim 1, wherein for the catalyst compound of Formula (CI), each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ is independently selected from the group consisting of hydrogen, alkyl, substituted alkyl, heteroalkyl, substituted heteroalkyl, alkoxy, substituted alkoxy, aryloxy, aryl, substituted aryl, heteroaryl, substituted heteroaryl, aralkyl, substituted aralkyl, alkaryl, substituted alkaryl, and halide, wherein at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is the oxadiazole group.

18. The catalyst system of claim 1, wherein, for the catalyst compound of Formula (CI), each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ is independently selected from the group consisting of hydrogen, hydrocarbyl, substituted hydrocarbyl, and halide, wherein at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is the oxadiazole group.

19. The catalyst system of claim 1, wherein, for the catalyst compound of Formula (CI), each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is independently selected from the group consisting of hydrogen, alkyl, haloalkyl, and halide, wherein R¹⁹ is substituted aryl, and wherein at least one of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ is the oxadiazole group.

20. The catalyst system of claim 19, wherein R¹⁹ is an aryl group substituted with one or more halides.
